(19) United States
(12) Patent Application Publication
(10) Pub. No.: US 2026/0052513 A1
(43) Pub. Date: Feb. 19, 2026

(54) METHOD AND DEVICE RELATED TO CHANNEL ACCESS OPERATION AND PHYSICAL CHANNEL DESIGN IN UNLICENSED SPECTRUM

(71) Applicant: LG ELECTRONICS INC., Seoul (KR)

(72) Inventors: Seungmin LEE, Seoul (KR); Daesung HWANG, Seoul (KR); Youngdae LEE, Seoul (KR); Suckchel YANG, Seoul (KR); Seonwook KIM, Seoul (KR)

(73) Assignee: LG ELECTRONICS INC., Seoul (KR)

(21) Appl. No.: 19/103,073

(22) PCT Filed: Aug. 11, 2023
(86) PCT No.: PCT/KR2023/011970

§ 371 Date: Feb. 11, 2025

Related U.S. Application Data
(60) Provisional application No. 63/397,343, filed on Aug. 11, 2022.

(51) Int. Cl. H04W 72/02; H04W 72/25; H04W 74/0808

(52) U.S. Cl. CPC H04W 72/02; H04W 72/25; H04W 74/0808

(57) ABSTRACT

An operation method of a first device (100) in a wireless communication system is proposed. The method may comprise the steps of: selecting at least one first resource; determining whether to select an adjacent resource to the at least one first resource; selecting at least one second resource on the basis of determining to select the adjacent resource; and selecting at least one third resource on the basis of determining not to select the adjacent resource.

### CROSS-REFERENCE TO RELATED APPLICATIONS

This application is the National Stage filing under 35 U.S.C. 371 of International Application No. PCT/KR2023/011970, filed on Aug. 11, 2023, which claims the benefit of U.S. Provisional Application No. 63/397,343 filed on Aug. 11, 2022, the contents of which are all hereby incorporated by reference herein in their entireties.

### TECHNICAL FIELD

This disclosure relates to a wireless communication system.

### BACKGROUND

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic. Vehicle-to-everything (V2X) refers to a communication technology through which a vehicle exchanges information with another vehicle, a pedestrian, an entity having an infrastructure (or infra) established therein, and so on. The V2X may be spread into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR).

### SUMMARY

According to an embodiment of the present disclosure, a method for performing, by a first device, wireless communication may be proposed. For example, the method may comprise: selecting at least one first resource; determining whether to perform contiguous resource selection for the at least one first resource; selecting at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and selecting at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

According to an embodiment of the present disclosure, a first device for performing wireless communication may be proposed. For example, the first device may comprise: at least one transceiver; at least one processor; and at least one memory operably connected to the at least one processor and storing instructions that, based on being executed by the at least one processor, cause the first device to perform operations. For example, the operations may comprise: selecting at least one first resource; determining whether to perform contiguous resource selection for the at least one first resource; selecting at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and selecting at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

According to an embodiment of the present disclosure, a device adapted to control a first user equipment (UE) may be proposed. For example, the device may comprise: at least one processor; and at least one memory operably connected to the at least one processor and storing instructions that, based on being executed by the at least one processor, cause the first UE to perform operations. For example, the operations may comprise: selecting at least one first resource; determining whether to perform contiguous resource selection for the at least one first resource; selecting at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and selecting at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

According to an embodiment of the present disclosure, a non-transitory computer-readable storage medium storing instructions may be proposed. For example, the instructions, based on being executed, may cause a first device to: select at least one first resource; determine whether to perform contiguous resource selection for the at least one first resource; select at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and select at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

According to an embodiment of the present disclosure, a method for performing, by a second device, wireless communication may be proposed. For example, the method comprising: receiving, from a first device, sidelink control information (SCI) for scheduling of a physical sidelink shared channel (PSSCH) through a physical sidelink control channel (PSCCH), based on at least one second resource; and receiving, from the first device, a second medium access control (MAC) protocol data unit (PDU) through the PSSCH, based on the at least one second resource, wherein a second channel access priority class (CAPC) value related to the second MAC PDU may be less than or equal to a first CAPC value related to a first MAC PDU to be transmitted through at least one first resource, and wherein the at least one second resource may be selected within a contiguous interval of the at least one first resource based on a determination to perform contiguous resource selection.

According to an embodiment of the present disclosure, a second device for performing wireless communication may be proposed. For example, the second device may comprise: at least one transceiver; at least one processor; and at least one memory operably connected to the at least one processor and storing instructions that, based on being executed by the at least one processor, cause the second device to perform operations. For example, the operations may comprise: receiving, from a first device, sidelink control information (SCI) for scheduling of a physical sidelink shared channel (PSSCH) through a physical sidelink control channel (PSCCH), based on at least one second resource; and receiving, from the first device, a second medium access control (MAC) protocol data unit (PDU) through the PSSCH, based on the at least one second resource, wherein a second channel access priority class (CAPC) value related to the second MAC PDU may be less than or equal to a first CAPC value related to a first MAC PDU to be transmitted through at least one first resource, and wherein the at least one second resource may be selected within a contiguous interval of the at least one first resource based on a determination to perform contiguous resource selection.

### BRIEF DESCRIPTION OF THE DRAWINGS

FIG. 1 shows a communication structure that can be provided in a 6G system, according to one embodiment of the present disclosure.

FIG. 2 shows an electromagnetic spectrum, according to one embodiment of the present disclosure.

FIG. 3 shows a structure of an NR system, based on an embodiment of the present disclosure.

FIG. 4 shows a radio protocol architecture, based on an embodiment of the present disclosure.

FIG. 5 shows a structure of a radio frame of an NR, based on an embodiment of the present disclosure.

FIG. 6 shows a structure of a slot of an NR frame, based on an embodiment of the present disclosure.

FIG. 7 shows an example of a BWP, based on an embodiment of the present disclosure.

FIG. 8 shows a procedure of performing V2X or SL communication by a UE based on a transmission mode, based on an embodiment of the present disclosure.

FIG. 9 shows three cast types, based on an embodiment of the present disclosure.

FIG. 10 may include an unlicensed spectrum (U-S) wireless communication system.

FIG. 11 shows a method of occupying resources in an unlicensed band, based on an embodiment of the present disclosure.

FIG. 12 shows a case in which a plurality of LBT-SBs are included in an unlicensed band, based on an embodiment of the present disclosure.

FIG. 13 shows CAP operations performed by a base station to transmit a downlink signal through an unlicensed band, based on an embodiment of the present disclosure.

FIG. 14 shows type 1 CAP operations performed by a UE to transmit an uplink signal, based on an embodiment of the present disclosure.

FIG. 15 shows a method in which a UE that has reserved transmission resource(s) informs another UE of the transmission resource(s), based on an embodiment of the present disclosure.

FIG. 16 shows a plurality of PRBs corresponding to a resource pool, according to one embodiment of the present disclosure.

FIG. 17 shows an interlace structure within an RB set, according to one embodiment of the present disclosure.

FIG. 18 shows an interlace structure within an RB set, according to one embodiment of the present disclosure.

FIG. 19 shows a resource selection method performed for transmission of a MAC PDU related to different SL processes, according to one embodiment of the present disclosure.

FIG. 20 is a diagram to illustrate a determination rule for PSFCH occasions, according to one embodiment of the present disclosure.

FIG. 21 is a diagram to illustrate a determination rule for PSFCH occasions, according to one embodiment of the present disclosure.

FIG. 22 and FIG. 23 are drawings to describe a determination rule for PSFCH occasions, according to one embodiment of the present disclosure.

FIG. 24 and FIG. 25 are drawings to describe a determination rule for PSFCH occasions, according to one embodiment of the present disclosure.

FIG. 26 is a diagram to describe a determination rule for PSFCH occasions, according to one embodiment of the present disclosure.

FIG. 27 is a diagram to describe a determination rule for PSFCH occasions, according to one embodiment of the present disclosure.

FIG. 28 is a diagram to describe a determination rule for PSFCH occasions, according to one embodiment of the present disclosure.

FIG. 29 is a diagram to describe a determination rule for PSFCH occasions, according to one embodiment of the present disclosure.

FIG. 30 shows a configuration method for an RB set, according to one embodiment of the present disclosure.

FIG. 31 shows a configuration method for an RB set, according to one embodiment of the present disclosure.

FIG. 32 shows a configuration method for an RB set, according to one embodiment of the present disclosure.

FIG. 33 shows a configuration method for an RB set, according to one embodiment of the present disclosure.

FIG. 34 and FIG. 35 show a configuration method for an RB set, according to one embodiment of the present disclosure.

FIG. 36 shows an interlace RB-based RB set structure, according to one embodiment of the present disclosure.

FIG. 37 and FIG. 38 show an interlace RB-based RB set structure, according to one embodiment of the present disclosure.

FIG. 39 shows a sense duration and a defer duration related to an SL transmission resource, according to one embodiment of the present disclosure.

FIG. 40 shows a transmission resource that is excluded from a resource selection procedure, according to one embodiment of the present disclosure.

FIG. 41 shows an RB set for transmission based on contiguous RBs, according to one embodiment of the present disclosure.

FIG. 42 shows an RB set for transmission based on contiguous RBs, according to one embodiment of the present disclosure.

FIG. 43 shows a problem that may occur in an interlace-based RB set, according to one embodiment of the present disclosure.

FIG. 44 shows a problem that may occur in an interlace-based RB set, according to one embodiment of the present disclosure.

FIG. 45 shows a channel sensing duration of a type 1 SL channel access for an SL transmission near the start of a resource selection window, according to one embodiment of the present disclosure.

FIG. 46 shows a transmission resource that is selected in a mode 2 SL resource selection procedure such that the time gap between all two transmission resources covers the channel sense interval, according to one embodiment of the present disclosure.

FIG. 47 shows an SL mode 2 resource selection procedure based on channel sensing durations of different UEs, according to one embodiment of the present disclosure.

FIG. 48 shows an SL mode 2 resource selection procedure based on shared or unshared COT durations, according to one embodiment of the present disclosure.

FIG. 49 shows subchannelization for PSCCH/PSSCH transmissions based on contiguous RBs, according to one embodiment of the present disclosure.

FIG. 50 shows subchannelization for PSCCH/PSSCH transmissions based on contiguous RBs, according to one embodiment of the present disclosure.

FIG. 51 shows subchannelization for PSCCH/PSSCH transmission based on interlaced RBs, according to one embodiment of the present disclosure.

FIG. 52 shows a sub-channelization for interlaced RB-based PSCCH/PSSCH transmission, according to one embodiment of the present disclosure.

FIG. 53a and FIG. 53b show resources related to SL burst transmission, according to one embodiment of the present disclosure.

FIG. 54 shows a PSSCH-to-PSFCH mapping that takes into account the dropping of a PSFCH transmission due to LBT failure, according to one embodiment of the present disclosure.

FIG. 55 shows a PSSCH-to-PSFCH mapping for handling PSFCH TX dropping due to LBT failure, according to one embodiment of the present disclosure.

FIG. 56 shows a procedure for a first device to perform wireless communication, according to one embodiment of the present disclosure.

FIG. 57 shows a procedure for a second device to perform wireless communication, according to one embodiment of the present disclosure.

FIG. 58 shows a communication system 1, based on an embodiment of the present disclosure.

FIG. 59 shows wireless devices, based on an embodiment of the present disclosure.

FIG. 60 shows a signal process circuit for a transmission signal, based on an embodiment of the present disclosure.

FIG. 61 shows another example of a wireless device, based on an embodiment of the present disclosure.

FIG. 62 shows a hand-held device, based on an embodiment of the present disclosure.

FIG. 63 shows a vehicle or an autonomous vehicle, based on an embodiment of the present disclosure.

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

The 6G (wireless communication) system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with a machine learning capability. The vision of the 6G system can be in four aspects: intelligent connectivity, deep connectivity, holographic connectivity, and ubiquitous connectivity, and the 6G system may satisfy the requirements as shown in Table 1 below. In other words, Table 1 is an example of the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

6G system may have key factors such as eMBB(Enhanced mobile broadband), URLLC(Ultra-reliable low latency communications), mMTC(massive machine-type communication), Al integrated communication, Tactile internet, High throughput, High network capacity, High energy efficiency, Low backhaul and access network congestion, Enhanced data security.

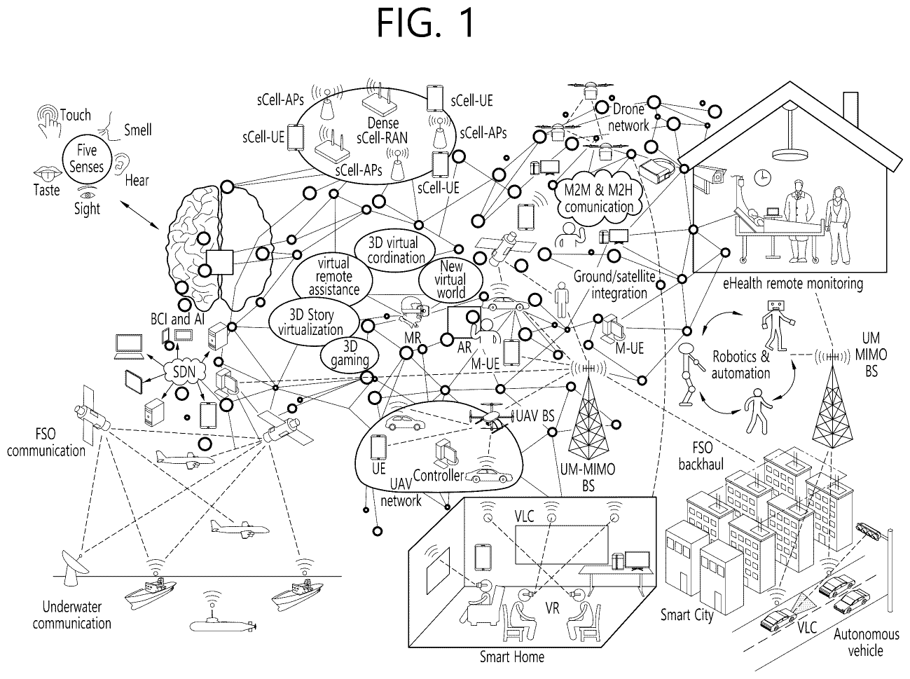

FIG. 1 shows a communication structure that can be provided in a 6G system, according to one embodiment of the present disclosure. The embodiment of FIG. 1 may be combined with various embodiments of the present disclosure.

6G systems are expected to have 50 times higher simultaneous radio connectivity than 5G radio systems. URLLC, a key feature of 5G, will become a more dominant technology in 6G communications by providing end-to-end delay of less than 1 ms. In 6G systems, volumetric spectral efficiency will be much better, as opposed to the area spectral efficiency often used today. 6G systems will be able to offer very long battery life and advanced battery technologies for energy harvesting, so mobile devices will not need to be recharged separately in 6G systems. In 6G, new network characteristics may be as follows.
Satellites integrated network: To provide a global mobile population, 6G is expected to be integrated with satellite. The integration of terrestrial, satellite, and airborne networks into a single wireless communication system is important for 6G.
Connected intelligence: Unlike previous generations of wireless communication systems, 6G is revolutionary and the wireless evolution will be updated from “connected things” to “connected intelligence”. Al can be applied at each step of the communication procedure (or each step of signal processing, as will be described later).
Seamless integration wireless information and energy transfer: 6G wireless networks will deliver power to charge batteries of devices such as smartphones and sensors. Therefore, wireless information and energy transfer (WIET) will be integrated.
Ubiquitous super 3D connectivity: Super 3D connection will be generated from 6G ubiquity to access networks and core network functions on drones and very low Earth orbit satellites.

Given the above new network characteristics of 6G, some common requirements may be as follows
small cell networks: The idea of small cell networks was introduced in cellular systems to improve received signal quality as a result of improved processing throughput, energy efficiency, and spectral efficiency. As a result, small cell networks are an essential characteristic for communication systems over 5G and beyond 5G (5 GB). Therefore, 6G communication systems will also adopt the characteristics of small cell networks.
Ultra-dense heterogeneous network: Ultra-dense heterogeneous networks will be another important characteristic of 6G communication systems. Multi-tier networks composed of heterogeneous networks will improve overall QoS and reduce costs.
High-capacity backhaul: Backhaul connection is characterized by high-capacity backhaul networks to support large volumes of traffic. High-speed fiber optics and free-space optics (FSO) systems may be a possible solution to this problem.
Radar technology integrated with mobile technology: High-precision localization (or location-based services) through communication is one of the features of 6G wireless communication systems. Therefore, radar systems will be integrated with 6G networks.
Softwarization and virtualization: Softwareization and virtualization are two important features that are fundamental to the design process in a 5 GB network to ensure flexibility, reconfigurability, and programmability. In addition, billions of devices may be shared on a shared physical infrastructure.

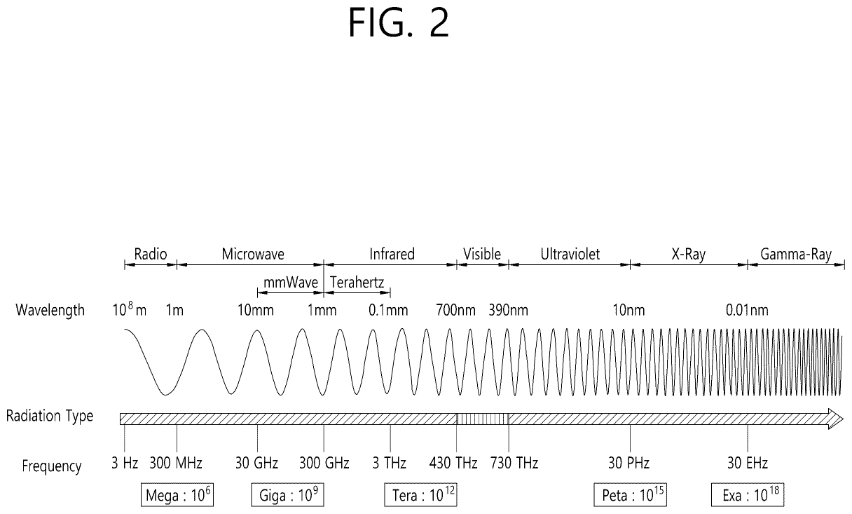

The following describes the core implementation technologies for 6G systems.
Artificial Intelligence: The most important and new technology that will be introduced in the 6G system is Al. The 4G system did not involve Al. 5G systems will support partial or very limited Al. However, 6G systems will be fully AI-enabled for automation. Advances in machine learning will create more intelligent networks for real-time communication in 6G. The introduction of Al in telecommunications may streamline and improve real-time data transmission. Al may use numerous analytics to determine the way complex target operations are performed, which means Al can increase efficiency and reduce processing delays. Time-consuming tasks such as handover, network selection, and resource scheduling can be done instantly by using Al. Al may also play an important role in M2M, machine-to-human, and human-to-machine communications. In addition, Al may become a rapid communication in Brain Computer Interface (BCI). AI-based communication systems can be supported by metamaterials, intelligent structures, intelligent networks, intelligent devices, intelligent cognitive radios, self-sustaining wireless networks, and machine learning.
THz Communication (Terahertz Communication): Data rates can be increased by increasing bandwidth. This can be accomplished by using sub-THz communication with a wide bandwidth and applying advanced massive MIMO technology. THz waves, also known as sub-millimeter radiation, refer to frequency bands between 0.1 and 10 THz with corresponding wavelengths typically ranging from 0.03 mm-3 mm. The 100 GHz-300 GHz band range (Sub THz band) is considered the main part of the THz band for cellular communications. Adding the Sub-THz band to the mmWave band increases the capacity of 6G cellular communications. 300 GHz-3 THz in the defined THz band is in the far infrared (IR) frequency band. The 300 GHz-3 THz band is part of the optical band, but it is on the border of the optical band, just behind the RF band. Thus, the 300 GHz-3 THz band exhibits similarities to RE. FIG. 2 shows an electromagnetic spectrum, according to one embodiment of the present disclosure. The embodiment of FIG. 2 may be combined with various embodiments of the present disclosure. Key characteristics of THz communications include (i) widely available bandwidth to support very high data rates, and (ii) high path loss at high frequencies (for which highly directive antennas are indispensable). The narrow beamwidth produced by highly directive antennas reduces interference. The small wavelength of THz signals allows a much larger number of antenna elements to be integrated into devices and BSs operating in this band. This enables the use of advanced adaptive array techniques that can overcome range limitations.
Large-scale MIMO
HBF, Hologram Bmeaforming
Optical wireless technology
FSO Backhaul Network
Non-Terrestrial Networks, NTN
Quantum Communication
Cell-free Communication
Integration of Wireless Information and Power Transmission
Integration of Wireless Communication and Sensing
Integrated Access and Backhaul Network
Big data Analysis
Reconfigurable Intelligent Surface
Metaverse
Block-chain

UAV, Unmanned Aerial Vehicle: Unmanned aerial vehicles (UAVs), or drones, will be an important component of 6G wireless communications. In most cases, high-speed data wireless connection is provided using UAV technology. A BS entity is installed on a UAV to provide cellular connection. UAVs have specific features not found in fixed BS infrastructure, such as easy deployment, strong line-of-sight links, and freedom of controlled mobility. During emergencies, such as natural disasters, the deployment of terrestrial communication infrastructure is not economically feasible and sometimes cannot provide services in volatile environments. UAVs can easily handle these situations. UAVs will be a new paradigm in wireless communications. This technology facilitates three basic requirements of wireless networks: eMBB, URLLC, and mMTC. UAVs can also support many other purposes such as enhancing network connectivity, fire detection, disaster emergency services, security and surveillance, pollution monitoring, parking monitoring, accident monitoring, etc. Therefore, UAV technology is recognized as one of the most important technologies for 6G communications.

Autonomous Driving, Self-driving: For perfect autonomous driving, vehicles must communicate with each other to inform each other of dangerous situations, or with infrastructure such as parking lots and traffic lights to check information such as the location of parking information and signal change times. Vehicle to Everything (V2X), a key element in building an autonomous driving infrastructure, is a technology that allows vehicles to communicate and share information with various elements on the road, in order to perform autonomous driving, such as vehicle-to-vehicle (V2V) wireless communication and vehicle-to-infrastructure (V2I) wireless communication. In order to maximize the performance of autonomous driving and ensure high safety, fast transmission speeds and low latency technologies are essential. In addition, in the future, autonomous driving will go beyond delivering warnings or guidance messages to a driver to actively intervene in vehicle operation and directly control the vehicle in dangerous situations, so the amount of information that needs to be transmitted and received will be vast, and 6G is expected to maximize autonomous driving with faster transmission speeds and lower latency than 5G.

For the sake of clarity, the description focuses on 5G NR, but the technical ideas of one embodiment of the present disclosure are not limited thereto. Various embodiments of the present disclosure may also be applicable to 6G communication systems.

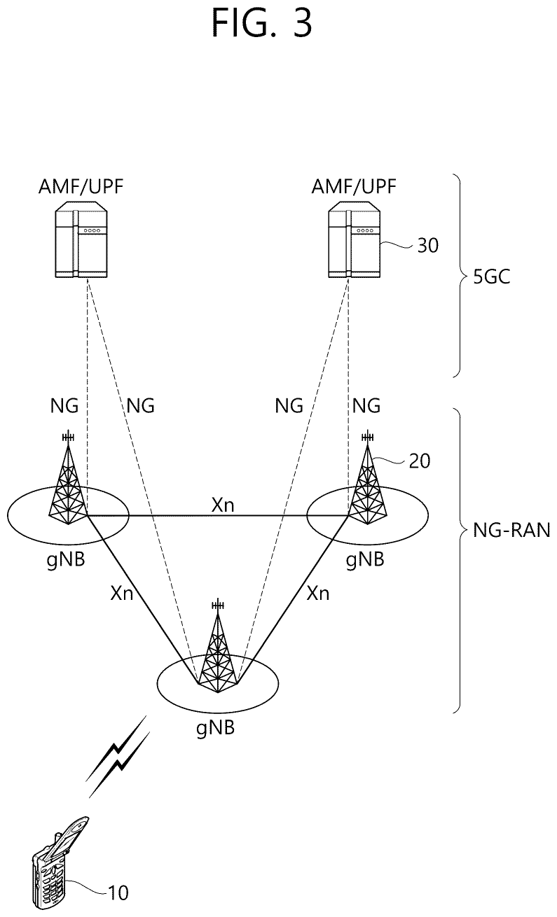

FIG. 3 shows a structure of an NR system, based on an embodiment of the present disclosure. The embodiment of FIG. 3 may be combined with various embodiments of the present disclosure.

Referring to FIG. 3, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 3 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

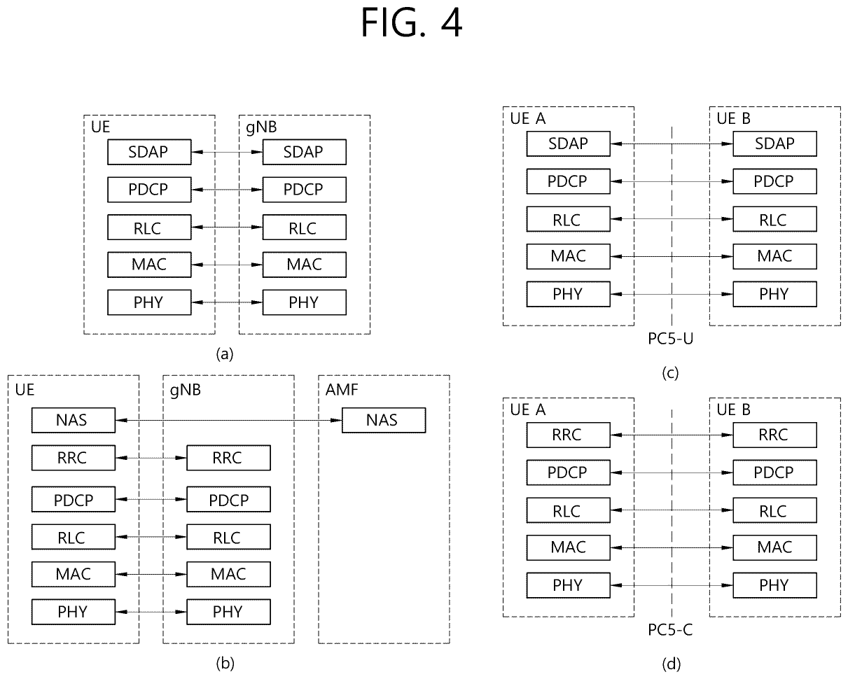

FIG. 4 shows a radio protocol architecture, based on an embodiment of the present disclosure. The embodiment of FIG. 4 may be combined with various embodiments of the present disclosure. Specifically, (a) of FIG. 4 shows a radio protocol stack of a user plane for Uu communication, and (b) of FIG. 4 shows a radio protocol stack of a control plane for Uu communication. (c) of FIG. 4 shows a radio protocol stack of a user plane for SL communication, and (d) of FIG. 4 shows a radio protocol stack of a control plane for SL communication.

Referring to FIG. 4, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., a MAC layer, an RLC layer, a packet data convergence protocol (PDCP) layer, and a service data adaptation protocol (SDAP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

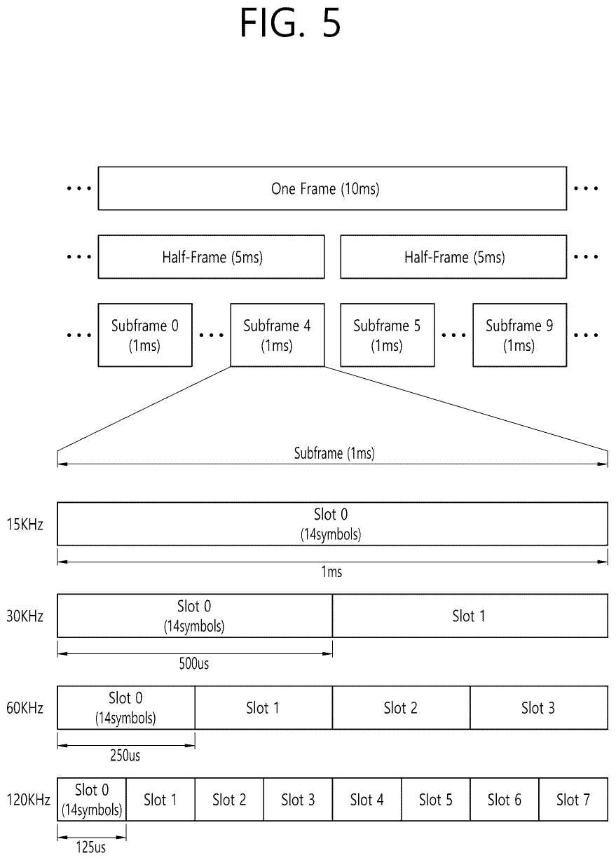

FIG. 5 shows a structure of a radio frame of an NR, based on an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five Tms subframes (SFs). A subframe (SF) may be spread into one or more slots, and the number of slots within a subframe may be determined based on subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

The following Table 2 shows the number of symbols per slot (N^{slot}_{symb}), number of slots per frame (N^{frame,u}ₛₗₒₜ), and number of slots per subframe (N^{subframe,u}ₛₗₒₜ), depending on the SCS configuration (u), when Normal CP or Extended CP is used.

TABLE 2

| CP type | SCS (15*2^{u}) | N^{slot}_{symb} | N^{frame, u}ₛₗₒₜ | N^{subframe, u}ₛₗₒₜ |
|---|---|---|---|---|
| normal CP | 15 kHz (u = 0) | 14 | 10 | 1 |
| | 30 kHz (u = 1) | 14 | 20 | 2 |
| | 60 kHz (u = 2) | 14 | 40 | 4 |
| | 120 kHz (u = 3) | 14 | 80 | 8 |
| | 240 kHz (u = 4) | 14 | 160 | 16 |
| extended CP | 60 kHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | Subcarrier | |
|---|---|---|---|
| designation | frequency range | Spacing (SCS) | |
| FR1 | 450 MHz-6000 MHz | 15, 30, 60 | kHz |
| FR2 | 24250 MHz-52600 MHz | 60, 120, 240 | kHz |

As described above, the values of the frequency ranges in the NR system may be changed (or varied). For example, as shown below in Table 4, FR1 may include a band within a range of 410 MHz to 7125 MHz. More specifically, FRI may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

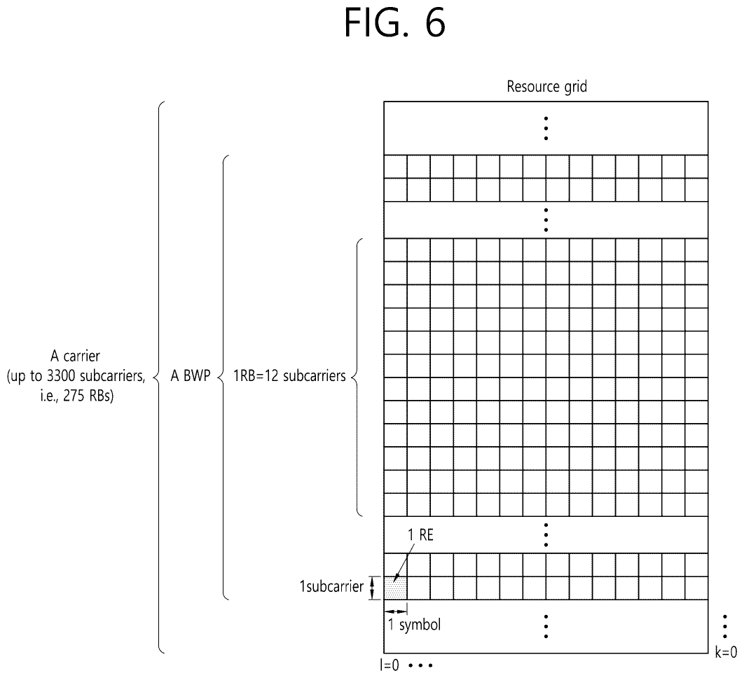

FIG. 6 shows a structure of a slot of an NR frame, based on an embodiment of the present disclosure. The embodiment of FIG. 6 may be combined with various embodiments of the present disclosure.

Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols. A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on).

A carrier may include a maximum of N number BWPs (e.g., 5 BWPs). Data communication may be performed via an activated BWP. Each element may be referred to as a Resource Element (RE) within a resource grid and one complex symbol may be mapped to each element.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. For example, the UE may receive a configuration for the Uu BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

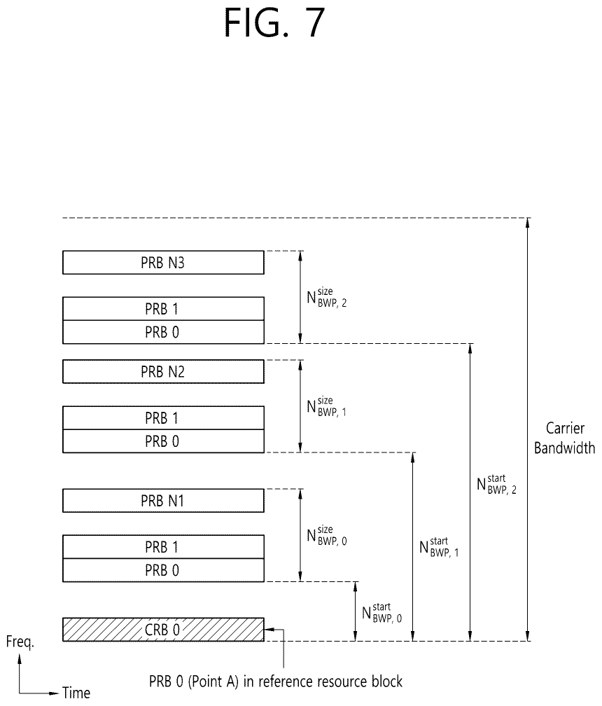

FIG. 7 shows an example of a BWP, based on an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{star}BWP from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

A sidelink synchronization signal (SLSS) may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit cyclic redundancy check (CRC).

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

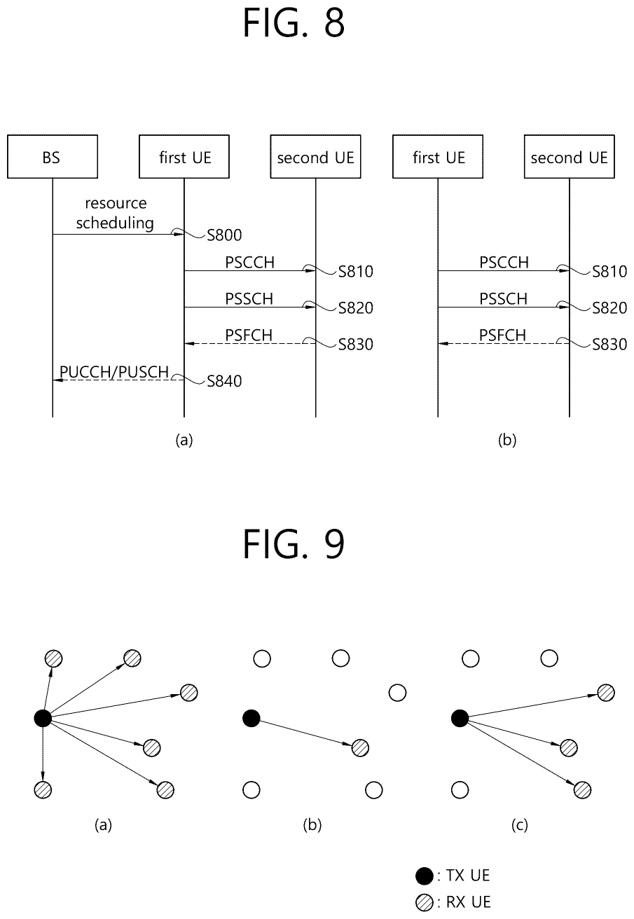

FIG. 8 shows a procedure of performing V2X or SL communication by a UE based on a transmission mode, based on an embodiment of the present disclosure. The embodiment of FIG. 8 may be combined with various embodiments of the present disclosure. In various embodiments of the present disclosure, for example, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, (a) of FIG. 8 shows a UE operation related to an LTE transmission mode 1 or an LTE transmission mode 3. Alternatively, for example, (a) of FIG. 8 shows a UE operation related to an NR resource allocation mode 1. For example, the LTE transmission mode 1 may be applied to general SL communication, and the LTE transmission mode 3 may be applied to V2X communication.

For example, (b) of FIG. 8 shows a UE operation related to an LTE transmission mode 2 or an LTE transmission mode 4. Alternatively, for example, (b) of FIG. 8 shows a UE operation related to an NR resource allocation mode 2.

Referring to (a) of FIG. 8, in the LTE transmission mode 1, the LTE transmission mode 3, or the NR resource allocation mode 1, a base station may schedule SL resource(s) to be used by a UE for SL transmission. For example, in step S800, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

In step S810, the first UE may transmit a PSCCH (e.g., sidelink control information (SCI) or 1st-stage SCI) to a second UE based on the resource scheduling. In step S820, the first UE may transmit a PSSCH (e.g., 2nd-stage SCI, MAC PDU, data, etc.) related to the PSCCH to the second UE. In step S830, the first UE may receive a PSFCH related to the PSCCH/PSSCH from the second UE. For example, HARQ feedback information (e.g., NACK information or ACK information) may be received from the second UE through the PSFCH. In step S840, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1.

Referring to (b) of FIG. 8, in the LTE transmission mode 2, the LTE transmission mode 4, or the NR resource allocation mode 2, a UE may determine SL transmission resource(s) within SL resource(s) configured by a base station/network or pre-configured SL resource(s). For example, the configured SL resource(s) or the pre-configured SL resource(s) may be a resource pool. For example, the UE may autonomously select or schedule resource(s) for SL transmission. For example, the UE may perform SL communication by autonomously selecting resource(s) within the configured resource pool. For example, the UE may autonomously select resource(s) within a selection window by performing a sensing procedure and a resource (re)selection procedure. For example, the sensing may be performed in a unit of subchannel(s). For example, in step S810, a first UE which has selected resource(s) from a resource pool by itself may transmit a PSCCH (e.g., sidelink control information (SCI) or 1st-stage SCI) to a second UE by using the resource(s). In step S820, the first UE may transmit a PSSCH (e.g., 2nd-stage SCI, MAC PDU, data, etc.) related to the PSCCH to the second UE. In step S830, the first UE may receive a PSFCH related to the PSCCH/PSSCH from the second UE.

Hereinafter, a UE procedure for determining a subset of resources to be reported to an higher layer in PSSCH resource selection in sidelink resource allocation mode 2 will be described.

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of msec.
if the higher layer requests the UE to determine a subset of resources from which the higher layer will select resources for PSSCH/PSCCH transmission as part of re-evaluation or pre-emption procedure, the higher layer provides a set of resources (r₀, r₁, r₂, . . . ) which may be subject to re-evaluation and a set of resources

$$( {r}_{0}^{′} , {r}_{1}^{′} , {r}_{2}^{′} , … )$$

which may be subject to pre-emption.
it is up to UE implementation to determine the subset of resources as requested by higher layers before or after the slot

$${r}_{i}^{″} - {T}_{3} , where {r}_{i}^{″}$$

is the slot with the smallest slot index among

$$( {r}_{0} , {r}_{1} , {r}_{2} , … ) and ( {r}_{0}^{′} , {r}_{1}^{′} , {r}_{2}^{′} , … ) , and {T}_{3} is equal to {T}_{proc , 1}^{SL} , where {T}_{proc , 1}^{SL}$$

is defined in slots, and where μ_{SL} is the SCS configuration of the SL BWP.

The following higher layer parameters affect this procedure:

sl-SelectionWindowList: internal parameter T₂ₘᵢₙ is set to the corresponding value from higher layer parameter sl-SelectionWindowList for the given value of prio_{TX}.
sl-Thres-RSRP-List: this higher layer parameter provides an RSRP threshold for each combination (pᵢ, pⱼ), where pᵢ is the value of the priority field in a received SCI format 1-A and pⱼ is the priority of the transmission of the UE selecting resources; for a given invocation of this procedure, pⱼ=prio_{TX}.
sl-RS-ForSensing selects if the UE uses the PSSCH-RSRP or PSCCH-RSRP measurement.
sl-ResourceReservePeriodList
sl-SensingWindow: internal parameter T₀ is defined as the number of slots corresponding to sl-SensingWindow msec.
sl-TxPercentageList: internal parameter X for a given prio_{TX} is defined as sl-TxPercentageList (prio_{TX}) converted from percentage to ratio.
sl-PreemptionEnable: if sl-PreemptionEnable is provided, and if it is not equal to ‘enabled’, internal parameter prioₚᵣₑ is set to the higher layer provided parameter sl-PreemptionEnable.

The resource reservation interval, P_{rsvp_TX}, if provided, is convened from units of msec to units of logical slots, resulting in

$${P}_{rsvp\_TX}^{′} .$$

$$\text{Notation:}$$

$$( {t}_{0}^{′ SL} , {t}_{1}^{′ SL} , {t}_{2}^{′ SL} , … )$$

may denote the set of slots which belongs to the sidelink resource pool.

For example, a UE may select a set of candidate resources (Sa) based on Table 5. For example, when resource (re)selection is triggered, a UE may select a candidate resource set (Sa) based on Table 5. For example, when re-evaluation or pre-emption is triggered, a UE may select a candidate resource set (Sa) based on Table 5.

TABLE 5
The following steps are used:
1) A candidate single-slot resource for transmission R_{x,y} is defined as a set of L_{subCH}
$contiguous sub - channels with sub - channel x + j in slot {t}_{y}^{′ SL} where j = 0 , … , {L}_{subCH} - 1.$
The UE shall assume that any set of L_{subCH} contiguous sub-channels included in the
corresponding resource pool within the time interval [n + T₁, n + T₂] correspond to one
candidate single-slot resource, where
$- selection of {T}_{1} is up to UE implementation under 0 \leq {T}_{1} \leq {T}_{proc , 1}^{SL} , where {T}_{proc , 1}^{SL}$
is defined in slots in Table 8.1.4-2 where μ_{SL} is the SCS configuration of the SL BWP;
- if T₂ₘᵢₙ is shorter than the remaining packet delay budget (in slots) then T₂ is up
to UE implementation subject to T₂ₘᵢₙ ≤ T₂ ≤ remaining packet delay budget (in
slots); otherwise T₂ is set to the remaining packet delay budget (in slots).
The total number of candidate single-slot resources is denoted by Mₜₒₜₐₗ.
$( 2 ) The sensing window is defined by the range of slots [ n - {T}_{0} , n - {T}_{proc , 0}^{SL} ) where {T}_{0}$
$is defined above and {T}_{proc , 0}^{SL} is defined in slots in Table 8.1 \text{.4} - 1 where {μ}_{SL} is the SCS$
configuration of the SL BWP. The UE shall monitor slots which belongs to a sidelink
resource pool within the sensing window except for those in which its own transmissions
occur. The UE shall perform the behaviour in the following steps based on PSCCH
decoded and RSRP measured in these slots.
3) The internal parameter Th(pᵢ, pⱼ) is set to the corresponding value of RSRP
threshold indicated by the i-th field in sl-Thres-RSRP-List, where i = pᵢ + (pⱼ - 1) * 8.
4) The set S_{A} is initialized to the set of all the candidate single-slot resources.
5) The UE shall exclude any candidate single-slot resource R_{x,y} from the set S_{A} if it
meets all the following conditions:
$- the UE has not monitored slot {t}_{m}^{′ SL} in Step 2.$
- for any periodicity value allowed by the higher layer parameter sl-
$ResourceReservePeriodList and a hypothetical SCI - format I - A recieved in slot {t}_{m}^{′ SL} with$
‘Resource reservation period’ field set to that periodicity value and indicating all
subchannels of the resource pool in this slot, condition c in step 6 would be met.
5a) If the number of candidate single-slot resources R_{x,y} remaining in the set S_{A} is
smaller than X · Mₜₒₜₐₗ, the set S_{A} is initialized to the set of all the candidate single-slot
resources as in step 4.
6) The UE shall exclude any candidate single-slot resource R_{x,y} from the set S_{A} if it
meets all the following conditions:
$a ) the UE recieves an SCI format 1 - A in slot {t}_{m}^{′ SL} , and ‘ Resource reservation period ’$
field, if present, and ‘Priority’ field in the received SCI format 1-A indicate the values
Pᵣₛᵥₚ_RX and prio_{Rx}, respectively according to Clause 16.4 in [6, TS 38.213];
b) the RSRP measurement performed, according to clause 8.4.2.1 for the received
SCI format 1-A, is higher than Th(prio_{Rx}, prio_{Tx});
$c ) the SCI format recieved in slot {t}_{m}^{′ SL} or the same SCI format which , if and only if$
the ‘Resource reservation period’ field is present in the received SCI format 1-A, is
$assumed to be recieved in slot ( s ) {t}_{m + q \times {P}_{rsvp \_ RX}^{′}}^{′ SL} determines according to clause 8.1 \text{.5} the$
$set of resource blocks and slots which overlaps with {R}_{x , y + j \times {P}_{rsvp \_ TX}^{′}} for q = 1 , 2 , … , Q and$
$j = 0 , 1 , … , {C}_{resel} - 1. Here , {P}_{rsvp \_ RX}^{′} is {P}_{rsvp \_ RX} converted to units of logical slots$
$according to clause 8.1 \text{.7} , Q = ⌈ \frac{{T}_{scal}}{{P}_{rsvp \_ RX}} ⌉ if {P}_{rsvp \_ RX} < {T}_{scal} and {n}^{′} - m \leq {P}_{rsvp \_ RX}^{′} ,$
$where {t}_{{n}^{′}}^{′ SL} = n if slot n belongs to the set ( {t}_{0}^{′ SL} , {t}_{1}^{′ SL} , … , {t}_{{T}_{max}^{′} - 1}^{′ SL} ) , otherwise slot {t}_{{n}^{′}}^{′ SL}$
$is the first slot after slot n belonging to the set ( {t}_{0}^{′ SL} , {t}_{1}^{′ SL} , … , {t}_{{T}_{max}^{′} - 1}^{′ SL} ) ; otherwise Q = 1.$
T_{scal} is set to selection window size T₂ converted to units of msec.
7) If the number of candidate single-slot resources remaining in the set S_{A} is smaller
than X · Mₜₒₜₐₗ, then Th(pᵢ, pⱼ) is increased by 3 dB for each priority value Th(pᵢ, pⱼ)
and the procedure continues with step 4.
The UE shall report set S_{A} to higher layers.
If a resource rᵢ from the set (r₀, r₁, r₂, . . . ) is not a member of S_{A}, then the UE shall
report re-evaluation of the resource rᵢ to higher layers.
$If a resource {r}_{i}^{′} from the set ( {r}_{0}^{′} , {r}_{1}^{′} , {r}_{2}^{′} , … ) meets the conditions below then the UE shall$
$report pre - emption of the resource {r}_{i}^{′} to higher layers$
$- {r}_{i}^{′} is not a member of {S}_{A} , and$
$- {r}_{i}^{′} meets the conditions for exclusion in step 6 , with Th ( {prio}_{RX} , {prio}_{TX} ) set to$
the final threshold after executing steps 1)-7), i.e. including all necessary increments for
reaching X · Mₜₒₜₐₗ, and
- the associated priority prio_{Rx}, satisfies one of the following conditions:
- sl-PreemptionEnable is provided and is equal to ‘enabled’ and prio_{TX} > prio_{RX}
- sl-PreemptionEnable is provided and is not equal to ‘enabled’, and prio_{RX} <
prioₚᵣₑ and prio_{TX} > prio_{RX}

Meanwhile, partial sensing may be supported for power saving of the UE. For example, in LTE SL or LTE V2X, the UE may perform partial sensing based on Tables 6 and 7.

TABLE 6
In sidelink transmission mode 4, when requested by higher layers in subframe n for a
carrier, the UE shall determine the set of resources to be reported to higher layers for
PSSCH transmission according to the steps described in this Subclause. Parameters L_{subCH}
the number of sub-channels to be used for the PSSCH transmission in a subframe, Pᵣₛᵥₚ_TX
the resource reservation interval, and prio_{TX} the priority to be transmitted in the
associated SCI format 1 by the UE are all provided by higher layers.
In sidelink transmission mode 3, when requested by higher layers in subframe n for a
carrier, the UE shall determine the set of resources to be reported to higher layers in
sensing measurement according to the steps described in this Subclause. Parameters
L_{subCH}, Pᵣₛᵥₚ_TX and prio_{TX} are all provided by higher layers. Cᵣₑₛₑₗ is determined by
Cᵣₑₛₑₗ = 10*SL_RESOURCE_RESELECTION_COUNTER, where
SL_RESOURCE_RESELECTION_COUNTER is provided by higher layers.
. . .
If partial sensing is configured by higher layers then the following steps are used:
1) A candidate single-subframe resource for PSSCH transmission R_{x,y} is defined as
$a set of {L}_{subCH} contiguous sub - channels with sub - channel x + j in subframe {t}_{y}^{SL} where$
j = 0, . . . , L_{subCH}-1. The UE shall determine by its implementation a set of subframes
which consists of at least Y subframes within the time interval [n + T₁, n + T₂] where
selections of T₁ and T₂ are up to UE implementations under T₁ ≤ 4 and
T₂ₘᵢₙ (prio_{TX}) ≤ T₂ ≤ 100, if T₂ₘᵢₙ (prio_{TX}) is provided by higher layers for prio_{TX},
otherwise 20 ≤ T₂ ≤ 100. UE selection of T₂ shall fulfil the latency requirement and Y
shall be greater than or equal to the high layer parameter minNumCandidateSF. The UE
shall assume that any set of L_{subCH} contiguous sub-channels included in the
corresponding PSSCH resource pool within the determined set of subframes correspond to
one candidate single-subframe resource. The total number of the candidate single-subframe
resources is denoted by Mₜₒₜₐₗ.
$2 ) If a subframe {t}_{y}^{SL} is included in the set of subframes in Step 1 , the UE shall$
$monitor any subframe {t}_{y - k \times {P}_{step}}^{SL} if k - th bit of the high layer parameter$
gapCandidateSensing is set to 1. The UE shall perform the behaviour in the following
steps based on PSCCH decoded and S-RSSI measured in these subframes.
3) The parameter Th_{a,b} is set to the value indicated by the i-th SL-ThresPSSCH-
RSRP field in SL-ThresPSSCH-RSRP-List where i = (a-1) * 8 + b.
4) The set S_{A} is initialized to the union of all the candidate single-subframe
resources. The set S_{B} is initialized to an empty set.
5) The UE shall exclude any candidate single-subframe resourceR_{x,y} from the set
S_{A} if it meets all the following conditions:
$- the UE recieves an SCI format 1 in subframe {t}_{m}^{S L} , and “ Resource reservation ” field$
and “Priority” field in the received SCI format 1 indicate the values Pᵣₛᵥₚ_RX and prio_{RX},
respectively.
- PSSCH-RSRP measurement according to the received SCI format 1 is higher than
Thₚᵣᵢₒ_{_{TX}}, ₚᵣᵢₒ_{_{RX}}.
$- the SCI format recieved in subframe {t}_{m}^{S L} or the same SCI format 1 which is$
$assumed to be received in subframe ( s ) {t}_{m + q \times {P}_{step} \times {P}_{{rsvp}_{RX}}}^{S L} determines according to$
14.1.1.4C the set of resource blocks and subframes which overlaps with R_{x,y+j×P′rsvp}_TX
$for q = 1 , 2 , … , Q and j = 0 , 1 , … , {C}_{resel} - 1. Here , Q = \frac{1}{{P}_{rsvp \_ RX}} if {P}_{rsvp \_ RX} and$
${y}^{′} - m \leq {P}_{step} \times {P}_{rsvp \_ RX} + {P}_{step} , where {t}_{y ′}^{S L} is the last subframe of the Y subframes ,$
and Q = 1 otherwise.
6) If the number of candidate single-subframe resources remaining in the set S_{A} is
smaller than 0.2 · Mₜₒₜₐₗ, then Step 4 is repeated with Th_{a,b} increased by 3 dB.

TABLE 7
(7) For a candidate single-subframe resource R_{x,y} remaining in the set S_{A}, the metric
E_{x,y} is defined as the linear average of S-RSSI measured in sub-channels x + k for
k = 0, . . . , L_{subCH}-1 in the monitored subframes in Step 2 that can be expressed by
${t}_{y - {P}_{s t e p} * j}^{S L} for a non - negative integer j .$
8) The UE moves the candidate single-subframe resource R_{x,y} with the smallest
metric E_{x,y} from the set S_{A} to S_{B}. This step is repeated until the number of candidate
single-subframe resources in the set S_{B} becomes greater than or equal to 0.2 · Mₜₒₜₐₗ.
9) When the UE is configured by upper layers to transmit using resource pools on
multiple carriers, it shall exclude a candidate single-subframe resource R_{x,y} from S_{B} if
the UE does not support transmission in the candidate single-subframe resource in the
carrier under the assumption that transmissions take place in other carrier(s) using the
already selected resources due to its limitation in the number of simultaneous transmission
carriers, its limitation in the supported carrier combinations, or interruption for RF retuning time.
The UE shall report set S_{B} to higher layers.
If transmission based on random selection is configured by upper layers and when the UE
is configured by upper layers to transmit using resource pools on multiple carriers, the
following steps are used:
1) A candidate single-subframe resource for PSSCH transmission R_{x,y} is defined as
$a set of {L}_{subCH} contiguous sub - channels with sub - channel x + j in subframe {t}_{y}^{S L} where$
j = 0, . . . , L_{subCH}-1. The UE shall assume that any set of L_{subCH} contiguous sub-
channels included in the corresponding PSSCH resource pool within the time interval [n +
T₁, n + T₂] corresponds to one candidate single-subframe resource, where selections of T₁
and T₂ are up to UE implementations under T₁ ≤ 4 and T₂ₘᵢₙ(prio_{TX}) ≤ T₂ ≤ 100, if
T₂ₘᵢₙ (prio_{TX}) is provided by higher layers for prio_{TX}, otherwise 20 ≤ T₂ ≤ 100. UE
selection of T₂ shall fulfil the latency requirement. The total number of the candidate
single-subframe resources is denoted by Mₜₒₜₐₗ.
2) The set S_{A} is initialized to the union of all the candidate single-subframe
resources. The set S_{B} is initialized to an empty set.
3) The UE moves the candidate single-subframe resource R_{x,y} from the set S_{A} to S_{B}.
4) The UE shall exclude a candidate single-subframe resource R_{x,y} from S_{B} if the
UE does not support transmission in the candidate single-subframe resource in the carrier
under the assumption that transmissions take place in other carrier(s) using the already
selected resources due to its limitation in the number of simultaneous transmission carriers,
its limitation in the supported carrier combinations, or interruption for RF retuning time.
The UE shall report set S_{B} to higher layers.

Referring to (a) or (b) of FIG. 8, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1st SCI, a first SCI, a 1st-stage SCI or a 1st-stage SCI format, and a SCI transmitted through a PSSCH may be referred to as a 2nd SCI, a second SCI, a 2nd-stage SCI or a 2nd-stage SCI format. For example, the 1st-stage SCI format may include a SCI format 1-A, and the 2nd-stage SCI format may include a SCI format 2-A and/or a SCI format 2-B.

Hereinafter, an example of SCI format 1-A will be described.

SCI format 1-A is used for the scheduling of PSSCH and 2nd-stage-SCI on PSSCH.

The following information is transmitted by means of the SCI format 1-A:
Priority-3 bits
Frequency resource assignment-ceiling (log₂(N^{SL}_{subChanel}(N^{SL}_{subChannel}+1)/2)) bits when the value of the higher layer parameter sl-MaxNumPerReserve is configured to 2; otherwise ceiling log₂(N^{SL}_{subchannel}(N^{SL}_{subchannel}+1)(2N^{SL}_{subChannel}+1)/6) bits when the value of the higher layer parameter sl-MaxNumPerReserve is configured to 3
Time resource assignment-5 bits when the value of the higher layer parameter sl-MaxNumPerReserve is configured to 2; otherwise 9 bits when the value of the higher layer parameter sl-MaxNumPerReserve is configured to 3
Resource reservation period-ceiling (log₂ N_{rsv_period}) bits, where N_{rsv_period} is the number of entries in the higher layer parameter sl-ResourceReservePeriodList, if higher layer parameter sl-MultiReserveResource is configured; 0 bit otherwise
DMRS pattern-ceiling (log₂ Nₚₐₜₑᵣₙ) bits, where Nₚₐₜₜₑᵣₙ is the number of DMRS patterns configured by higher layer parameter sl-PSSCH-DMRS-TimePattemList
2^{nd}-stage SCI format-2 bits as defined in Table 6
Beta_offset indicator-2 bits as provided by higher layer parameter sl-BetaOffsets2ndSCI
Number of DMRS port-1 bit as defined in Table 7
Modulation and coding scheme-5 bits
Additional MCS table indicator-1 bit if one MCS table is configured by higher layer parameter sl-Additional-MCS-Table; 2 bits if two MCS tables are configured by higher layer parameter sl-Additional-MCS-Table; 0 bit otherwise
PSFCH overhead indication-1 bit if higher layer parameter sl-PSFCH-Period=2 or 4; 0 bit otherwise
Reserved—a number of bits as determined by higher layer parameter sl-NumReservedBits, with value set to zero.

TABLE 8

| Value of 2nd-stage | 2nd-stage |
|---|---|
| SCI format field | SCI format |
| 00 | SCI format 2-A |
| 01 | SCI format 2-B |
| 10 | Reserved |
| 11 | Reserved |

TABLE 9

| Value of the Number | |
|---|---|
| of DMRS port field | Antenna ports |
| 0 | 1000 |
| 1 | 1000 and 1001 |

Hereinafter, an example of SCI format 2-A will be described.

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
HARQ process number-4 bits
New data indicator-1 bit
Redundancy version-2 bits
Source ID-8 bits
Destination ID-16 bits
HARQ feedback enabled/disabled indicator-1 bit
Cast type indicator-2 bits as defined in Table 10
CSI request-1 bit

TABLE 10

| Value of Cast | |
|---|---|
| type indicator | Cast type |
| 00 | Broadcast |
| 01 | Groupcast when HARQ-ACK |
| | information includes ACK or NACK |
| 10 | Unicast |
| 11 | Groupcast when HARQ-ACK |
| | information includes only NACK |

Hereinafter, an example of SCI format 2-B will be described.

SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number-4 bits
New data indicator-1 bit
Redundancy version-2 bits
Source ID-8 bits
Destination ID-16 bits
HARQ feedback enabled/disabled indicator-1 bit
Zone ID-12 bits
Communication range requirement-4 bits determined by higher layer parameter sl-ZoneConfigMCR-Index

Referring to (a) or (b) of FIG. 8, in step S830, the first UE may receive the PSFCH. For example, the first UE and the second UE may determine a PSFCH resource, and the second UE may transmit HARQ feedback to the first UE using the PSFCH resource.

Referring to (a) of FIG. 8, in step S840, the first UE may transmit SL HARQ feedback to the base station through the PUCCH and/or the PUSCH.

FIG. 9 shows three cast types, in accordance with an embodiment of the present disclosure. The embodiment of FIG. 9 may be combined with various embodiments of the present disclosure. Specifically, FIG. 9(a) shows broadcast-type SL communication, FIG. 9(b) shows unicast type-SL communication, and FIG. 9(c) shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, for example, SL groupcast communication may be replaced with SL multicast communication, SL one-to-many communication, or the like.

Meanwhile, in the conventional unlicensed spectrum (NR-U), a communication method between a UE and a base station is supported in an unlicensed band. In addition, a mechanism for supporting communication in an unlicensed band between sidelink UEs is planned to be supported in Rel-18.

In the present disclosure, a channel may refer to a set of frequency domain resources in which Listen-Before-Talk (LBT) is performed. In NR-U, the channel may refer to an LBT bandwidth with 20 MHz and may have the same meaning as an RB set. For example, the RB set may be defined in section 7 of 3GPP TS 38.214 V17.0.0.

In the present disclosure, channel occupancy (CO) may refer to time/frequency domain resources obtained by the base station or the UE after LBT success.

In the present disclosure, channel occupancy time (COT) may refer to time domain resources obtained by the base station or the UE after LBT success. It may be shared between the base station (or the UE) and the UE (or the base station) that obtained the CO, and this may be referred to as COT sharing. Depending on the initiating device, this may be referred to as gNB-initiated COT or UE-initiated COT.

Hereinafter, a wireless communication system supporting an unlicensed band/shared spectrum will be described.

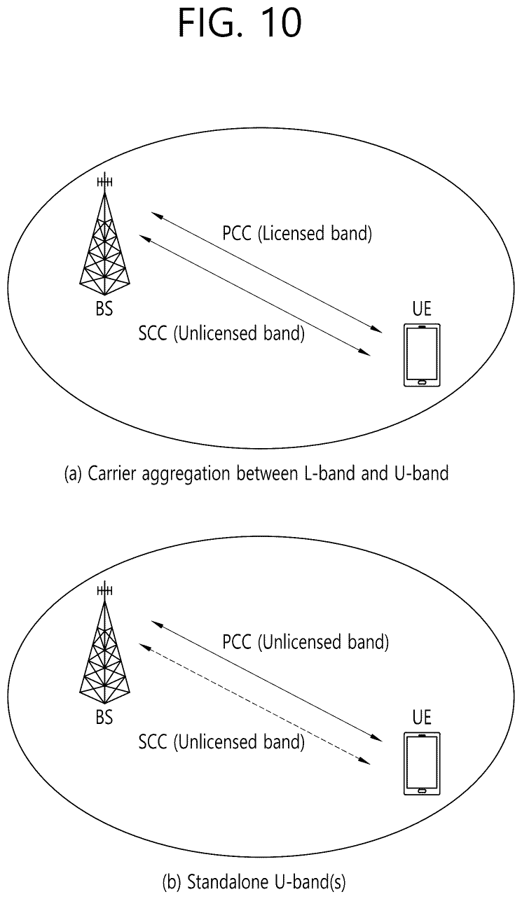

For example, FIG. 10 may include an unlicensed spectrum (U-S) wireless communication system. The embodiments of FIG. 10 may be combined with various embodiments of the present disclosure.

In the following description, a cell operating in a licensed band (hereinafter, L-band) may be defined as an L-cell, and a carrier of the L-cell may be defined as a (DL/UL/SL) LCC. In addition, a cell operating in an unlicensed band (hereinafter, U-band) may be defined as a U-cell, and a carrier of the U-cell may be defined as a (DL/UL/SL) UCC. The carrier/carrier-frequency of a cell may refer to the operating frequency (e.g., center frequency) of the cell. A cell/carrier (e.g., CC) is commonly called a cell.

When the base station and the UE transmit and receive signals on carrier-aggregated LCC and UCC as shown in (a) of FIG. 10, the LCC and the UCC may be configured as a primary CC (PCC) and a secondary CC (SCC), respectively. The base station and the UE may transmit and receive signals on one UCC or on a plurality of carrier-aggregated UCCs as shown in (b) of FIG. 10. In other words, the base station and the UE may transmit and receive signals only on UCC(s) without using any LCC. For a standalone operation, PRACH transmission, PUCCH transmission, PUSCH transmission, SRS transmission, etc. may be supported on a UCell.

In the embodiment of FIG. 10, the base station may be replaced with the UE. In this case, for example, PSCCH transmission, PSSCH transmission, PSFCH transmission, S-SSB transmission, etc. may be supported on a UCell.

Unless otherwise noted, the definitions below are applicable to the following terminologies used in the present disclosure.
Channel: a carrier or a part of a carrier composed of a contiguous set of RBs in which a channel access procedure is performed in a shared spectrum.
Channel access procedure (CAP): a procedure of assessing channel availability based on sensing before signal transmission in order to determine whether other communication node(s) are using a channel. A basic sensing unit is a sensing slot with a duration of Tₛₗ=9 us. The base station or the UE senses a channel during a sensing slot duration. If power detected for at least 4 us within the sensing slot duration is less than an energy detection threshold Xₜᵣₑₛₕ, the sensing slot duration Ti is considered to be idle. Otherwise, the sensing slot duration Tₛₗ=9 us is considered to be busy. CAP may also be referred to as listen before talk (LBT).
Channel occupancy: transmission(s) on channel(s) by the base station/UE after a channel access procedure.
Channel occupancy time (COT): a total time during which the base station/UE and any base station/UE(s) sharing channel occupancy may perform transmission(s) on a channel after the base station/UE perform a channel access procedure. In the case of determining COT, if a transmission gap is less than or equal to 25 us, the gap duration may be counted in the COT. The COT may be shared for transmission between the base station and corresponding UE(s).
DL transmission burst: a set of transmissions without any gap greater than 16 us from the base station. Transmissions from the base station, which are separated by a gap exceeding 16 us are considered as separate DL transmission bursts. The base station may perform transmission(s) after a gap without sensing channel availability within a DL transmission burst.
UL or SL transmission burst: a set of transmissions without any gap greater than 16 us from the UE. Transmissions from the UE, which are separated by a gap exceeding 16 us are considered as separate UL or SL transmission bursts. The UE may perform transmission(s) after a gap without sensing channel availability within a UL or SL transmission burst.
Discovery burst: a DL transmission burst including a set of signal(s) and/or channel(s) confined within a window and associated with a duty cycle. In the LTE-based system, the discovery burst may be transmission(s) initiated by the base station, which includes PSS, an SSS, and cell-specific RS (CRS) and further includes non-zero power CSI-RS. In the NR-based system, the discover burst may be transmission(s) initiated by the base station, which includes at least an SS/PBCH block and further includes CORESET for a PDCCH scheduling a PDSCH carrying SIB1, the PDSCH carrying SIB1, and/or non-zero power CSI-RS.

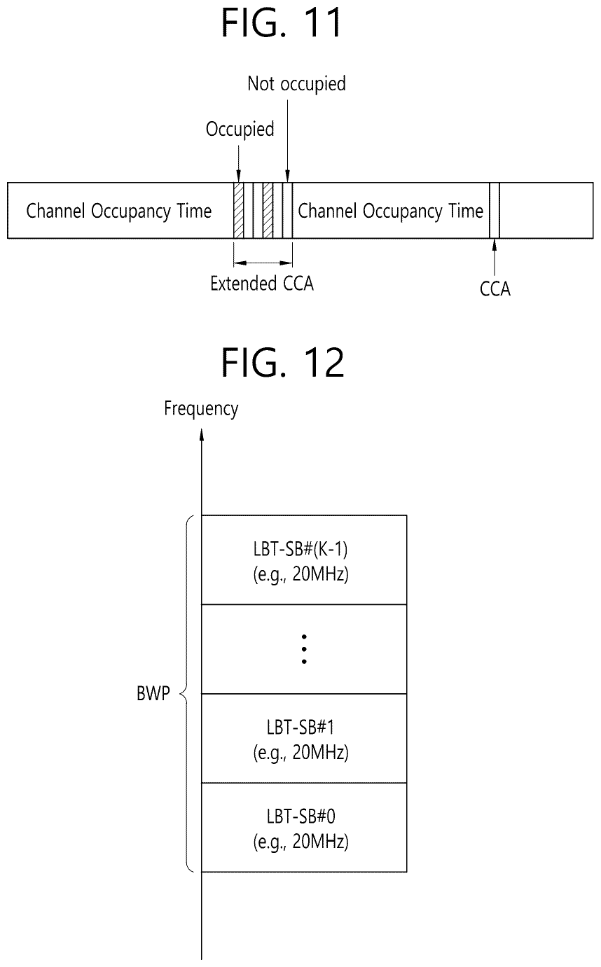

FIG. 11 shows a method of occupying resources in an unlicensed band, based on an embodiment of the present disclosure. The embodiment of FIG. 11 may be combined with various embodiments of the present disclosure.

Referring to FIG. 11, a communication node (e.g., base station, UE) within an unlicensed band should determine whether other communication node(s) is using a channel before signal transmission. To this end, the communication node within the unlicensed band may perform a channel access procedure (CAP) to access channel(s) on which transmission(s) is performed. The channel access procedure may be performed based on sensing. For example, the communication node may perform carrier sensing (CS) before transmitting signals so as to check whether other communication node(s) perform signal transmission. When the other communication node(s) perform no signal transmission, it is the that clear channel assessment (CCA) is confirmed. If a CCA threshold (e.g., X_{Thresh}) is predefined or configured by a higher layer (e.g., RRC), the communication node may determine that the channel is busy if the detected channel energy is higher than the CCA threshold. Otherwise, the communication node may determine that the channel is idle. If it is determined that the channel is idle, the communication node may start the signal transmission in the unlicensed band. The CAP may be replaced with the LBT.

Table 11 shows an example of the channel access procedure (CAP) supported in NR-U.

TABLE 11

| | Type | Explanation |
|---|---|---|
| DL | Type 1 CAP | CAP with random back-off |
| | | time duration spanned by the sensing slots that are sensed |
| | | to be idle before a downlink transmission(s) is random |
| | Type 2 CAP | CAP without random back-off |
| | Type 2A, 2B, 2C | time duration spanned by sensing slots that are sensed to |
| | | be idle before a downlink transmission(s) is deterministic |
| UL or | Type 1 CAP | CAP with random back-off |
| SL | | time duration spanned by the sensing slots that are sensed |
| | | to be idle before an uplink or sidelink transmission(s) is |
| | | random |
| | Type 2 CAP | CAP without random back-off |
| | Type 2A, 2B, 2C | time duration spanned by sensing slots that are sensed to |
| | | be idle before an uplink or sidelink transmission(s) is |
| | | deterministic |

Referring to Table 11, the LBT type or CAP for DL/UL/SL transmission may be defined. However, Table 11 is only an example, and a new type or CAP may be defined in a similar manner. For example, the type 1 (also referred to as Cat-4 LBT) may be a random back-off based channel access procedure. For example, in the case of Cat-4, the contention window may change. For example, the type 2 may be performed in case of COT sharing within COT acquired by the base station (gNB) or the UE.

Hereinafter, LBT-SubBand (SB) (or RB set) will be described.

In a wireless communication system supporting an unlicensed band, one cell (or carrier (e.g., CC)) or BWP configured for the UE may have a wideband having a larger bandwidth (BW) than in legacy LTE. However, a BW requiring CCA based on an independent LBT operation may be limited according to regulations. Let a subband (SB) in which LBT is individually performed be defined as an LBT-SB. Then, a plurality of LBT-SBs may be included in one wideband cell/BWP. A set of RBs included in an LBT-SB may be configured by higher-layer (e.g., RRC) signaling. Accordingly, one or more LBT-SBs may be included in one cell/BWP based on (i) the BW of the cell/BWP and (ii) RB set allocation information.

FIG. 12 shows a case in which a plurality of LBT-SBs are included in an unlicensed band, based on an embodiment of the present disclosure. The embodiment of FIG. 12 may be combined with various embodiments of the present disclosure.

Referring to FIG. 12, a plurality of LBT-SBs may be included in the BWP of a cell (or carrier). An LBT-SB may have, for example, a 20-MHz band. The LBT-SB may include a plurality of contiguous (P)RBs in the frequency domain, and thus may be referred to as a (P)RB set. While not shown, a guard band (GB) may be interposed between LBT-SBs. Accordingly, the BWP may be configured in the form of {LBT-SB #0 (RB set #0)+GB #0+LBT-SB #1 (RB set #1+GB #1)+ . . . +LBT-SB #(K-1) (RB set (#K-1))}. For convenience, LBT-SB/RB indexes may be configured/defined in an increasing order from the lowest frequency to the highest frequency.

Hereinafter, a channel access priority class (CAPC) will be described.

The CAPCs of MAC CEs and radio bearers may be fixed or configured to operate in FR1:
Fixed to lowest priority for padding buffer status report (BSR) and recommended bit rate MAC CE;
Fixed to highest priority for SRB0, SRB1, SRB3 and other MAC CEs;
Configured by the base station for SRB2 and DRB.

When selecting a CAPC of a DRB, the base station considers fairness between other traffic types and transmissions while considering 5QI of all QoS flows multiplexed to the corresponding DRB. Table 12 shows which CAPC should be used for standardized 5QI, that is, a CAPC to be used for a given QoS flow. For standardized 5QI, CAPCs are defined as shown in the table below, and for non-standardized 5QI, the CAPC with the best QoS characteristics should be used.

TABLE 12

| CAPC | 5QI |
|---|---|
| 1 | 1, 3, 5, 65, 66, 67, 69, 70, |
| | 79, 80, 82, 83, 84, 85 |
| 2 | 2, 7, 71 |
| 3 | 4, 6, 8, 9, 72, 73, 74, 76 |
| 4 | — |

NOTE:
A lower CAPC value indicates a higher priority.

Hereinafter, a method of transmitting a downlink signal through an unlicensed band will be described. For example, a method of transmitting a downlink signal through an unlicensed band may be applied to a method of transmitting a sidelink signal through an unlicensed band.

The base station may perform one of the following channel access procedures (e.g., CAP) for downlink signal transmission in an unlicensed band.

(1) Type 1 downlink (DL) CAP Method

In the type 1 DL CAP, the length of a time duration spanned by sensing slots sensed to be idle before transmission(s) may be random. The type 1 DL CAP may be applied to the following transmissions:
Transmission(s) initiated by the base station including (i) a unicast PDSCH with user plane data or (ii) the unicast PDSCH with user plane data and a unicast PDCCH scheduling user plane data, or
Transmission(s) initiated by the base station including (i) a discovery burst only or (ii) a discovery burst multiplexed with non-unicast information.

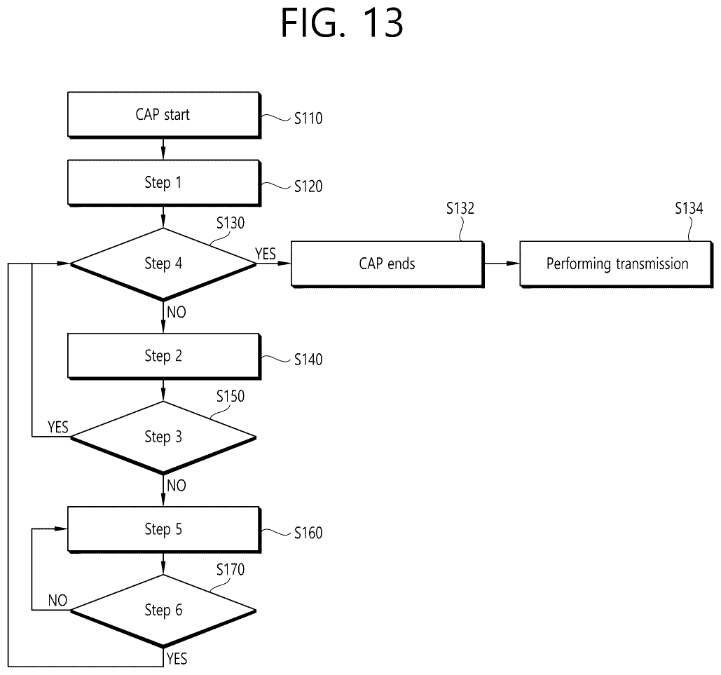

FIG. 13 shows CAP operations performed by a base station to transmit a downlink signal through an unlicensed band, based on an embodiment of the present disclosure. The embodiment of FIG. 13 may be combined with various embodiments of the present disclosure.

Referring to FIG. 13, the base station may sense whether a channel is idle for sensing slot durations of a defer duration T_{d}. Then, if a counter N is zero, the base station may perform transmission (S134). In this case, the base station may adjust the counter N by sensing the channel for additional sensing slot duration(s) according to the following steps:

Step 1) (S120) The base station sets N to Nᵢₙᵢₜ (N=Nᵢₙᵢₜ), where Nᵢₙᵢₜ is a random number uniformly distributed between 0 and CWₚ. Then, step 4 proceeds.

Step 2) (S140) If N>0 and the base station determines to decrease the counter, the base station sets N to N−1 (N=N−1).

Step 3) (S150) The base station senses the channel for the additional sensing slot duration. If the additional sensing slot duration is idle (Y), step 4 proceeds. Otherwise (N), step 5 proceeds.

Step 4) (S130) If N=0 (Y), the base station terminates the CAP (S132). Otherwise (N), step 2 proceeds.

Step 5) (S160) The base station senses the channel until either a busy sensing slot is detected within an additional defer duration T_{d} or all the slots of the additional defer duration Td are detected to be idle.

Step 6) (S170) If the channel is sensed to be idle for all the slot durations of the additional defer duration T_{d} (Y), step 4 proceeds. Otherwise (N), step 5 proceeds.

Table 13 shows that mₚ, a minimum contention window (CW), a maximum CW, a maximum channel occupancy time (MCOT), and an allowed CW size, which are applied to the CAP, vary depending on channel access priority classes.

TABLE 13

| Channel Access | | | | | |
|---|---|---|---|---|---|
| Priority Class (p) | mₚ | CW_{min, p} | CW_{max, p} | T_{mcot, p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

Referring to Table 13, a contention window size (CWS), a maximum COT value, etc. for each CAPC may be defined. For example, Td may be equal to T_{f}+mₚ*Tₛₗ (T_{d}=T_{f}+mₚ*Tₛₗ).

The defer duration T_{d} is configured in the following order: duration T_{f} (16 us)+mₚ consecutive sensing slot durations Tₛₗ(9 us). T_{f} includes the sensing slot duration Tₛₗ at the beginning of the 16 us duration.

The following relationship is satisfied: CW_{min,p}<=CWₚ<=CW_{max,p}. CWₚ may be configured by CWₚ=CW_{min,p} and updated before step 1 based on HARQ-ACK feedback (e.g., the ratio of ACK or NACK) for a previous DL burst (e.g., PDSCH) (CW size update). For example, CWₚ may be initialized to CW_{min,p} based on the HARQ-ACK feedback for the previous DL burst. Alternatively, CWₚ may be increased to the next higher allowed value or maintained as it is.

### (2) Type 2 Downlink (DL) CAP Method

In the type 2 DL CAP, the length of a time duration spanned by sensing slots sensed to be idle before transmission(s) may be determined. The type 2 DL CAP is classified into type 2A/2B/2C DL CAPs.

The type 2A DL CAP may be applied to the following transmissions. In the type 2A DL CAP, the base station may perform transmission immediately after the channel is sensed to be idle at least for a sensing duration T_{short_dl}=25 us. Herein, T_{short_dl} includes the duration T_{f} (=16 us) and one sensing slot duration immediately after the duration T_{f}, where the duration T_{f} includes a sensing slot at the beginning thereof.
Transmission(s) initiated by the base station including (i) a discovery burst only or (ii) a discovery burst multiplexed with non-unicast information, or
Transmission(s) by the base station after a gap of 25 us from transmission(s) by the UE within a shared channel occupancy.

The type 2B DL CAP is applicable to transmission(s) performed by the base station after a gap of 16 us from transmission(s) by the UE within a shared channel occupancy time. In the type 2B DL CAP, the base station may perform transmission immediately after the channel is sensed to be idle for T_{f}=16 us. T_{f} includes a sensing slot within 9 us from the end of the duration. The type 2C DL CAP is applicable to transmission(s) performed by the base station after a maximum of 16 us from transmission(s) by the UE within the shared channel occupancy time. In the type 2C DL CAP, the base station does not perform channel sensing before performing transmission.

Hereinafter, a method of transmitting an uplink signal through an unlicensed band will be described. For example, a method of transmitting an uplink signal through an unlicensed band may be applied to a method of transmitting a sidelink signal through an unlicensed band.

The UE may perform type 1 or type 2 CAP for UL signal transmission in an unlicensed band. In general, the UE may perform the CAP (e.g., type 1 or type 2) configured by the base station for UL signal transmission. For example, a UL grant scheduling PUSCH transmission (e.g., DCI formats 0_0 and 01) may include CAP type indication information for the UE.

(1) Type 1 uplink (UL) CAP Method

In the type 1 UL CAP, the length of a time duration spanned by sensing slots sensed to be idle before transmission(s) is random. The type 1 UL CAP may be applied to the following transmissions.
PUSCH/SRS transmission(s) scheduled and/or configured by the base station
PUCCH transmission(s) scheduled and/or configured by the base station
Transmission(s) related to a random access procedure (RAP)

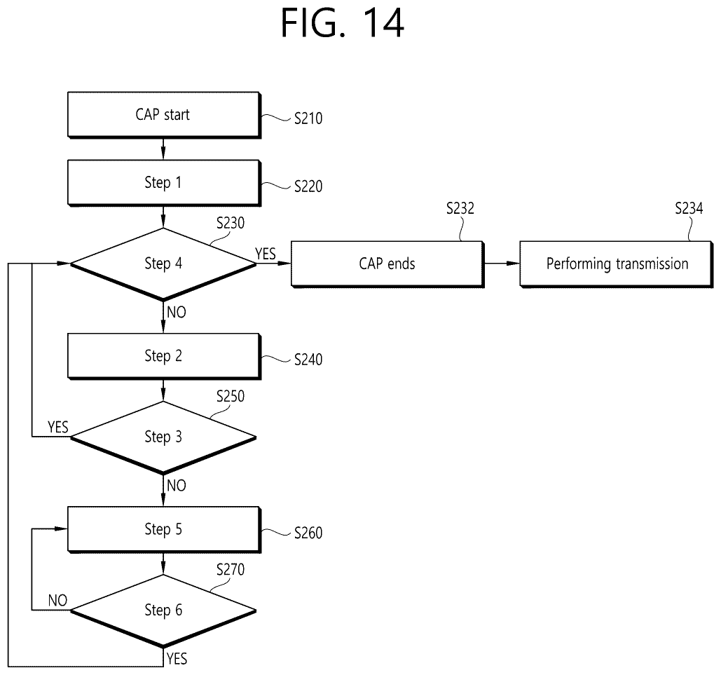

FIG. 14 shows type 1 CAP operations performed by a UE to transmit an uplink signal, based on an embodiment of the present disclosure. The embodiment of FIG. 14 may be combined with various embodiments of the present disclosure.

Referring to FIG. 14, the UE may sense whether a channel is idle for sensing slot durations of a defer duration T_{d}. Then, if a counter N is zero, the UE may perform transmission (S234). In this case, the UE may adjust the counter N by sensing the channel for additional sensing slot duration(s) according to the following steps:

Step 1) (S220) The UE sets N to Nᵢₙᵢₜ (N=Nᵢₙᵢₜ), where Nᵢₙᵢₜ is a random number uniformly distributed between 0 and CWₚ. Then, step 4 proceeds.

Step 2) (S240) If N>0 and the UE determines to decrease the counter, the UE sets N to N−1 (N=N−1).

Step 3) (S250) The UE senses the channel for the additional sensing slot duration. If the additional sensing slot duration is idle (Y), step 4 proceeds. Otherwise (N), step 5 proceeds.

Step 4) (S230) If N=0 (Y), the UE terminates the CAP (S232). Otherwise (N), step 2 proceeds.

Step 5) (S260) The UE senses the channel until either a busy sensing slot is detected within an additional defer duration T_{d} or all the slots of the additional defer duration T_{d} are detected to be idle.

Step 6) (5270) If the channel is sensed to be idle for all the slot durations of the additional defer duration T_{d} (Y), step 4 proceeds. Otherwise (N), step 5 proceeds.

Table 14 shows that mₚ, a minimum CW, a maximum CW, a maximum channel occupancy time (MCOT), and an allowed CW size, which are applied to the CAP, vary depending on channel access priority classes.

TABLE 14

| Channel Access | | | | | |
|---|---|---|---|---|---|
| Priority Class (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 or 10 ms | {15, 31, 63, 127, |
| | | | | | 255, 511, 1023} |
| 4 | 7 | 15 | 1023 | 6 or 10 ms | {15, 31, 63, 127, |
| | | | | | 255, 511, 1023} |

Referring to Table 14, a contention window size (CWS), a maximum COT value, etc. for each CAPC may be defined. For example, T_{d} may be equal to T_{f}+mₚ*Tₛₗ (T_{d}=T_{f}+mₚ*Tₛₗ).

The defer duration T_{d} is configured in the following order: duration T_{f} (16 us)+mₚ consecutive sensing slot durations Tₛₗ(9 us). T_{f} includes the sensing slot duration Ti at the beginning of the 16 us duration.

The following relationship is satisfied: CW_{min,p}<=CWₚ<=CW_{max,p}. CWₚ may be configured by CWₚ=CW_{min,p} and updated before step 1 based on an explicit/implicit reception response for a previous UL burst (e.g., PUSCH) (CW size update). For example, CWₚ may be initialized to CW_{min,p} based on the explicit/implicit reception response for the previous UL burst. Alternatively, CWₚ may be increased to the next higher allowed value or maintained as it is.

(2) Type 2 uplink (UL) CAP Method

In the type 2 UL CAP, the length of a time duration spanned by sensing slots sensed to be idle before transmission(s) may be determined. The type 2 UL CAP is classified into type 2A/2B/2C UL CAPs. In the type 2A UL CAP, the UE may perform transmission immediately after the channel is sensed to be idle at least for a sensing duration T_{short_dl}l=25 us. Herein, T_{short_dl} includes the duration T_{f} (=16 us) and one sensing slot duration immediately after the duration T_{f}. In the type 2A UL CAP, T_{f} includes a sensing slot at the beginning thereof. In the type 2B UL CAP, the UE may perform transmission immediately after the channel is sensed to be idle for the sensing duration T_{f}=16 us. In the type 2B UL CAP, T_{f} includes a sensing slot within 9 us from the end of the duration. In the type 2C UL CAP, the UE does not perform channel sensing before performing transmission.

For example, according to the type 1 LBT-based NR-U operation, the UE having uplink data to be transmitted may select a CAPC mapped to 5QI of data, and the UE may perform the NR-U operation by applying parameters of the corresponding CACP (e.g., minimum contention window size, maximum contention window size, mₚ, etc.). For example, the UE may select a backoff counter (BC) after selecting a random value between the minimum CW and the maximum CW mapped to the CAPC. In this case, for example, the BC may be a positive integer less than or equal to the random value. The UE sensing a channel decreases the BC by 1 if the channel is idle. If the BC becomes zero and the UE detects that the channel is idle for the time T_{d} (T_{d}=T_{f}+mₚ*Tₛₗ), the UE may attempt to transmit data by occupying the channel. For example, Ti (=9 usec) is a basic sensing unit or sensing slots, and may include a measurement duration for at least 4 usec. For example, the front 9 usec of T_{f} (=16 usec) may be configured to be Tₛₗ.

For example, according to the type 2 LBT-based NR-U operation, the UE may transmit data by performing the type 2 LBT (e.g., type 2A LBT, type 2B LBT, or type 2C LBT) within COT.

For example, the type 2A (also referred to as Cat-2 LBT (one shot LBT) or one-shot LBT) may be 25 usec one-shot LBT. In this case, transmission may start immediately after idle sensing for at least a 22 usec gap. The type 2A may be used to initiate transmission of SSB and non-unicast DL information. That is, the UE may sense a channel for 25 usec within COT, and if the channel is idle, the UE may attempt to transmit data by occupying the channel.

For example, the type 2B may be 16 usec one-shot LBT. In this case, transmission may start immediately after idle sensing for a 16 usec gap. That is, the UE may sense a channel for 16 usec within COT, and if the channel is idle, the UE may attempt to transmit data by occupying the channel.

For example, in the case of the type 2C (also referred to as Cat-1 LBT or No LBT), LBT may not be performed. In this case, transmission may start immediately after a gap of up to 16 usec and a channel may not be sensed before the transmission. The duration of the transmission may be up to 584 usec. The UE may attempt transmission after 16 usec without sensing, and the UE may perform transmission for up to 584 usec.

In a sidelink unlicensed band, the UE may perform a channel access operation based on Listen Before Talk (LBT). Before the UE accesses a channel in an unlicensed band, the UE should check whether the channel to be accessed is idle (e.g., a state in which UEs do not occupy the channel, a state in which UEs may access the corresponding channel and transmit data) or busy (e.g., a state in which the channel is occupied and data transmission/reception is performed on the corresponding channel, and the UE attempting to access the channel cannot transmit data while the channel is busy). That is, the operation in which the UE checks whether the channel is idle or busy may be referred to as Clear Channel Assessment (CCA), and the UE may check whether the channel is idle or busy for the CCA duration.

Meanwhile, in a future system, a UE may perform a sidelink transmission and/or reception operation in an unlicensed band. For operations in an unlicensed band, depending on band-specific regulations or requirements, a UE's transmission may be preceded by a channel sensing operation (e.g., energy detection/measurement) for the channel to be used, a UE may perform a transmission in the unlicensed band only if, as a result of the channel sensing, the channel or RB set to be used is determined to be IDLE (e.g., if the measured energy is less than or equal to or greater than a certain threshold value), and, if, according to a result of the channel sensing, the channel or RB set to be used is determined to be BUSY (e.g., if the measured energy is greater than or equal to or greater than a certain threshold value), the UE may cancel all or part of the transmission in the unlicensed band.

Meanwhile, in operation in an unlicensed band, a UE may omit or simplify the channel sensing operation (i.e., make the channel sensing interval relatively small) within a certain time interval after a transmission for a certain time period, or conversely, after a certain time interval after the transmission, the UE may decide whether to transmit or not after performing the usual channel sensing operation.

On the other hand, in a transmission in an unlicensed band, depending on regulations or requirements, the size and/or power spectral density (PSD) of the time interval and/or frequency occupied region of the signal/channel transmitted by the UE may be greater than or equal to a certain level, respectively.

On the other hand, in unlicensed bands, in order to simplify channel sensing, it may be informed through channel occupancy time (COT) interval information that the channel obtained through initial general channel sensing is occupied for a certain period of time, and the length of the COT interval may be configured to have different maximum values depending on the priority of the service or data packet or the channel access priority class (CAPC).

On the one hand, a base station may share a COT duration that it has secured through channel sensing in the form of a DCI transmission, and a UE may perform a specific (indicated) channel sensing type and/or CP extension within the COT duration based on the DCI information received from the base station. On the other hand, a UE may share a COT duration that it has secured through channel sensing to a base station that is the destination of the UE's UL transmission, and the relevant information may be provided through the UL via CG-UCI. In the above situation, the base station may perform simplified channel sensing within the COT duration shared by the UE.

In the case of SL communication, there are situations where a UE is indicated by a base station to use resources for SL transmission through DCI or RRC signaling, such as Mode 1 RA operation, and there are situations where a UE performs SL transmission and reception through sensing operation between UEs without the assistance of a base station, such as Mode 2 RA operation.

On the other hand, for channel access type 1, which may be used regardless of the channel occupancy time (COT) configuration, the procedures shown in Table 15 and Table 16 for DL transmissions and Table 17 and Table 18 for UL transmissions were performed.

In the present disclosure, channel access may be mutually replaceable/substitutable with channel sensing.

TABLE 15
The eNB/gNB may transmit a transmission after first sensing the channel to be idle
during the sensing slot durations of a defer duration T_{d} and after the counter N is
zero in step 4. The counter N is adjusted by sensing the channel for additional
sensing slot duration(s) according to the steps below:

| | |
|---|---|
| 1) | set N = Nᵢₙᵢₜ, where Nᵢₙᵢₜ is a random number uniformly distributed |
| | between 0 and CWₚ, and go to step 4; |
| 2) | if N > 0 and the eNB/gNB chooses to decrement the counter, set N = N − |
| | 1; |
| 3) | sense the channel for an additional sensing slot duration, and if the additional |
| | sensing slot duration is idle, go to step 4; else, go to step 5; |
| 4) | if N = 0, stop; else, go to step 2. |
| 5) | sense the channel until either a busy sensing slot is detected within an |
| | additional defer duration T_{d} or all the sensing slots of the additional defer |
| | duration T_{d} are detected to be idle; |
| 6) | if the channel is sensed to be idle during all the sensing slot durations of the |
| | additional defer duration T_{d}, go to step 4; else, go to step 5; |

If an eNB/gNB has not transmitted a transmission after step 4 in the procedure
above, the eNB/gNB may transmit a transmission on the channel, if the channel is
sensed to be idle at least in a sensing slot duration Tₛₗ when the eNB/gNB is
ready to transmit and if the channel has been sensed to be idle during all the
sensing slot durations of a defer duration T_{d} immediately before this
transmission. If the channel has not been sensed to be idle in a sensing slot
duration Tₛₗ when the eNB/gNB first senses the channel after it is ready to
transmit or if the channel has been sensed to be not idle during any of the sensing
slot durations of a defer duration T_{d} immediately before this intended
transmission, the eNB/gNB proceeds to step 1 after sensing the channel to be idle
during the sensing slot durations of a defer duration T_{d}.
The defer duration T_{d} consists of duration T_{f} = 16 us immediately followed by
mₚ consecutive sensing slot durations Tₛₗ, and T_{f} includes an idle sensing slot
duration Tₛₗ at start of T_{f}.

TABLE 16
If a gNB transmits transmissions including PDSCH that are associated with
channel access priority class p on a channel, the gNB maintains the contention
window value CWₚ and adjusts CWₚ before step 1 of the procedure described in
clause 4.1.1 for those transmissions using the following steps:

| 1) | For every priority class p ∈ {1, 2, 3, 4}, set CWₚ = CW_{min, p}. | |
|---|---|---|
| 2) | If HARQ-ACK feedback is available after the last update of Wₚ , go to step | |
| | 3. Otherwise, if the gNB transmission after procedure described in clause | |
| | 4.1.1 does not include a retransmission or is transmitted within a duration | |
| | T_{w} from the end of the reference duration corresponding to the earliest DL | |
| | channel occupancy after the last update of CWₚ, go to step 5; otherwise go | |
| | to step 4. | |
| 3) | The HARQ-ACK feedback(s) corresponding to PDSCH(s) in the reference | |
| | duration for the latest DL channel occupancy for which HARQ-ACK | |
| | feedback is available is used as follows: | |
| | a. | If at least one HARQ-ACK feedback is ‘ACK’ for PDSCH(s) with |
| | | transport block based feedback or at least 10% of HARQ-ACK feedbacks |
| | | is ‘ACK’ for PDSCH CBGs transmitted at least partially on the channel |
| | | with code block group based feedback, go to step 1; otherwise go to step |
| | | 4. |

| | |
|---|---|
| 4) | Increase CWₚ for every priority class p ∈ {1, 2, 3, 4} to the next higher |
| | allowed value. |
| 5) | For every priority class p ∈ {1, 2, 3, 4}, maintain CWₚ as it is; go to step 2. |

The reference duration and duration T_{w} in the procedure above are defined as
follows:

The reference duration corresponding to a channel occupancy initiated by
the gNB including transmission of PDSCH(s) is defined in this clause as a
duration starting from the beginning of the channel occupancy until the end
of the first slot where at least one unicast PDSCH is transmitted over all the
resources allocated for the PDSCH, or until the end of the first transmission
burst by the gNB that contains unicast PDSCH(s) transmitted over all the
resources allocated for the PDSCH, whichever occurs earlier. If the channel
occupancy includes a unicast PDSCH, but it does not include any unicast
PDSCH transmitted over all the resources allocated for that PDSCH, then,
the duration of the first transmission burst by the gNB within the channel
occupancy that contains unicast PDSCH(s) is the reference duration for
CWS adjustment.
T_{W} = max (T_{A}, T_{B} + 1 ms) where T_{B} is the duration of the transmission
burst from start of the reference duration in ms and T_{A} = 5 ms if the
absence of any other technology sharing the channel can not be guaranteed
on a long-term basis (e.g. by level of regulation), and T_{A} = 10 ms
otherwise.

If a gNB transmits transmissions using Type 1 channel access procedures
associated with the channel access priority class p on a channel and the
transmissions are not associated with explicit HARQ-ACK feedbacks by the
corresponding UE(s), the gNB adjusts CWₚ before step 1 in the procedures
described in subclase 4.1.1, using the latest CWₚ used for any DL transmissions
on the channel using Type 1 channel access procedures associated with the channel
access priority class p. If the corresponding channel access priority class p has
not been used for any DL transmissions on the channel, CWₚ = CW_{min, p} is used.

TABLE 17
A UE may transmit the transmission using Type 1 channel access procedure after
first sensing the channel to be idle during the slot durations of a defer duration T_{d},
and after the counter N is zero in step 4. The counter N is adjusted by sensing
the channel for additional slot duration(s) according to the steps described below.

| | |
|---|---|
| 1) | set N = Nᵢₙᵢₜ, where Nᵢₙᵢₜ is a random number uniformly distributed |
| | between 0 and CWₚ, and go to step 4; |
| 2) | if N > 0 and the UE chooses to decrement the counter, set N = N − 1; |
| 3) | sense the channel for an additional slot duration, and if the additional slot |
| | duration is idle, go to step 4; else, go to step 5; |
| 4) | if N = 0, stop; else, go to step 2. |
| 5) | sense the channel until either a busy slot is detected within an additional |
| | defer duration T_{d} or all the slots of the additional defer duration T_{d} are |
| | detected to be idle; |
| 6) | if the channel is sensed to be idle during all the slot durations of the |
| | additional defer duration T_{d}, go to step 4; else, go to step 5; |

If a UE has not transmitted a UL transmission on a channel on which UL
transmission(s) are performed after step 4 in the procedure above, the UE may
transmit a transmission on the channel, if the channel is sensed to be idle at least in
a sensing slot duration Tₛₗ when the UE is ready to transmit the transmission and
if the channel has been sensed to be idle during all the slot durations of a defer
duration T_{d} immediately before the transmission. If the channel has not been
sensed to be idle in a sensing slot duration Tₛₗ when the UE first senses the
channel after it is ready to transmit, or if the channel has not been sensed to be idle
during any of the sensing slot durations of a defer duration T_{d} immediately before
the intended transmission, the UE proceeds to step 1 after sensing the channel to
be idle during the slot durations of a defer duration T_{d}.
The defer duration T_{d} consists of duration T_{f} = 16 us immediately followed by
mₚ consecutive slot durations where each slot duration is Tₛₗ = 9 us, and T_{f}
includes an idle slot duration Tₛₗ at start of T_{f}.

TABLE 18
If a UE transmits transmissions using Type 1 channel access procedures that are
associated with channel access priority class p on a channel, the UE maintains the
contention window value CWₚ and adjusts CWₚ for those transmissions before
step 1 of the procedure described in clause 4.2.1.1, using the following steps:

| | |
|---|---|
| 1) | For every priority class p ∈ {1, 2, 3, 4}, set CWₚ = CW_{min, p}; |
| 2) | If HARQ-ACK feedback is available after the last update of CWₚ, go to |
| | step 3. Otherwise, if the UE transmission after procedure described in clause |
| | 4.2.1.1 does not include a retransmission or is transmitted within a duration |
| | T_{w} from the end of the reference duration corresponding to the earliest UL |
| | channel occupancy after the last update of CWₚ, go to step 5; otherwise go |
| | to step 4. |
| 3) | The HARQ-ACK feedback(s) corresponding to PUSCH(s) in the reference |
| | duration for the latest UL channel occupancy for which HARQ-ACK |
| | feedback is available is used as follows: |
| | a. If at least one HARQ-ACK feedback is ‘ACK’ for PUSCH(s) with |
| | transport block (TB) based feedback or at least 10% of HARQ-ACK |
| | feedbacks are ‘ACK’ for PUSCH CBGs transmitted at least partially on |
| | the channel with code block group (CBG) based feedback, go to step 1; |
| | otherwise go to step 4. |
| 4) | Increase CWₚ for every priority class p ∈ {1, 2, 3, 4} to the next higher |
| | allowed value; |
| 5) | For every priority class p ∈ {1, 2, 3, 4}, maintain CWₚ as it is; go to step 2. |

The HARQ-ACK feedback, reference duration and duration T_{w} in the procedure
above are defined as the following:

```
For the purpose of contention window adjustment in this clause, HARQ-
ACK feedback for PUSCH(s) transmissions are expected to be provided to
UE(s) explicitly or implicitly where explicit HARQ-ACK is determined
based on the valid HARQ-ACK feedback in a corresponding CG-DFI as
described in clause 10.5 in [7], and implicit HARQ-ACK feedback is
determined based on the indication for a new transmission or retransmission
in the DCI scheduling PUSCH(s) as follows:
  If a new transmission is indicated, ‘ACK’ is assumed for the transport
  blocks or code block groups in the corresponding PUSCH(s) for the TB-
  based and CBG-based transmission, respectively.
  If a retransmission is indicated for TB-based transmissions, ‘NACK’ is
  assumed for the transport blocks in the corresponding PUSCH(s).
  If a retransmission is indicated for CBG-based transmissions, if a bit
  value in the code block group transmission information (CBGTI) field is
  ‘0’ or ‘l’ as described in clause 5.1.7.2 in [8], ‘ACK’ or ‘NACK’ is assumed
  for the corresponding CBG in the corresponding PUSCH(s), respectively.
The reference duration corresponding to a channel occupancy initiated by
the UE including transmission of PUSCH(s) is defined in this clause as a
duration starting from the beginning of the channel occupancy until the end
of the first slot where at least one PUSCH is transmitted over all the
resources allocated for the PUSCH, or until the end of the first transmission
burst by the UE that contains PUSCH(s) transmitted over all the resources
allocated for the PUSCH, whichever occurs earlier. If the channel occupancy
includes a PUSCH, but it does not include any PUSCH transmitted over all
the resources allocated for that PUSCH, then, the duration of the first
transmission burst by the UE within the channel occupancy that contains
PUSCH(s) is the reference duration for CWS adjustment.
T_{w} = max (T_{A}, T_{B} + 1 ms) where T_{B} is the duration of the transmission
burst from start of the reference duration in ms and T_{A} = 5 ms if the
absence of any other technology sharing the channel cannot be guaranteed on
a long-term basis (e.g. by level of regulation), and T_{A} = 10 ms otherwise.
```

On the other hand, within the channel occupancy time (COT), the simplified channel access type 2 can be used before transmission, and the procedure as shown in Table 19 for DL transmission and Table 20 for UL transmission is performed.

```
TABLE 19
4.1.2 Type 2 DL channel access procedures
This clause describes channel access procedures to be performed by an eNB/gNB
where the time duration spanned by sensing slots that are sensed to be idle before a
downlink transmission(s) is deterministic.
If an eNB performs Type 2 DL channel access procedures, it follows the
procedures described in clause 4.1.2.1.
Type 2A channel access procedures as described in clause 4.1.2.1 are only
applicable to the following transmission(s) performed by an eNB/gNB:
  Transmission(s) initiated by an eNB including discovery burst and not
  including PDSCH where the transmission(s) duration is at most 1 ms, or
  Transmission(s) initiated by a gNB with only discovery burst or with
  discovery burst multiplexed with non-unicast information, where the
  transmission(s) duration is at most 1 ms, and the discovery burst duty cycle
  is at most 1/20, or
  Transmission(s) by an eNB/ gNB following transmission(s) by a UE after a
  gap of 25 us in a shared channel occupancy as described in clause 4.1.3.
Type 2B or Type 2C DL channel access procedures as described in clause 4.1.2.2
and 4.1.2.3, respectively, are applicable to the transmission(s) performed by a gNB
following transmission(s) by a UE after a gap of 16 us or up to 16 us,
respectively, in a shared channel occupancy as described in clause 4.1.3.
4.1.2.1 Type 2A DL channel access procedures
An eNB/gNB may transmit a DL transmission immediately after sensing the
channel to be idle for at least a sensing interval Tₛₕₒᵣₜ_{_{—}}_{dl} = 25 us.
Tₛₕₒᵣₜ_{_{—}}_{dl} consists of a duration T_{f} = 16 us immediately followed by one sensing
slot and T_{f} includes a sensing slot at start of T_{f}. The channel is considered to be
idle for Tₛₕₒᵣₜ_{_{—}}_{dl} if both sensing slots of Tₛₕₒᵣₜ_{_{—}}_{dl} are sensed to be idle.
4.1.2.2 Type 2B DL channel access procedures
A gNB may transmit a DL transmission immediately after sensing the channel to
be idle within a duration of T_{f} = 16 us. T_{f} includes a sensing slot that occurs
within the last 9 us of T_{f}. The channel is considered to be idle within the duration
T_{f} if the channel is sensed to be idle for a total of at least 5 us with at least 4 us
of sensing occurring in the sensing slot.
4.1.2.3 Type 2C DL channel access procedures
When a gNB follows the procedures in this clause for transmission of a DL
transmission, the gNB does not sense the channel before transmission of the DL
transmission. The duration of the corresponding DL transmission is at most
584 us.
```

TABLE 20
4.2.1.2 Type 2 UL channel access procedure
This clause describes channel access procedures by UE where the time duration
spanned by the sensing slots that are sensed to be idle before a UL transmission(s)
is deterministic.
If a UE is indicated by an eNB to perform Type 2 UL channel access procedures,
the UE follows the procedures described in clause 4.2.1.2.1.
4.2.1.2.1 Type 2A UL channel access procedure
If a UE is indicated to perform Type 2A UL channel access procedures, the UE
uses Type 2A UL channel access procedures for a UL transmission. The UE may
transmit the transmission immediately after sensing the channel to be idle for at
least a sensing interval Tₛₕₒᵣₜ_{_{—}}ᵤₗ = 25 us. Tₛₕₒᵣₜ_{_{—}}ᵤₗ consists of a duration T_{f} =
16 usimmediately followed by one sensing slot and T_{f}includes a sensing slot at
start of T_{f}. The channel is considered to be idle for Tₛₕₒᵣₜ_{_{—}}ᵤₗ if both sensing slots
of Tₛₕₒᵣₜ_{_{—}}ᵤₗ.are sensed to be idle.
4.2.1.2.2 Type 2B UL channel access procedure
If a UE is indicated to perform Type 2B UL channel access procedures, the UE
uses Type 2B UL channel access procedure for a UL transmission. The UE may
transmit the transmission immediately after sensing the channel to be idle within a
duration of T_{f} = 16 us. T_{f} includes a sensing slot that occurs within the last 9 us
of T_{f}. The channel is considered to be idle within the duration T_{f} if the channel is
sensed to be idle for total of at least 5 us with at least 4 us of sensing occurring
in the sensing slot.
4.2.1.2.3 Type 2C UL channel access procedure
If a UE is indicated to perform Type 2C UL channel access procedures for a UL
transmission, the UE does not sense the channel before the transmission. The
duration of the corresponding UL transmission is at most 584 us.

According to one embodiment of the present disclosure, a type 2A SL channel access may be in the same manner as a type 2A DL and/or UL channel access, with a sensing interval of T_short_sl=25 us and a T_f=16 us interval immediately following the sensing interval comprised of one sensing slot, where T_f comprises a sensing slot at the beginning. As for the basic idle determination, the scheme of DL or UL may also be used.

According to one embodiment of the present disclosure, a Type 2B SL channel access may be in the same manner as a Type 2B DL and/or UL channel access, with a sensing interval of T_f=16 us, where T_f includes a sensing slot at the end of the 9 us interval. As for the basic idle determination, the DL or UL scheme may also be used.

According to one embodiment of the present disclosure, a Type 2C SL channel access may be in the same manner as a Type 2C DL and/or UL channel access, such that no channel sensing is performed. Instead, the time interval of the SL transmission may be up to 584 us.

According to one embodiment of the present disclosure, a type 1 SL channel access is performed in the same manner as a type 1 DL and/or UL channel access, wherein: i) a random integer value N is derived based on a contention window size corresponding to the priority class, ii) if the channel sensing result for a defer duration of size T_d corresponding to the priority class is an idle, the counter value is decremented to N−1 with T_sl as the unit when it is idle; and iii) if the counter value is zero, the UE may occupy the RB set or channel subject to channel sensing.

However, if some of the channel sensing results for the above T_sl interval are determined to be idle, the counter value may be maintained and channel sensing may be continued until the channel sensing results in the unit of the defer duration of size T_d again become idle. In the above, the defer duration of length T_d may be in the form of m_p consecutive T_sl after T_f=16 us, where m_p is a value determined according to the priority class p, and may be a time interval in which channel sensing is performed with T_sl=9 us.

According to one embodiment of the present disclosure, when a UE has occupied a channel via a Type 1 SL channel access and the UE is not ready to transmit a sidelink transmission, the UE may configure a defer duration of length T_d and a sensing interval of length T_sl immediately preceding the ready-to-transmit sidelink transmission, and if both are idle, the UE may immediately perform the sidelink transmission. Here, if any of them are busy, the UE may perform the type 1 SL channel access again.

For example, if a sidelink transmission is difficult at the end of the channel sensing (e.g., if the end of the channel sensing is after the start of the sidelink transmission), the UE may reselect the sidelink transmission resource. For example, the reselected resource may be selected in consideration of the end time of the channel sensing and/or the length of the remaining sensing interval. For example, the remaining sensing interval may be a value derived by assuming that the channel sensing is all idle.

Meanwhile, in the present disclosure, a transmitting UE (i.e., TX UE) may be a UE which transmits data to (target) receiving UE(s) (i.e., RX UE(s)). For example, the TX UE may be a UE which performs PSCCH transmission and/or PSSCH transmission. For example, the TX UE may be a UE which transmits SL CSI-RS(s) and/or a SL CSI report request indication to (target) RX UE(s). For example, the TX UE may be a UE which transmits a (pre-defined) reference signal(s) (e.g., PSSCH demodulation reference signal (DM-RS)) and/or SL (L1) RSRP report request indicator, which is/are used for SL (L1) RSRP measurement, to (target) to RX UE(s). For example, the TX UE may be a UE which transmits a (control) channel (e.g., PSCCH, PSSCH, etc.) and/or reference signal(s) (e.g., DM-RS(s), CSI-RS(s), etc.) through the (control) channel, which is/are used for SL radio link monitoring (RLM) operation(s) and/or SL radio link failure (RLF) operation(s) of (target) RX UE(s).

Meanwhile, in the present disclosure, a receiving UE (i.e., RX UE) may be a UE which transmits SL HARQ feedback to transmitting UE(s) (i.e., TX UE(s)), based on whether or not data transmitted by TX UE(s) is decoded successfully and/or whether or not a PSCCH (related to PSSCH scheduling) transmitted by TX UE(s) is detected/decoded successfully. For example, the RX UE may be a UE which performs SL CSI transmission to TX UE(s) based on SL CSI-RS(s) and/or a SL CSI report request indication received from TX UE(s). For example, the RX UE may be a UE which transmits, to TX UE(s), an SL (L1) RSRP measurement value measured based on (pre-defined) reference signal(s) and/or SL (L1) RSRP report request indication received from TX UE(s). For example, the RX UE may be a UE which transmits its own data to TX UE(s). For example, the RX UE may be a UE which performs SL RLM operation(s) and/or SL RLF operation(s) based on a (pre-configured) (control) channel and/or reference signal(s) through the (control) channel received from TX UE(s).

According to one embodiment of the present disclosure, when a receiving UE transmits SL HARQ feedback information for a PSSCH (and/or PSCCH) received from a transmitting UE, (part of) the below schemes may be considered. For example, the (part of) the corresponding schemes may be limitedly applied only if the receiving UE has successfully decoded/detected the PSCCH scheduling the PSSCH.
option 1) transmitting NACK information only if a PSSCH decoding/reception is failed
option 2) transmitting ACK information when a PSSCH decoding/reception is succeeded, transmitting NACK information when failed

Meanwhile, in the present disclosure, a TX UE may transmit the entirety or part of information described below to RX UE(s) through SCI(s). Herein, for example, the TX UE may transmit the entirety or part of the information described below to the RX UE(s) through a first SCI and/or a second SCI.
PSSCH (and/or PSCCH) related resource allocation information (e.g., the number/positions of time/frequency resources, resource reservation information (e.g., period))
SL CSI report request indicator or SL (L1) RSRP (and/or SL (L1) RSRQ and/or SL (L1) RSSI) report request indicator
SL CSI transmission indicator (or SL (L1) RSRP (and/or SL (L1) RSRQ and/or SL (L1) RSSI) information transmission indicator)) (on a PSSCH)
Modulation and coding scheme (MCS) information
Transmit power information
L1 destination ID information and/or L1 source ID information
SL HARQ process ID information
New data indicator (NDI) information
Redundancy version (RV) information
(Transmission traffic/packet related) QoS information (e.g., priority information)
SL CSI-RS transmission indicator or information on the number of (to-be-transmitted) SL CSI-RS antenna ports
Location information of the TX UE or location (or distance region) information of target RX UE(s) (for which SL HARQ feedback is requested)
Reference signal (e.g., DM-RS, etc.) information related to channel estimation and/or decoding of data to be transmitted through a PSSCH. For example, the reference signal information may be information related to a pattern of a (time-frequency) mapping resource of DM-RS, rank information, antenna port index information, information on the number of antenna ports, etc.

Meanwhile, in the present disclosure, for example, a PSCCH may be replaced/substituted with at least one of a SCI, a first SCI (1′t-stage SCI), and/or a second SCI (2^{nd}-stage SCI), or vice versa. For example, a SCI may be replaced/substituted with at least one of a PSCCH, a first SCI, and/or a second SCI, or vice versa. For example, a PSSCH may be replaced/substituted with a second SCI and/or a PSCCH, or vice versa.

Meanwhile, in the present disclosure, for example, if SCI configuration fields are divided into two groups in consideration of a (relatively) high SCI payload size, an SCI including a first SCI configuration field group may be referred to as a first SCI or a 1^{st} SCI, and an SCI including a second SCI configuration field group may be referred to as a second SCI or a 2^{nd} SCI. For example, the 1^{st} SCI and the 2^{nd} SCI may be transmitted through different channels. For example, the transmitting UE may transmit the first SCI to the receiving UE through the PSCCH. For example, the second SCI may be transmitted to the receiving UE through an (independent) PSCCH, or may be transmitted in a piggyback manner together with data through the PSSCH.

Meanwhile, in the present disclosure, for example, “configuration” or “definition” may mean (pre-)configuration from base station(s) or network(s). For example, “configuration” or “definition” may mean resource pool specific (pre-)configuration from base station(s) or network(s). For example, base station(s) or network(s) may transmit information related to “configuration” or “definition” to UE(s). For example, base station(s) or network(s) may transmit information related to “configuration” or “definition” to UE(s) through pre-defined signaling. For example, the pre-defined signaling may include at least one of RRC signaling, MAC signaling, PHY signaling, and/or SIB.

Meanwhile, in the present disclosure, for example, “configuration” or “definition” may mean that it is designated or configured through pre-configured signaling between UEs. For example, information related to “configuration” or “definition” may be transmitted or received pre-configured signaling between UEs. For example, the pre-defined signaling may include at least one of RRC signaling, MAC signaling, PHY signaling, and/or SIB.

Meanwhile, in the present disclosure, for example, RLF may be replaced/substituted with out-of-synch (OOS) and/or in-synch (IS), or vice versa.

Meanwhile, in the present disclosure, for example, a resource block (RB) may be replaced/substituted with a subcarrier, or vice versa. For example, a packet or a traffic may be replaced/substituted with a transport block (TB) or a medium access control protocol data unit (MAC PDU) according to a transmission layer, or vice versa. For example, a code block group (CBG) may be replaced/substituted with a TB, or vice versa. For example, a source ID may be replaced/substituted with a destination ID, or vice versa. For example, an L1 ID may be replaced/substituted with an L2 ID, or vice versa. For example, the L1 ID may be an L1 source ID or an L1 destination ID. For example, the L2 ID may be an L2 source ID or an L2 destination ID.

Meanwhile, in the present disclosure, for example, operation(s) of a TX UE to reserve/select/determine retransmission resource(s) may include operation(s) of the TX UE to reserve/select/determine potential retransmission resource(s) in which actual use is determined based on SL HARQ feedback information received from RX UE(s).

Meanwhile, in the present disclosure, a sub-selection window may be replaced/substituted with a selection window and/or a pre-configured number of resource sets within the selection window, or vice versa.

Meanwhile, in the present disclosure, SL MODE 1 may refer to a resource allocation method or a communication method in which a base station directly schedules SL transmission resource(s) for a TX UE through pre-defined signaling (e.g., DCI or RRC message). For example, SL MODE 2 may refer to a resource allocation method or a communication method in which a UE independently selects SL transmission resource(s) in a resource pool pre-configured or configured from a base station or a network. For example, a UE performing SL communication based on SL MODE 1 may be referred to as a MODE 1 UE or MODE 1 TX UE, and a UE performing SL communication based on SL MODE 2 may be referred to as a MODE 2 UE or MODE 2 TX UE.

Meanwhile, in the present disclosure, for example, a dynamic grant (DG) may be replaced/substituted with a configured grant (CG) and/or a semi-persistent scheduling (SPS) grant, or vice versa. For example, the DG may be replaced/substituted with a combination of the CG and the SPS grant, or vice versa. For example, the CG may include at least one of a configured grant (CG) type 1 and/or a configured grant (CG) type 2. For example, in the CG type 1, a grant may be provided by RRC signaling and may be stored as a configured grant. For example, in the CG type 2, a grant may be provided by a PDCCH, and may be stored or deleted as a configured grant based on L1 signaling indicating activation or deactivation of the grant. For example, in the CG type 1, a base station may allocate periodic resource(s) to a TX UE through an RRC message. For example, in the CG type 2, a base station may allocate periodic resource(s) to a TX UE through an RRC message, and the base station may dynamically activate or deactivate the periodic resource(s) through a DCI.

Meanwhile, in the present disclosure, a channel may be replaced/substituted with a signal, or vice versa. For example, transmission/reception of a channel may include transmission/reception of a signal. For example, transmission/reception of a signal may include transmission/reception of a channel. For example, cast may be replaced/substituted with at least one of unicast, groupcast, and/or broadcast, or vice versa. For example, a cast type may be replaced/substituted with at least one of unicast, groupcast, and/or broadcast, or vice versa. For example, the cast or the cast type may include unicast, groupcast and/or broadcast.

Meanwhile, in the present disclosure, a resource may be replaced/substituted with a slot or a symbol, or vice versa. For example, the resource may include a slot and/or a symbol.

Meanwhile, in the present disclosure, a priority may be replaced/substituted with at least one of logical channel prioritization (LCP), latency, reliability, minimum required communication range, prose per-packet priority (PPPP), sidelink radio bearer (SLRB), a QoS profile, a QoS parameter, and/or requirement, or vice versa.

Meanwhile, in the present disclosure, for example, for convenience of description, a (physical) channel used when a RX UE transmits at least one of the following information to a TX UE may be referred to as a PSFCH.
SL HARQ feedback, SL CSI, SL (L1) RSRP

Meanwhile, when performing sidelink communication, a method for a transmitting UE to reserve or pre-determine transmission resource(s) for receiving UE(s) may be representatively as follows.

For example, the transmitting UE may perform a reservation of transmission resource(s) based on a chain. Specifically, for example, if the transmitting UE reserves K transmission resources, the transmitting UE may transmit location information for less than K transmission resources to receiving UE(s) through a SCI transmitted to the receiving UE(s) at any (or specific) transmission time or a time resource. That is, for example, the SCI may include location information for less than the K transmission resources. Alternatively, for example, if the transmitting UE reserves K transmission resources related to a specific TB, the transmitting UE may transmit location information for less than K transmission resources to receiving UE(s) through a SCI transmitted to the receiving UE(s) at any (or specific) transmission time or a time resource. That is, the SCI may include location information for less than the K transmission resources. In this case, for example, it is possible to prevent performance degradation due to an excessive increase in payloads of the SCI, by signaling only the location information for less than K transmission resources to the receiving UE(s) through one SCI transmitted at any (or specific) transmission time or the time resource by the transmitting UE.

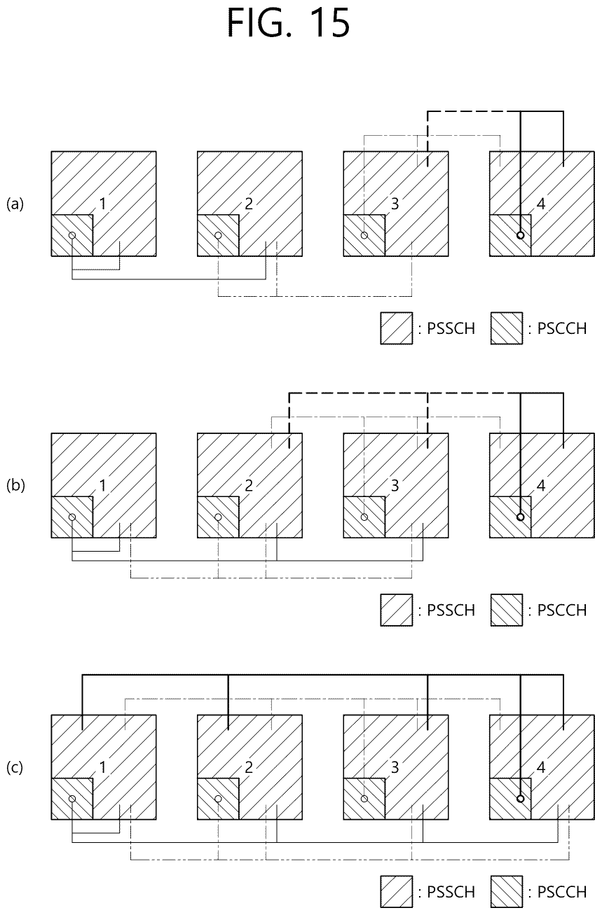

FIG. 15 shows a method in which a UE that has reserved transmission resource(s) informs another UE of the transmission resource(s), based on an embodiment of the present disclosure. The embodiment of FIG. 15 may be combined with various embodiments of the present disclosure.

Specifically, for example, (a) of FIG. 15 shows a method for performing by a transmitting UE chain-based resource reservation by transmitting/signaling location information of (maximum) 2 transmission resources to receiving UE(s) through one SCI, in the case of a value of K=4. For example, (b) of FIG. 15 shows a method for performing by a transmitting UE chain-based resource reservation by transmitting/signaling location information of (maximum) 3 transmission resources to receiving UE(s) through one SCI, in the case of a value of K=4. For example, referring to (a) and (b) of FIG. 15, the transmitting UE may transmit/signal only location information of the fourth transmission-related resource to the receiving UE(s) through the fourth (or last) transmission-related PSCCH. For example, referring to (a) of FIG. 15, the transmitting UE may transmit/signal to the receiving UE(s) not only location information of the fourth transmission-related resource but also location information of the third transmission-related resource additionally through the fourth (or last) transmission-related PSCCH. For example, referring to (b) of FIG. 15, the transmitting UE may transmit/signal to the receiving UE(s) not only location information of the fourth transmission-related resource but also location information of the second transmission-related resource and location information of the third transmission-related resource additionally through the fourth (or last) transmission-related PSCCH. In this case, for example, in (a) and (b) of FIG. 15, if the transmitting UE may transmit/signal to the receiving UE(s) only location information of the fourth transmission-related resource through the fourth (or last) transmission-related PSCCH, the transmitting UE may set or designate a field/bit of location information of unused or remaining transmission resource(s) to a pre-configured value (e.g., 0). For example, in (a) and (b) of FIG. 15, if the transmitting UE may transmit/signal to the receiving UE(s) only location information of the fourth transmission-related resource through the fourth (or last) transmission-related PSCCH, the transmitting UE may be set or designate a field/bit of location information of unused or remaining transmission resource(s) to a pre-configured status/bit value indicating/representing the last transmission (among 4 transmissions).

Meanwhile, for example, the transmitting UE may perform a reservation of transmission resource(s) based on a block. Specifically, for example, if the transmitting UE reserves K transmission resources, the transmitting UE may transmit location information for K transmission resources to receiving UE(s) through a SCI transmitted to the receiving UE(s) at any (or specific) transmission time or a time resource. That is, the SCI may include location information for K transmission resources. For example, if the transmitting UE reserves K transmission resources related to a specific TB, the transmitting UE may transmit location information for K transmission resources to receiving UE(s) through a SCI transmitted to the receiving UE(s) at any (or specific) transmission time or a time resource. That is, the SCI may include location information for K transmission resources. For example, (c) of FIG. 15 shows a method for performing by the transmitting UE block-based resource reservation, by signaling location information of 4 transmission resources to receiving UE(s) through one SCI, in the case of a value of K=4.

LBT operation may be performed to secure transmission opportunities in an unlicensed band. An LBT operation is an operation that performs channel sensing in a certain interval (contention window) in front of the resource to be transmitted, and then performs a transmission based on that resource only if it is idle. In SL-U, an LBT operation is performed in units of RB sets. For contiguous transmission resources located within a certain time window in an unlicensed band, the result of channel sensing for the earliest resource may be shared, i.e., if the earliest resource is idle, the LBT operation of lagging resources may be omitted (LBT type 2C). When selecting resources for a plurality of SL grants, if the respective LBT operation requirement intervals between different SL grants are not considered, transmission operations on subsequent SL grants (in the time domain) may be omitted, and excessive (type 1) LBT overhead may be caused if the SL grant resource selection is performed only based on SL sensing results. Furthermore, even if the selected resources of different SL grants (based on SL sensing results) are contiguous (in time domain), if the CAPC value of the MAC PDU to be transmitted over the lagging SL grant is greater than that of the preceding SL grant, additional (Type 1) LBT may be required to be performed for the transmission of the MAC PDU of the lagging SL grant, and the corresponding (Type 1) LBT performance interval may be blocked by the contiguous (in time domain) preceding SL grant.

For example, in an unlicensed band, SL communication may be configured to be performed according to (a part or all) of the rules below.

```
TABLE 21
Agreement
SL BWP, SL resource pool in R16/R17 NR SL and RB set in R16 NR-U are reused
for SL-U as baseline
Only one SL BWP is (pre-)configured within a carrier
The SL BWP is (pre-)configured to include one or multiple SL resource pools
At least support that one SL resource pool can be (pre-)configured to include integer
number of RB sets
  FFS: whether/how to support one SL resource pool can include sub-
  set of PRBs of one RB set
  FFS: the applicable resource pool
  FFS: the impact on sub-channel size and number of sub-channels in a
  resource pool if sub-channel is supported
PRBs within intra-cell guard band of two adjacent RB sets belong to a resource pool
if the resource pool includes the two adjacent RB sets
  FFS details, e.g., how such PRBs are used, the applicable resource
  pool, etc.
FFS: whether R16/R17 NR SL S-SSB slots and/or new S-SSB slots (if supported)
are excluded from resource pool
FFS: which slots belong to resource pool, e.g., how to set the value of bitmap,
whether to consider SL-U/NR-U operating in the same carrier and whether TDD
configuration are considered, etc.
FFS: the impact of PSCCH/PSSCH mapping to frequency resources on resource
pool configuration, on sub-channel definition if sub-channel is supported, etc.
```

For example, when configuring a resource pool for a plurality of RB sets, it may be configured so that specific parameters are shared.

TABLE 22

| ● | Agreement | |
|---|---|---|
| - | For PSCCH and PSSCH in SL-U: | |
| • | Both R16/R17 NR SL contiguous RB-based and R16 NR-U interlace RB-based | |
| | transmissions are considered as starting point | |
| | > | RAN1 strives to have unified design for both contiguous RB-based |
| | | and interlace RB-based transmissions |
| | > | FFS: whether/how to address IBE (In Band Emission) impact |

For example, as a method ofhandling cases where support for contiguous RB-based or interlace RB-based related features differs between UEs, a method may be provided where the type is configured per resource pool or per carrier.

For example, when different resource pools have different types, the transmitting and receiving pools may also be paired by type.

For example, in the resource pool selection procedure, consideration of the types supported by a UE may be required.

For example, in the absence of a PC5 RRC connection, it may be difficult to know the support type information between UEs, and the GC/BC may need a way to handle this.

For example, in the case of NR-U, if a UE does not support a specific type, and a base station only allows that type (e.g., RACH), the UE may not access that base station.

For example, the type may be indicated via SCI.

TABLE 23

| ● | Agreement | |
|---|---|---|
| - | For PSCCH and PSSCH in SL-U: | |
| • | For interlace RB-based transmission (if supported), at least the following candidates | |
| | can be discussed: | |
| | > | Frequency domain resource allocation granularity is one sub-channel |
| | | for PSSCH transmission |

| | |
|---|---|
| • | FFS: Other resource allocation granularity, e.g., RB-level |

| | |
|---|---|
| > | 1 sub-channel equals K interlaces if sub-channel is supported |

| | |
|---|---|
| • | FFS details |

| | |
|---|---|
| > | Other candidates are not precluded |
| > | FFS: mapping of PSCCH to frequency resources |
| > | FFS: resource indication in time/frequency domain, e.g., how to |
| | handle using one RB set or multiple RB sets, etc. |

TABLE 24

| ● | Agreement | |
|---|---|---|
| - | For slot structure in SL-U: | |
| • | At least R16/R17 NR SL slot-based PSCCH/PSSCH transmission is supported | |
| | > | FFS: whether/how to support additional starting symbol(s) within a |
| | | slot for the PSCCH/PSSCH transmission |

TABLE 25

| ● | Agreement | |
|---|---|---|
| - | For PSFCH and SL-HARQ in SL-U: | |
| • | At least R16 NR SL PSFCH format 0 is supported | |
| | > | FFS whether to introduce new PSFCH format |

| | |
|---|---|
| • | FFS: how to meet OCB and PSD requirement for PSFCH transmission, e.g., using |
| | interlaced RB transmission, whether/how to avoid too small PSFCH capacity, etc. |
| • | FFS: the locations of PSFCH resources, e.g., (pre-)configured, dynamically |
| | indicated, etc. |
| • | FFS: whether/how to address PSFCH transmission dropping due to LBT failure, |
| | e.g., whether to have multiple PSFCH occasions for a PSSCH and the related |
| | PSSCH-PSFCH mapping relationship, impact on SL HARQ-ACK reporting to the |
| | gNB for Mode 1, etc. |
| • | FFS: whether/how to address PSFCH and related PSSCH in different COTs |

may be considered. For example, a base station may provide a candidate set.

For example, as a design that considers an RB set, PSFCH transmission opportunities of different RB sets may be defined for one PSCCH.

For example, when a plurality of RB sets belong to a resource pool, a sub-channelization form may be provided as a mapping relationship between PSSCH and PSFCH.

TABLE 26

| ● | Agreement | |
|---|---|---|
| - | For S-SSB and synchronization in SL-U: | |
| • | FFS the time domain locations of S-SSB resources, e.g., whether/how to introduce | |
| | more candidate occasions compared with R16/R17 NR SL design, etc. | |
| • | Down-selection at least one of the following solutions to meet OCB and PSD | |
| | requirement for S-SSB transmission | |
| | > | Option 1: Using interlaced RB transmission |
| | > | Option 2: S-SSB multiplexing with other SL transmissions in the |
| | | same slot |
| | > | Option 3: Repetition of S-PSS/S-SSS/PSBCH in frequency domain |
| | > | Option 4: S-PSS/S-SSS/PSBCH with wider bandwidth |
| • | FFS: whether to support 4 symbols S-SSB | |
| | > | Note: 4 symbols S-SSB can be considered with options 1/2/3/4 above |

| | |
|---|---|
| • | FFS whether the temporary exemption of OCB requirement is applicable for S-SSB |
| | transmission |
| • | FFS whether any changes to R16/R17 NR SL synchronization procedure |

The Physical channel design framework is described below.

A. SL BWP, SL resource pool configuration

TABLE 27
Agreement
SL BWP, SL resource pool in R16/R17 NR SL and RB set in R16 NR-U are reused for
SL-U as baseline

| | |
|---|---|
| • | Only one SL BWP is (pre-)configured within a carrier |
| • | The SL BWP is (pre-)configured to include one or multiple SL resource |
| | pools |
| • | At least support that one SL resource pool can be (pre-)configured to |
| | include integer number of RB sets |
| ∘ | FFS: whether/how to support one SL resource pool can include sub-set of |
| | PRBs of one RB set |
| ∘ | FFS: the applicable resource pool |
| ∘ | FFS: the impact on sub-channel size and number of sub-channels in a |
| | resource pool if sub-channel is supported |
| • | PRBs within intra-cell guard band of two adjacent RB sets belong to a |
| | resource pool if the resource pool includes the two adjacent RB sets |
| ∘ | FFS details, e.g., how such PRBs are used, the applicable resource pool, |
| | etc. |
| • | FFS: whether R16/R17 NR SL S-SSB slots and/or new S-SSB slots (if |
| | supported) are excluded from resource pool |
| • | FFS: which slots belong to resource pool, e.g., how to set the value of |
| | bitmap, whether to consider SL-U/NR-U operating in the same carrier and |
| | whether TDD configuration are considered, etc. |
| • | FFS: the impact of PSCCH/PSSCH mapping to frequency resources on |
| | resource pool configuration, on sub-channel definition if sub-channel is |
| | supported, etc. |

I. SL BWP configuration

1. sl-BWP-Generic-rl6

a. sl-BWP-rl6

i. locationAndBandwith: It may indicate the start position and size of the RB-level granularity.
(1) It may be aligned with the start and end of the RB set. (For a plurality of RB sets, the lowest RB of the lowest starting RB set and the highest RB of the highest RB set).
(2) Intra-band guard locations may be provided by a base station. The RB set itself may be defined in the RAN4 standard on a per-carrier basis. For example, the intra-band guard may not be specified separately.
ii. SCS(subcarrierSpacing) and CP(cyclicPrefix): may indicate numerology.
iii. The above parameters may remain unchanged.
b. sl-LengthSymbols, sl-StartSymbol: may indicate available slots for SL, within a slot.
i. it may always be fixed for SL burst transmission as a specific value.
ii. it may be applied differently per slot in an SL burst. For example, the start may be applied to the initial slot. Or, the last may be applied as start+length to the last slot.
c. SL-PSBCH-Config-r16: may indicate a power control parameter for PSBCH.
i. If the S-SSB transmission is different per resource pool or per UE pair, the configuration unit may be different. In this regard, the parameters related to the PSBCH transmission method may be indicated in the FreqConfigCommon and the configuration for them may be changed.
d. sl-BWP-PoolConfig-r16
i. sl-RxPool-r16, sl-TxPoolSelectedNormal-r16, sl-TxPoolScheduling-r16, sl-TxPoolExceptional-rl6: may indicate information for the time-and-frequency resources that comprise the resource pool and the parameters configured for each resource pool.
(1) When contiguous RB-based or interlaced RB-based transmission is supported, whether interlace is used or not may be configured to be mixed on a per-carrier basis, based on BWP configuration, on a per-resource pool basis, and/or within a resource pool.
1) (Uu link) whether it is interlaced is indicated in the SIB, and the corresponding parameter in the UL BWP may inherit its value.
(a) For SCells, the Common parameter set may be checked for whether it includes whether it is interlaced.
2) For whether contiguous RB-based and interlaced RB-based transmissions may be mixed within an SL BWP.
(a) considering that an interlace RB-based transmission is a UE capability, SL communication through that carrier or SL BWP may need to be supported, at least through transmission resource pool selection.
(b) If this is not supported, UEs without interlace RB-based transmission capability may not be able to perform SL communication on that carrier or SL BWP.
3) For whether contiguous RB-based transmissions and interlace RB-based transmissions may be mixed within the SL resource pool.
(a) UEs without interlaced-RB based reception capability may not be able to avoid each other's resources in a mixed situation.
(b) If the above two methods are mixed, PSCCH-configuration or PSSCH-configuration may be applied per channel or collectively to the corresponding resource pool.
   II. Resource pool configuration
1. sl-RB-Number, sl-StartRB-Subchannel-r16, (sl-SubchannelSize-r16, sl-NumSubchannel-rl6): may indicate a frequency domain resource consisting a resource pool.
a. the parameter may be maximally reused in the case when it is contiguous RB-based transmission.
i. The number of contiguous PRBs that comprise the resource pool may be indicated by the current sl-RB-Number. Remaining RBs that are not currently configured as subchannels may not be used.

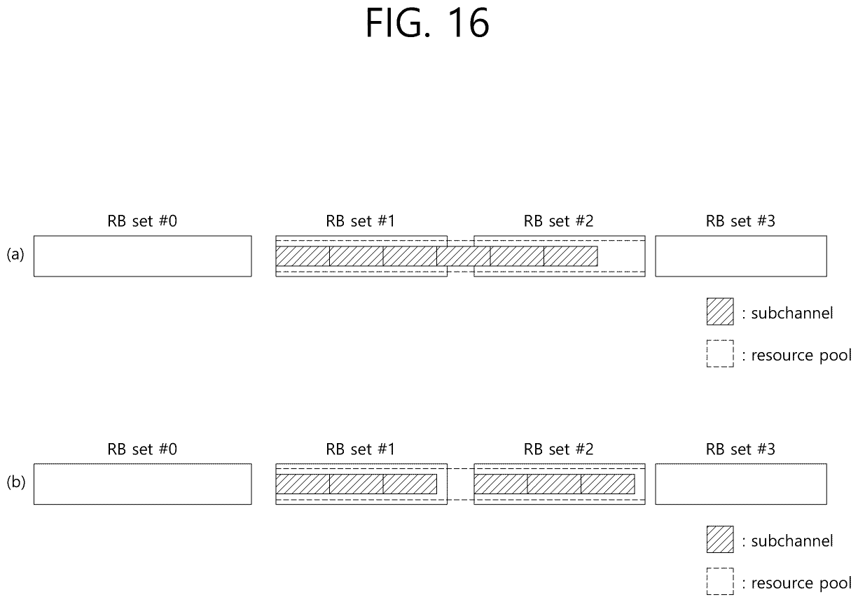

FIG. 16 shows a plurality of PRBs corresponding to a resource pool, according to one embodiment of the present disclosure. The embodiment of FIG. 16 may be combined with various embodiments of the present disclosure.

Referring to (a) of FIG. 16, for example, the plurality of PRBs may include only contiguous PRBs. For example, the remaining RBs may be unavailable.
i. For example, referring to (b) of FIG. 16, a gap may be configured between the lowest RB of the RB set and the lowest RB of the lowest subchannel. For example, the gap may be configured via signaling, or may be implicitly determined.
ii. If a single-LBT channel transmission is considered, this may cause a loss in the number of subchannels in some cases, according to the above scheme.
A. Depending on whether the subchannel allocation is multi-channel or single-channel, the subchannel configuration may differ.
B. Depending on the size of the subchannel, the (subchannel) configuration may differ.
ii. for whether to still use the remaining PRBs in the RB set for PSCCH/PSSCH transmissions.
(1) Here, the method of ensuring the same TBS between the initial transmission and retransmission may be considered. For example, the TBS calculation may not take into account the amount of additional resources used.
iii. For multi-channel transmissions, the guard band between the remaining PRBs and/or the adjacent RB set may be used for transmission.
(1) Here, the methods of ensuring the same TBS between initial transmission and retransmission may be considered.
iv. For impact in Mode 2 RA. For example, a two-step may be considered. The two-step may include the number of subchannels->RB set combination, or the RB set combination->number of subchannels.
(1) 3 Subchannels: 3 subchannels may be possible with one RB set, or two RB sets may need to be configured for 3 subchannels.
b. About the resource indicating method for interlace RB-based transmission.
i. Resource pools may be configured with RB-level granularity.
(1) The actual resources that may be used within a resource pool may be limited.
1) Resource configuration may be indicated based on existing subchannels.
(a) A subchannel may always be a contiguous RB or, in the case of interlace RB-based transmission, it may consist of an interlace and/or an RB set.
2) Interlaced index group+RB set index group
(a) When FDM in RB sets is considered between different resource pools, the interlace index groups may be designated differently.
2. sl-TimeResource-r16: it may indicate a time domain resource by iterating a bitmap over the remaining set of available slots in the SL, excluding S-SSB slots and reserved slots.
a. It may always be configured as all ones for SL burst transmission.
b. S-SSB slots may be included in the resource pool without being excluded. For example, this may be for multiplexing between S-SSB and PSSCH.
c. Coexistence with NR-U may not be considered, and TDD patterns may not be considered.
i. At least in intra-UE operation, prioritization between DL-U and SL-U may be required.
3. (COT-related issues) About the relationship between Multiple transmission pool(s) and COT sharing.
a. Sharing between different transmission pools may be possible, but only within the same transmission pool. For example, the sharing may be performed based on power levels, wherein the power levels may be exchanged between UEs.
   B. interlace RB-based transmission
   I. PSSCH transmission
   1. Subchannel definition

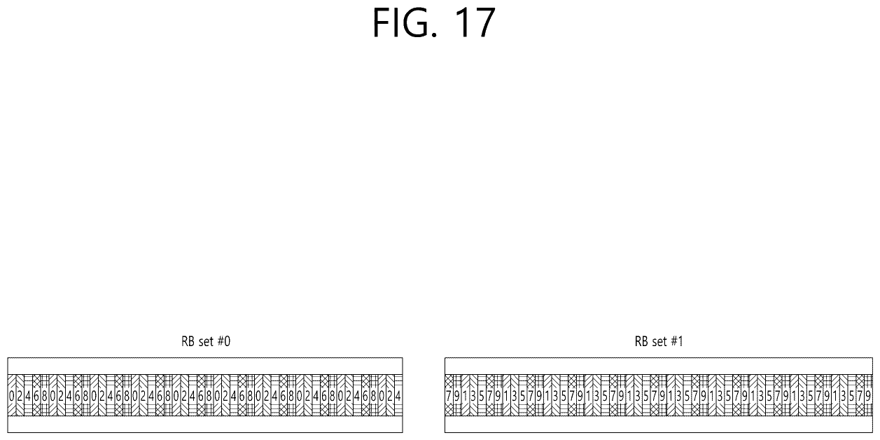

FIG. 17 shows an interlace structure within an RB set, according to one embodiment of the present disclosure. The embodiment of FIG. 17 may be combined with various embodiments of the present disclosure.

Referring to FIG. 17, RB set #0 and RB set #1 are shown. In RB set #0, the interlace indices may be repeated 0, 2, 4, 6, 8. In RB set #1, the interlace indices may be repeated 7, 9, 1, 3, 5.

a. Subchannel indexing may be performed by incrementing or decrementing the RB set index, starting with lower or higher indexed interlaces, and after all RB sets are mapped, subchannel indexing for RB sets may be repeated by incrementing or decrementing the interlace index again.

i. To increase the number of RBs, preemptively increasing the RB set may be needed. For example, a larger RB set may result in fewer transmission opportunities.

ii. In order to use RBs corresponding to a plurality of interlaces within an RB set, all RB sets (within a carrier) may need to be used for transmission.

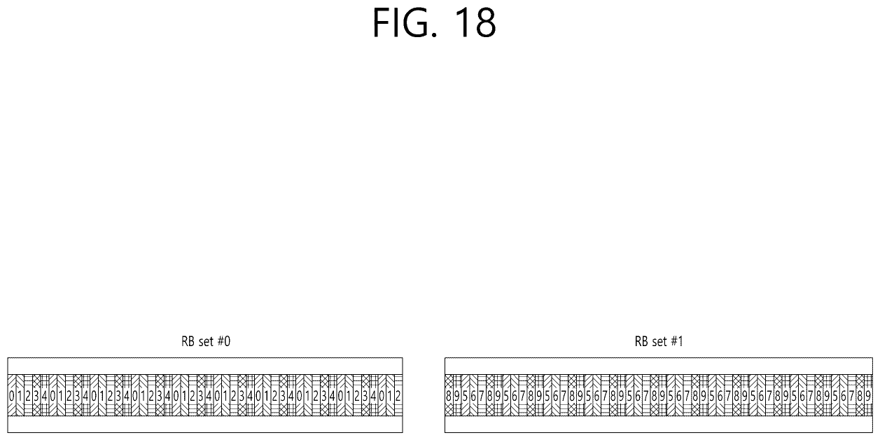

FIG. 18 shows an interlace structure within an RB set, according to one embodiment of the present disclosure. The embodiment of FIG. 18 may be combined with various embodiments of the present disclosure.

Referring to FIG. 18, RB set #0 and RB set #1 are shown. In RB set #0, the interlace indices may be repeated 0, 1, 2, 3, 4. In RB set #1, the interlace indices may be repeated 8, 9, 5, 6, 7.

b. Subchannel indexing may be performed by incrementing or decrementing the interlace index starting with a lower or higher indexed RB set, and after all interlace indices are mapped, subchannel indexing may be repeated by incrementing or decrementing the RB set index again for the interlace index.

i. The above structure may be suitable for using RBs corresponding to a plurality of interlaces within an RB set.

ii. Interlaces may not be maintained per RB set in multi-channel transmissions.

(1) When it comes to PSD inefficiency and PAPR, which interlace is used in the guard band may be an issue.

iii. For multi-channel transmissions, all interlaces may need to be used.

iv. For example, there may be constraints on the RA scheme.

(1) Only FRIV values that are allowed for the same interlace across different RB sets or the same number of interlaces across different RB sets may be valid.

(2) The FRIV may be configured by excluding invalid ones. For example, the number of possible subchannels may be 1, 2, 3, 4, 5, 6, 8, 10, . . . (based on the number of RB sets, the possible number may be different).

v. The operation related to the indication may be dynamically adjusted.

c. The entire interlace may be divided into N parts, and/or the entire RB set may be divided into M parts, and subchannel indexing may be performed on each subset.

d. In the case of a mix of schemes (SCI indication), a possible scheme may be selected based on the sensing-based results during Mode 2 RA. Alternatively, a specific scheme may be selected and resources may be selected based on the sensing-based results.

2. A resource reservation mechanism for the indicated RB set(s) and/or interlace(s).

a. The start RB set and/or start interlace may be obtained by the receiving UE with PSCCH BD.

b. The indicated start RB set may be the start RB set of a reserved resource. It may be assumed that the same pattern is applied to the number of indicated RB sets in the reserved resource.

i. The RB set(s) configuration may be fixed for the same TB.

c. The indicated start interlace index may be the start interlace index of a reserved resource. It may be assumed that the pattern of an indicated interlace group is the same for reserved resources.

### II. PSCCH Transmission

1. The PSCCH may be mapped to the interlace(s) with the lowest index in the RB set with the lowest index among the allocated resources.

a. Even if the number of RBs comprising an interlace changes, the number of RBs for PSCCH mapping may remain the same.

2. The PSCCH may be mapped to the lowest interlace(s) in the RB set with the lowest index among the allocated resources.

3. In multi-channel transmissions, the location of the PSCCH may vary. For example, the location may be included in RB set/RB/interlace.

4. F-OCC shift (may result in lower PAPR)

### III. PSFCH Transmission(s)

1. When a UE transmits a plurality of PSFCHs, the interlace may be limited to the same. This operation may have a low priority.

a. When transmitting multiple PSFCHs, the interlace index may be the same.

i. If a PSCCH/PSSCH transmitting UE causes the same PSCCH/PSSCH receiving UE to perform a plurality of PSFCH simultaneous transmissions in different RB sets, the interlace may be the same. For example, at least the interlace may be dynamically indicated.

ii. Within a single RB set, different interlaces may be allowed to be used for a plurality of PSFCH transmissions.

iii. If different PSCCH/PSSCH transmitting UEs cause the same PSCCH/PSSCH receiving UE to perform a plurality of PSFCH simultaneous transmissions in different RB sets, it may be difficult for the interlace to be the same.

(1) PSFCH transmission and reception may be limited to within a specific RB set(s).

(2) PSFCH transmissions and receptions may be limited to RBs corresponding to specific interlace(s).

iv. Different interlaces may be used, but PRBs within guards may not be used.

(1) PRBs within a guard may not be used even if they have the same interlace. In the sequence mapping method, if CS shifts are used, the CS shifts of a specific RB set may be used.

b. The interlace of a PSFCH with the highest prioritization priority according to an interlace may be transmitted first.

i. Once the Limit is exceeded, a scheme considering interlace for the PSFCH with the next highest priority may be provided, if dropping and additional transmission are available according to priority within it.

### 2. Explicit and Implicit PSFCH Resource Set Determination

a. RB set, interlace index, cyclic shift pair index

C. CP extension

I. It may be performed after a successful Type 1 channel access to reduce the gap between actual transmissions.

1. FDM between different transmitting UEs within the same RB set may be difficult if each transmitting UE arbitrarily determines whether or not to CPE and at what value of it.

2. The UE may apply and designate whether to apply CPE and the size of CPE arbitrarily only for wideband transmissions (where the number of allocated RBs in the RB set is greater than or equal to a certain level).

II. This may be performed to ensure that the gap between SL transmissions in an SL burst is less than or equal to a certain level.

1. Whether to use, time unit

a. whether to use may be determined by semi-static.

i. (Pre-)configuration per resource pool or SL BWP or SL channel type (PSCCH/PSSCH, PSFCH, S-SSB)

ii. Exception Conditions

(1) The case of overlapping sensing interval CPE duration in Type 1 may be an exception.

b. whether to use may be dynamically indicated.

i. There may not be a need for a transmitting UE to indicate to a receiving UE between consecutive PSCCH/PSSCH transmissions.

ii. If whether to use is indicated, the indicated whether to use may be used by neighboring UEs for the purpose of matching CPEs in the same RB set.

(1) That is, for the indicated reserved or repetitive resources through received SCI, it may be applied the same when a receiving UE transmits SL at that time according to the CPE information. For example, this may be limited to FDM.

c. Initial transmission (semi-static)+retransmission (dynamic)

d. Only used for Consecutive transmissions.

i. It may only be used between contiguous SL transmissions. Here, the CP extension level may include 25 us gap, 16 us gap, and no gap.

e. The SL burst transmission length may be aligned with the PSFCH period.

III. It may be for the purpose of reducing the gap between the SL reception (end time point) from the UE that initialized the COT and the SL transmission (start time point) from the UE using the COT when sharing the COT.

1. The CPE may be used by the UE for PSFCH transmission. For example, at least the length may be common.

IV. It may be for the purpose of preventing collisions between transmissions at the same time point.

1. By default, a significant number of problems may be alleviated by resource exclusion for reserved resources in Mode 2 operation.

2. There may be issues with different SL start positions making it difficult to be FDMed. For example, this may be due to the possibility of mutual LBT interference.

a. For wideband transmissions only (where the number of allocated RBs in the RB set is greater than or equal to a certain level), the UE may arbitrarily designate the CPE application and size. For example, candidates may be determined semi-statically.

V. 2-AGC symbol. For example, it may be to secure an LBT opportunity.

According to an embodiment of the present disclosure, the transmit power according to the PSD limit when different numbers of interlaces are transmitted per RB set may be compared.

For example, assuming a situation where there are 50 30 kHz SCS RBs in one RB set, each interlace has 10 RBs, and the frequency axis resource that the 50 RBs span may be 18 MHz. The PSD limit may be assumed to be 10 dBm/MHz.

1. For example, 5 interlaces transmitted in RB set #1+1 interlace transmitted in RB set #2

a. For RB set #1, since 18 MHz is full, as much power as 10 dBm*18 may be carried, or converted to per interlace, 10 dBm*18/5 may be carried.

b. For RB set #2, there is 1 RB in 1 MHz, so as much power as 10 dBm * 10 may be carried.

c. If the PSDs of RB set #1 and RB set #2 are matched, the total power may be 10 dBm*(18/5)*6=10 dBm * 21.6, since RB set #1 is the bottleneck.

2. 3 interlaces are transmitted in RB set #1+3 interlaces are transmitted in RB set #2

a. For one RB set, since about 33.33 (=1 MHz/30 kHz) REs are included at most within the 1 MHz window, 10 dBm may be carried on those 33.33 REs, so the power value that may be carried on all 360 REs may be 10 dBm * 360/33.33=10 dBm * 10.8.

b. The total power for all 6 interlaces might be 10 dBm*(10.8/3)*6=10 dBm * 21.6.

Other examples include the two examples below.

1. 5 interlaces are transmitted in RB set #1+3 interlaces are transmitted in RB set #2

a. For RB set #1, since 18 MHz is full, as much power as 10 dBm * 18 may be carried, converted to per interlace, 10 dBm*18/5 may be carried.

b. For RB set #2, since about 33.33 (=1 MHz/30 kHz) REs are included at most within the 1 MHz window, 10 dBm may be carried on those 33.33 REs, so the power value that may be carried on all 360 REs may be 10 dBm * 360/33.33=10 dBm * 10.8.

c. Since the PSDs of RB set #1 and RB set #2 match (18/5=10.8/3), the total power may be 10 dBm*(18/5)*8=10 dBm * 28.8.

2. 4 interlaces are transmitted in RB set #1+4 interlaces are transmitted in RB set #2

a. For one RB set, since about 33.33 (=1 MHz/30 kHz) REs are included at most within the 1 MHz window, 10 dBm may be carried on those 33.33 REs, so the power value that may be carried on all 480 REs may be 10 dBm * 480/33.33=10 dBm * 14.4.

b. The total power for all 8 interlaces could be 10 dBm*(14.4/4)*8=10 dBm * 28.8.

For example, the above results may be due to the frequency axis size being larger than 1 MHz spanned by consecutive RBs in the evenly populated case.

Other examples include the two examples below.

For example, assuming a situation where there are 100 15 kHz SCS RBs in one RB set, each interlace has 10 RBs, and the frequency axis resource spanned by the 100 RBs may be 18 MHz. The PSD limit may be assumed to be 10 dBm/MHz.

1. 7 interlaces are transmitted in RB set #1+1 interlace is transmitted in RB set #2

a. For RB set #1, there are a maximum of about 66.66 (=1 MHz/15 kHz) REs within the 1 MHz window, so 10 dBm may be carried by those 66.66 REs, so the power value that may be carried by all 840 REs may be 10 dBm * 840/66.66=10 dBm * 12.6.

b. For RB set #2, 1 RB is contained within 1 MHz, so as much power as 10 dBm * 10 may be carried.

c. When matching the PSDs of RB set #1 and RB set #2, the total power may be 10 dBm*(12.6/7)*8=10 dBm * 14.4, since RB set #1 is the bottleneck.

2. 4 interlaces are transmitted in RB set #1+4 interlaces are transmitted in RB set #2

a. For one RB set, since there are 4 RBs included within 1 MHz, as much power as 10 dBm * 10 may be carried for 4 interlaces, or converted to per interlace, 10 dBm * 10/4 power may be carried.

b. The total power of the 8 interlaces may be 10 dBm*(10/4)*8=10 dBm * 20.

For example, if the interlaces are evenly spaced as shown above, good results in terms of transmit power may be achieved.

The reason for this may be that a structure that does not place as many REs as possible within a 1 MHz window is beneficial in terms of transmit power, i.e., fewer REs within a 1 MHz window increases the power value that each RE may carry, so the more evenly distributed each RB set is, the more likely it is that fewer REs will be within a 1 MHz window.

On the other hand, if the REs within 1 MHz, whether evenly or unevenly spaced, are full, there may be no tradeoff in terms of transmit power.

For example, dividing the number of interlaces (to be used) as evenly as possible between RB sets, and schemes that space the interlaces (to be used) within an RB set by more than 1 MHz may be beneficial in terms of increasing the maximum total transmit power allowed. However, such effects may not always be possible, and in-band emission (IBE) impacts and increased probability of LBT failure when a plurality of RB sets are selected may also need to be considered.

Below, the PHY channel design framework is described.

A. slot structure

TABLE 28

| ● | Agreement | |
|---|---|---|
| | - | SL BWP, SL resource pool in R16/R17 NR SL and RB set in R16 NR-U |
| | | are reused for SL-U as baseline |

| | |
|---|---|
| • | Only one SL BWP is (pre-)configured within a carrier |
| • | The SL BWP is (pre-)configured to include one or multiple SL resource |
| | pools |
| • | At least support that one SL resource pool can be (pre-)configured to |
| | include integer number of RB sets |
| > | FFS: whether/how to support one SL resource pool can include sub-set of |
| | PRBs of one RB set |
| > | FFS: the applicable resource pool |
| > | FFS: the impact on sub-channel size and number of sub-channels in a |
| | resource pool if sub-channel is supported |
| • | PRBs within intra-cell guard band of two adjacent RB sets belong to a |
| | resource pool if the resource pool includes the two adjacent RB sets |
| > | FFS details, e.g., how such PRBs are used, the applicable resource pool, etc. |
| • | FFS: whether R16/R17 NR SL S-SSB slots and/or new S-SSB slots (if |
| | supported) are excluded from resource pool |
| • | FFS: which slots belong to resource pool, e.g., how to set the value of |
| | bitmap, whether to consider SL-U/NR-U operating in the same carrier and |
| | whether TDD configuration are considered, etc. |
| • | FFS: the impact of PSCCH/PSSCH mapping to frequency resources on |
| | resource pool configuration, on sub-channel definition if sub-channel is |
| | supported, etc. |

TABLE 29

| ● | Agreement | |
|---|---|---|
| | - | For PSCCH and PSSCH in SL-U: |

| | |
|---|---|
| • | Both R16/R17 NR SL contiguous RB-based and R16 NR-U interlace-RB |
| | based transmissions are considered as starting point |
| > | RANI strives to have unified design for both contiguous RB-based and |
| | interlace-RB bssed transmissions |
| > | FFS: whether/how to address IBE (In Band Emission) impact |

TABLE 30

| ● | Agreement | |
|---|---|---|
| | - | For PSCCH and PSSCH in SL-U: |

| | |
|---|---|
| • | For interlace-RB based transmission (if supported), at least the following |
| | candidates can be discussed: |
| > | Frequency domain resource allocation granularity is one sub-channel for |
| | PSSCH transmission |
| • | FFS: Other resource allocation granularity, e.g., RB-level |
| > | 1 sub-channel equals K interlaces if sub-channel is supported |
| • | FFS details |
| > | Other candidates are not precluded |
| > | FFS: mapping of PSCCH to frequency resources |
| > | FFS: resource indication in time/frequency domain, e.g., how to handle |
| | using one RB set or multiple RB sets, etc. |

TABLE 31

| ● | Agreement | |
|---|---|---|
| | - | For slot structure in SL-U: |

| | |
|---|---|
| • | At least R16/R17 NR SL slot-based PSCCH/PSSCH transmission is |
| | supported |
| > | FFS: whether/how to support additional starting symbol(s) within a slot for |
| | the PSCCH/PSSCH transmission |

TABLE 32

| ● | Agreement | |
|---|---|---|
| | - | For PSFCH and SL-HARQ in SL-U: |

| | |
|---|---|
| • | At least R16 NR SL PSFCH format 0 is supported |
| > | FFS whether to introduce new PSFCH format |
| • | FFS: how to meet OCB and PSD requirement for PSFCH transmission, e.g., |
| | using interlaced RB transmission, whether/how to avoid too small PSFCH |
| | capacity, etc. |
| • | FFS: the locations of PSFCH resources, e.g., (pre-)configured, dynamically |
| | indicated, etc. |
| • | FFS: whether/how to address PSFCH transmission dropping due to LBT |
| | failure, e.g., whether to have multiple PSFCH occasions for a PSSCH and |
| | the related PSSCH-PSFCH mapping relationship, impact on SL HARQ- |
| | ACK reporting to the gNB for Mode 1, etc. |
| • | FFS: whether/how to address PSFCH and related PSSCH in different COTs |

TABLE 33

| ● | Agreement | |
|---|---|---|
| | - | For S-SSB and synchronization in SL-U: |

| | |
|---|---|
| • | FFS the time domain locations of S-SSB resources, e.g., whether/how to |
| | introduce more candidate occasions compared with R16/R17 NR SL design, |
| | etc. |
| • | Down-selection at least one of the following solutions to meet OCB and |
| | PSD requirement for S-SSB transmission |
| > | Option 1: Using interlaced RB transmission |
| > | Option 2: S-SSB multiplexing with other SL transmissions in the same slot |
| > | Option 3: Repetition of S-PSS/S-SSS/PSBCH in frequency domain |
| > | Option 4: S-PSS/S-SSS/PSBCH with wider bandwidth |
| • | FFS: whether to support 4 symbols S-SSB |
| > | Note: 4 symbols S-SSB can be considered with options 1/2/3/4 above |
| • | FFS whether the temporary exemption of OCB requirement is applicable for |
| | S-SSB transmission |
| ∘ | FFS whether any changes to R16/R17 NR SL synchronization procedure |

I. 7-Symbol Interval for PSCCH/PSSCH transmissions

1. PSFCH transmission and reception may not be supported.

a. A new PSSCH DMRS pattern may be required to configure PSCCH/PSSCH/PSFCH within the TTI.

b. Alternatively, a specific TTI may consist of only PSFCH(s).

i. There may be transmission-reception switching periods between PSFCHs. (e.g., 3/3/1, 1/3/3, 3/1/3)

(1) It is possible to receive PSFCH or transmit PSFCH within the same TTI.

ii. There may be no PSFCH transmission-reception switching periods. (e.g., 2/2/2/1)

(1) If the transmission-reception switching period is not guaranteed, PSFCH reception after PSFCH transmission or PSFCH transmission after PSFCH reception in consecutive symbol groups may not be supported. Alternatively, only PSFCH transmission or PSFCH reception may be supported within a TTI.

II. Flexible starting symbol index based on channel sensing results

1. PSCCH/PSSCH MUX structure

a. If PSCCH/2ND SCI location is different for each starting symbol,

i. BD complexity may be increased at a receiving UE end.

ii. At the transmitting UE end, it may be necessary to prepare a transmission waveform for each starting symbol in advance.

b. If the PSCCH/2ND SCI location is fixed regardless of the starting symbol,

i. There may be no increase in BD complexity.

ii. When mapping PSCCH, there may be a need to avoid (possible) PSSCH DMRS locations based on different starting symbols.

c. A form of puncturing some OFDM symbols

i. The first few OFDM symbols may be punctured.

(1) The PSCCH may have a large number of symbols, or the PSCCH may be in the middle of a PSSCH symbol interval.

ii. The transmit waveform is delayed and the end of the PSSCH may be punctured.

(1) As the PSCCH location changes, BD complexity may increase at the receiving UE end.

2. A form where a receiving UE that receives a long TTI transmission, considering the AGC problem (due to the coexistence of short TTI transmissions), punctures a symbol that requires an additional AGC operation to be performed (e.g., no special operation on the part of the transmitting UE).

a. For example, a transmitting UE may indicate to a receiving UE whether to transmit the additional AGC symbol (ADD_AGCSYM).

i. Exceptionally, a transmitting UE may not perform any special operation (without performing additional ADD_AGCSYM transmission/indication) if the resources in the RB set are all used up.

3. When punctuating symbols that require additional AGC (from a data decoding perspective) by a receiving UE due to the coexistence of transmissions with different TTI lengths within a resource pool, a method may be provided to reduce the impact of this.

a. For example, variations of the SYSTEMACTIC bit mapping scheme

b. For example, TBS Scaling Factor Adjustment Scheme

B. SL-HARQ procedure on SL-U

I. When a plurality of PSFCH opportunities are allowed in a single PSSCH opportunity,

1. After setting a plurality of minimum (min)-PSSCH-to-PSFCH timings (e.g., slot level, RB set level, symbol level), the actual PSFCH timing may be determined based on the success of the LBT.

a. Collisions may be avoided by distinguishing PSFCH RB sets (groups) or resource sets between timings.

b. An implicit determination rule may be applied per PSFCH resource group for each timing.

c. If a plurality of PSSCH-to-PSFCH timing (e.g., K1>K2) related PSFCH resources are shared, the Kl-based PSFCH resources may also be determined according to the K2-based rules.

2. a configuration scheme for a plurality of PSFCH opportunities

a. For example, as before, it may be in the form of obtaining a single minimum PS SCH-to-PSFCH timing and selecting K opportunities based on this timing by predefined rules. For example, in this case, a transmitting UE may signal not to use any PSFCH opportunities after the maximum time points it indicates, taking into account the remaining PDB, etc.

i. For example, a scheme that derives a plurality of opportunities based on the RB set region

ii. For example, a scheme that derives a plurality of opportunities based on the slot region

iii. For example, a form where an RB set region is used first, followed by a slot region (e.g., a form where opportunities related to RB set #1/2 are repeatedly defined in slot #1 and slot #2, a form where the PSFCH index K in RB set #1 is implicitly (repeatedly) defined as an opportunity of the same index in RB set #2)

b. a form where a PSFCH resource is configured across multiple RB sets when multiple opportunities are not considered.

3. PSFCH resource mapping rules that consider the RB set index, CS index, and RB index related regions may be considered.

4. Dynamic indication through SCI

a. PSFCH collision issues between different transmitting UEs may occur.

i. After receiving the SCI and/or the 2ND SCI, a PSFCH collision may be avoided based on the PSFCH resource information. For example, the above operation may be performed based on conditions such as RSRP measurement.

ii. Randomization based on the source ID may be assumed to be sufficient, or additional parameters for randomization may be introduced.

5. For Mode 1 SL HARQ reporting, the base station may not know the PUCCH timing correctly, and BE may need to be performed.

a. A PUCCH resource may be configured separately per UE, such as SR PUCCH. A codebook may be configured so that information for PSSCH ((DCI) HARQ process number, PSSCH opportunity) is indicated or separated together with the SL HARQ-ACK reporting.

i. For example, it may be defined that the stacking of SL HARQ-ACK information transmitted to PUCCH is implicitly performed based on parameters such as (mode 1 DCI) HARQ process number, mode 1 SL grant timing, etc. For example, this may reduce the overhead of additional information signaling.

ii. A PSFCH transmission linked to a PSSCH transmission may be performed on different COTs.

(1) A form supported by Mode 2 only

1) For example, when PSFCH #1 for PSSCH #1 on COT #1 cannot be transmitted within COT #1 due to factors such as LBT failure, required minimum processing time, etc., the transmitting UE may signal to the receiving UE an indication that pending the transmission of PSFCH #1 (in the latter case), or the receiving UE may transmit PSFCH #1 within a subsequent COT #2 according to predefined rules. (e.g., when transmitting PSFCH #2 related to PSSCH #2 within COT #2, PSFCH #1 is transmitted along with it).

2) For example, a form where a transmitting UE indicates a retransmission of PSFCH #1 (in COT #2) for PSSCH #1, in the above example situation

(2) A form not supported in Mode 1

1) For example, it may be difficult for a transmitting UE to dynamically report to a base station whether the receiving UE's PSFCH transmission is out of the COT region.

2) For example, in terms of information reported via PUCCH, it is necessary to distinguish between a NACK due to the PSFCH transmission of the receiving UE being outside the COT region, or a NACK due to the failure of the receiving UE to decode the PSSCH.

(3) For example, when a gNB does not perform LBT operation for an unlicensed band, a single Mode 1 DCI may schedule/allocate a plurality of RSC (resource) sets. (e.g., a form where the PUCCH resource is configured separately per RSC set (e.g., considering the possibility of different TB transmissions per RSC set), a form where only the PUCCH resource is configured for the last RSC set (e.g., assuming the same TB transmission between RSC sets), and a form where the HARQ process ID information (related to the Mode 1 DCI) is added to the PUCCH information).

b. If indicated by SCI, the gNB may take over what the gNB has indicated via DCI. For example, the operation may require that the gNB is in a state where access to the U-band is available.

c. A single PUCCH resource may be configured based on the relatively longest of a plurality of timelines.

i. For example, the amount of information reported by PUCCH may increase due to an increase in the number of PSSCH resources linked to PSFCH.

II. PSFCH drops due to LBT failure or PSFCH drops due to PSFCH transmission(s)/reception collision(s)

### 1. Procedure Performance Order

a. Perform LBT on the final PSFCH transmission after handling PSFCH transmission(s)/reception collision(s)

b. In case of LBT failure, deprioritized PSFCH reception may be performed

c. On successful LBT, whether to perform a deprioritized PSFCH transmission (may be mutually (pre-)configured).

2. For example, after performing LBT, UE implementation complexity may increase when applying prioritization rules for the successful PSFCH(s). For example, UE implementation complexity may be increased by PSFCH power configuration.

3. For example, under Mode 1 operation, when a plurality of PSFCH timing opportunities are configured for GC PSSCH transmissions, the transmitting UE may be caused to report a NACK via its linked PUCCH resource when a NACK is received from some of the receiving UEs in a preceding opportunity. For example, the base station may schedule retransmission resources after the subsequent opportunity via the received NACK information.

a. For example, in the case of NACK only, a common resource is configured for a plurality of PSFCH timing opportunities, and a receiving UE may transmit a NACK based on one of them.

b. For example, in the case of NACK only or both ACK/NACK, the receiving UE may transmit the PSFCH repeatedly on a plurality of PSFCH timing opportunities.

i. For example, additional interference from other RATs (e.g., WI-FI) in an unlicensed band may be considered.

ii. For example, for the operation of a transmitting UE for retransmission or buffer flush when the SL HARQ information received by the transmitting UE via a plurality of PSFCH timing opportunities is different

c. For example, depending on the capability, whether the receiving UE performs (repeated) transmissions on a plurality of PSFCH timing opportunities may vary.

The following describes the channel access procedure.

A. The gNB may indicate to other UEs the COT initiated by a UE.

I. MAC CE for reporting new UCI type or COT information

1. If the above indicator is in UCI format, the UCI multiplexing, SL-UL prioritization rules may need to be redefined. For example, if it is a PUCCH transmission, there may be too many PUCCH opportunities if it is in the same format as SR. For example, if the periodicity is defined, it may be difficult to meet the processing time budget.

a. If the above indicator is in the form of a CG-UCI, it may be transmitted via CG PUSCH on a licensed carrier.

2. If the above indicator is in the form of MAC CE, the processing time budget may not be sufficient. For example, depending on the CAPC, the maximum COT duration may be 2-3 msec or 10 msec.

B. UE-to-UE COT sharing

I. After receiving PSCCH/PSSCH, a type 2 channel access may be performed on the PSFCH.

1. The channel access type and/or whether to CPE and/or the length of the CPE for a PSFCH may be indicated via the 1st SCI and/or the 2nd SCI.

a. It may be joint coded in the SL HARQ-ACK enabled/disabled indicator field.

2. When transmitting a plurality of PSFCHs, and when each PSFCH has a different indication channel access type,

a. A channel access procedure may be performed for each PSFCH and whether or not to transmit may be determined for each. This feature may be appropriate when there are different UEs receiving PSFCHs.

b. Type 2 may be used if there is at least one PSFCH where Type 2 LBT is applied. Whether it is a channel access may be determined in one LBT operation. In this case, the reference power may be the maximum power of a single PSFCH. For example, if a maximum of four transmissions are assumed, the maximum of them may be the reference power. Alternatively, for example, the maximum power of a multiple PSFCH reference may be the reference power.

i. For example, additional rules may also be defined between PSFCH transmissions of the Type 2 series.

(1) For example, if PSFCH transmissions of type 2 A/B/C overlap, either type 2A or type 2C may be applied.

c. For example, when a receiving UE transmits a plurality of PSFCH transmissions adjacent in time domain (e.g., in burst form),

i. The channel access type of the first transmission may be applied to subsequent transmissions, such as NR-U UL burst transmissions. Alternatively, the shortest length LBT type may be applied.

II. After receiving PSCCH/PSSCH, perform Type 2 channel access to PSCCH/PSSCH

1. The remaining COT duration may be indicated via the 1st SCI and/or the 2nd SCI. In this case, no PSCCH/PSSCH/PSFCH may be transmitted or type 1 may be performed for the PSFCH reception opportunity and the channel sensing duration for it, to assist the PSFCH reception of the PSCCH/PSSCH transmitting UE.

2. When the receiving UE is available, taking into account PSCCH/PSSCH decoding and that the transmitting UE continues some transmissions for channel occupancy.

a. it may be possible after the minimum PSSCH-to-PSFCH timing. Any combination of processing times may be possible, such as from the slot following the minimum-PSSCH-to-PSFCH timing, from T_{PROC,0}+T_{PROC,1}, etc.

b. From that interval, the transmitting UE may also determine that the COT is shared and may prohibit or deprioritize the transmission. Unlike gNB, in mode 2 operation, the shared COT duration may be excluded from the available resources.

3. Handling of reserved resources for a UE initiating COT in a shared COT duration

a. By overriding a resource for which COT sharing is reserved, the receiving UE may use that resource region.

1. SL-U related discussion (sidelink on an unlicensed band)

The channel access mechanism is described below.

According to an embodiment of the present disclosure, (Issue 1) When, after the SL grant is generated, whether the actual transmission on the related resources is determined via an additional LBT (e.g., Type 1),

A) The start time point of the selection window related to SL grant generation may be delayed by a (pre-)configured offset, considering the (minimum) required time for additional LBT operations.

For example, at the time point where resource selection is triggered, the applied offset value may vary depending on the selected BO counter value (or the minimum selection window size with respect to the priority of the data) related to the Type 1 LBT. For example, if the BO counter value is large, the offset value applied may be large. The above principle may be applicable to other options as well.

B) The starting point (N+Ti) of a selection window may be determined as before (license band).

For example, a selectable (idle) candidate resource used for SL grant generation may be configured in the region after a (pre-)configured offset (OFF VAL) from time point “N+Ti”.

Alternatively, for example, an SL grant may be generated using only those resources located after “N+T1+OFF_VAL” among the (idle) candidate resources in the selection window.

For example, the selection window to which X % is applied may be a selection window derived based on the existing scheme (license band), or it may be a modified selection window that considers the time required for additional LBT operations. For example, it may be configured so that the type to be used is determined based on the CAPC value between the two types.
The X % value may be (pre-)configured differently depending on the CAPC value or the modified selection window size value.
The relevant parameters may be configured per pool/carrier or per LCH/QOS profile/RB.

C) Depending on the existing scheme (license band), resources located before the (minimum) time required for additional LBT operations after the formation of the selection window and SL grant generation may be omitted.

For example, even in mode 2, the initial transmission of MAC PDUs on retransmission resources may be allowed.

For example, a reselection of the above resource may be triggered (e.g., the related SL grant may be cleared, or only the related resource may be reselected and the existing resource on the SL grant may be replaced with it), or a single MAC PDU resource selection may be triggered to replace the above resource.

D) Within the selection window formed as before (license band), the (idle) candidate resources located later in the time domain may be preferentially selected. For example, in this case, an additional application of the option C scheme may be required.

For example, when applying the above option, if the selection window size becomes smaller than a pre-configured minimum size value, the data transmission may be omitted, or exceptionally, SL grant generation based on the minimum selection window size may be performed, but if some selected/reserved resources are later in the time domain than the LBT completion time, the transmission on those resources may be omitted.

For example, drops due to LBT failures may be excluded from the counting of MAC PDU-related transmissions. For example, drops due to LBT failures may be excluded from the counting of MAC PDU-related transmissions in terms of reaching the maximum allowed PHY parameter related to congestion control, or in terms of ACK/NACK determination reported via Mode 1 PUCCH.

For example, the maximum value of the offset may be configured per CAPC, wherein the maximum BO counter related to each CAPC may be replaced by the time consumed without being busy. Further, for example, if the maximum value of the offset does not allow the minimum selection window size to be satisfied, exceptionally, resource selection may be performed based on the minimum selection window size.

According to one embodiment of the present disclosure, a form wherein the upper bound at the start of the selection window is assumed to be “N+TPRoc1+offset” may be provided.
For example, the offset in the above options may be applied as a (minimum) separation interval between resources involved in SL grant generation.
For example, a combination of the above options may be applied/utilized.

According to an embodiment of the present disclosure, (issue 2), during re-evaluation/pre-emption operation, conditions for performing/stopping LBT operation may be provided.

A) For resources whose re-evaluation/pre-emption-based reselection is triggered, the LBT operation that was performing to determine whether to allow transmission based on that resource may be stopped.

B) Re-evaluation/pre-emption based resource reselection may be limited to resources that have successful LBTs. Alternatively, for example, re-evaluation/pre-emption checking may not be performed for resources that fail LBT. Alternatively, for example, after checking whether re-evaluation/pre-emption based resource reselection is required, LBT may only be performed on resources that do not.

For example, a condition is proposed to perform additional re-evaluation/pre-emption checking on resources that fail LBT.

For example, depending on a parameter (combination of parameters) such as the priority of the packet related to the transmission resources of other UEs with which it overlaps (e.g., lower priority than the threshold value) or the priority of the packet it intends to transmit (e.g., higher priority than the threshold), it may be allowed to perform additional re-evaluation/pre-emption checking.

For example, when LBT fails, about triggering resource reselection (e.g., a form where only relevant resources from SL grants are reselected) and allowing retransmissions,

Whether the above operation is applied or not may be configured differently based on parameters such as priority, remaining PDBs, etc.

According to an embodiment of the present disclosure, (Issue 3), a relationship between LBT intervals and SL sensing intervals may be provided.

For example, for a power saving UE, for example, the LBT interval and the SL sensing interval may be configured to maximally match.

For example, when attempting to match an LBT interval to a discontinuous SL sensing duration, after a certain gap, the type of LBT may fall back to a predefined one (e.g., type 1), or the BO counter value may be maintained if it is idle by TD, otherwise the BO counter value may be reselected to resume LBT operation.

According to an embodiment of the present disclosure, (Issue 4) when reselecting resources considering the HARQ RTT timeline,

For example, if a plurality of PSFCH opportunities are linked per PSSCH, reselection may be performed based on the location of the PSFCH resource farthest from the PSSCH.

For example, in timing of the mode 1 PUCCH resource configuration, the PSFCH resource location may be a reference.

According to an embodiment of the present disclosure, (Issue 6), when there is no capability for simultaneous transmission of Mode 1 PUCCH and SL-U transmissions (e.g., PUCCH and SL-U transmissions are on different carriers), when selecting SL transmission resources, the time domain overlapping with PUCCH resources may be excluded.

For example, similar principles may be applicable to SL CA.

According to an embodiment of the present disclosure, (Issue 5-1), the CAPC value (SLG_CAPC) used to generate the SL grant and the CAPC value (SLM_CAPC) related to the generation of MAC PDUs on the SL grant may be different. (Or, after SL grant generation, the CAPC value (SLG CAPC) related to the (additional) LBT performed to determine whether a packet may be transmitted on the related resource may be different from the CAPC value (SLM_CAPC) related to MAC PDU generation on the corresponding resource).

In this case, for example, unlike NR-U UL, in Mode 2 SL-U operation, the SL grant may not be given in advance.

For example, it may be a general assumption that the LBT operation starts when data is available in the buffer.

For example, a Mode 1 SL-U operation may be considered similar to an NR-U UL.

Below, possible scenarios are described.

$$SLG\_CAPC < SLM\_CAPC \qquad Scenario 1 - 1 )$$

Scenario 1-2) may make more sense from the perspective of channel access fairness than 1-1).

$$SLG\_CAPC > SLM\_CAPC \qquad Scenario 1 - 2 )$$

Additional issues to consider

For example, the CAPC value used in the LBT that determines whether a packet may be transmitted on SL grant related resources may be selected by the UE implementation as one of SLG_CAPC and SLM_CAPC. For example, the SLG_CAPC related BO counter selected (or maximum) value may be smaller than the SLM_CAPC related BO counter selected (or maximum) value.

For example, for a limited capability UE, the LBT operation may be performed after MAC PDU generation.

Below, potential enhancements for the above features are described.

### Option 1-1)-MAC Solution

For example, after generating an SL grant, when performing the LCP procedure for MAC PDU generation, the destination with the highest priority may be selected from among data with a CAPC value less than or equal to SLG_CAPC, or data with a CAPC value less than or equal to SLG_CAPC may be selected after destination selection based on the existing LCP procedure.

If there is still room (in the MAC PDU size to be generated) after data selection based on Option 1-1,

1-1-1) Zero-padding may be performed.

1-1-2) Data may be additionally selected in ascending order of CAPC value from among data with CAPC values greater than or equal to SLG_CAPC that have the same selected destinations.

1-1-3) Data with the CAPC value greater than or equal to SLG_CAPC, but with the same selected destinations, may be additionally selected by applying the existing LCP procedure criteria.

1-I-4) For each data, a priority value (ADD PRI) may be (pre-)configured to be used in this case, and data with the same selected destination may be additionally selected in the ascending order of the ADD_PRI value.

For example, ADD_PRI may be replaced by the result of “SL-PRIORITIZEDBITRATE X SL-BUCKETSIZEDURATION” used in the LCP procedure, i.e., for example, the thing with this value that is larger may be interpreted as a relatively lower ADD_PRI value.
SCCH/MAC CE, etc. may be additionally selected in preference to STCH.

1-1-5) The (pre-)configured data/service type/type (or cast type (e.g. BC) or SL HARQ feedback type (e.g. NACK ONLY)) may be preferentially additionally selected.

1-1-6) The data with relatively large numbers of LBT failures, NACKs, etc. may be preferentially selected.

For example, among data of the same CAPC, data that may fill as much of the MAC PDU size as possible may be preferentially selected.

For example, it may be applied both from a destination selection perspective, or from an operation perspective after a destination is selected.

Option 1-2)-MAC solution

For example, after SL grant generation, MAC PDUs may be generated by performing the existing LCP procedure (i.e., selecting the destination of the highest priority data) without consideration of SLG_CAPC.

Option 1-3)-PHY/MAC solution

For example, a new SL grant may be formed by not performing a data transmission based on the existing SL grant, but performing a new LBT operation (i.e., performing a channel access operation based on the lowest CAPC value related to the most recent data to be transmitted).

Option 1-4)-PHY solution

For example, the CAPC value at the start time point of the LBT operation related to SL grant generation may be different from the CAPC value when the actual resource selection is performed.

For example, when “N” is the time point when resource (re)selection is triggered (or when data is available in the buffer),

1-4-1) The start time point (Ti) of the selection window may be determined by adding a (pre-)configured offset value (LBT_OFFVAL) to the selected value within the existing range (i.e., 0<Ti<Tₚroci), or the selectable range of Ti values may be defined as “0<Ti<TPRoci+LBT_OFFVAL”.

For example, the LBT_OFFVAL value may be interpreted as the (minimum) time allowed for additional SLM_CAPC-based LBT operations.

For example, the actual application of the LBT_OFFVAL value may be limited to cases where the SLG_CAPC and SLM_CAPC values are different. In particular, SLG_CAPC <SLM_CAPC.

For example, when the solution described in Issue 1 is applied, when the CAPC value used to determine the selection window type/length is different from the CAPC value that is to be used to generate the MAC PDU, an update of the selection window may be performed through an additional signaling exchange between the MAC layer and the PHY layer.

1-4-2) When the PHY layer reports to the MAC layer the set of idle resources to be used for resource selection, it may only target resources located after the completion/success of the additional SLM_CAPC-based LBT operation.

For example, determining the start time point of the selection window may be performed as before.

For example, in terms of solutions applied between modes 1/2, operations may be performed that are as common as possible.

According to an embodiment of the present disclosure, (Issue 5-2), a potential improvement to the impact of Issue 5-1 on the pre-emption/re-evaluation operation may be proposed.

2-1) [Pre-emption/Re-evaluation Procedure]When the retransmission resource is re-selected, the LBT operation may be performed based on the CAPC value of the initial transmission-related MAC PDU (or the CAPC value applied to the initial transmission resource).

2-2) [Re-evaluation Procedure]When the initial resource is reselected, the LBT operation may be performed based on the most recent data-related CAPC value.

2-3) [Pre-emption/Re-evaluation Procedure]When performing periodic resource reservation, when reselection for an initial resource within a non-first period, the LBT operation may be performed based on the CAPC value related to the most recent data to be transmitted within the corresponding period, and when reselection for a retransmission resource, the LBT operation may be performed based on the CAPC value of the initial transmission-related MAC PDU (or the CAPC value applied to the initial transmission resource).

Alternatively, for example, the CAPC value may be reapplied to resource (re)selection in the previous period or within the first period.

2-4) In the case of 2-1)/2-2)/2-3) above, the CAPC value used to generate the SL Grant may be applied. For example, when generating an SL Grant, the CAPC value related to LCH where data is available may be reused.

According to an embodiment of the present disclosure, (Issue 7), a back-to-back transmission of SL-U may be provided.

For example, within a COT, when TB transmissions of a plurality of (N) different CAPCs are performed consecutively (with an interval of 16 msec or less) in the time domain,

For example, an LBT operation may be performed by designating the largest of the CAPCs available at the time of the first TB transmission (or the CAPC value of the first transmitted TB) as the representative CAPC value, or

For example, another TB transmission is added after the first TB transmission time point, and if the related CAPC value is greater than the above representative CAPC value, the transmission in the existing burst form may be stopped and a new burst transmission may be performed; or

For example, if another TB exists between the other added TB #D and the TB #A currently being transmitted, only the TB transmission immediately before the TB #D transmission location may be omitted (i.e., a form where the TB #A transmission is performed); or

For example, when selecting the additional TB-related resources, it may be performed in a form that does not cause omissions in existing TB transmissions.

According to an embodiment of the present disclosure, when performing multiple MAC PDU-related resource reservation, whether a resource at a neighboring location may be selected between different SL processes/SL grants based on a representative CAPC value related to each SL process/SL grant (e.g., a maximum CAPA value related to LCH data present/used at the time of SL grant generation) may be determined. In other words, based on a representative CAPC value related to each SL process/SL grant, whether to select a resource in a neighboring location between different SL processes/SL grants or to avoid selecting a resource in a neighboring location may be determined.

For example, if resource selection of neighboring locations should be avoided (due to different representative CAPC values), resources located within the relevant gap (time interval to be avoided) may be excluded from the candidate set (configuration) available for selection.

For example, when multiple MAC PDU-related SL processes/SL grants exist,
When attempting to use resources of neighboring locations related to different SL processes/SL grants without omitting some transmissions, CAPC limit-based selection for the data to be included in the MAC PDU generation may be performed in individual SL process/SL grant related LCP procedures to prevent this (i.e., to prevent omitting some transmissions). For example, a CAPC limit-based selection of data to be included in the MAC PDU generation may be performed such that the TB-related CAPC value on the preceding SL grant resource is greater than or equal to the TB-related CAPC value on the trailing SL grant resource.
Based on the CAPC value related to the data to be transmitted via independent MAC PDU, the selection for (different) SL processes/SL grants with resources of neighboring locations, or (different) SL processes/SL grants that do not (among resources that have avoided resources of neighboring locations) may be determined.

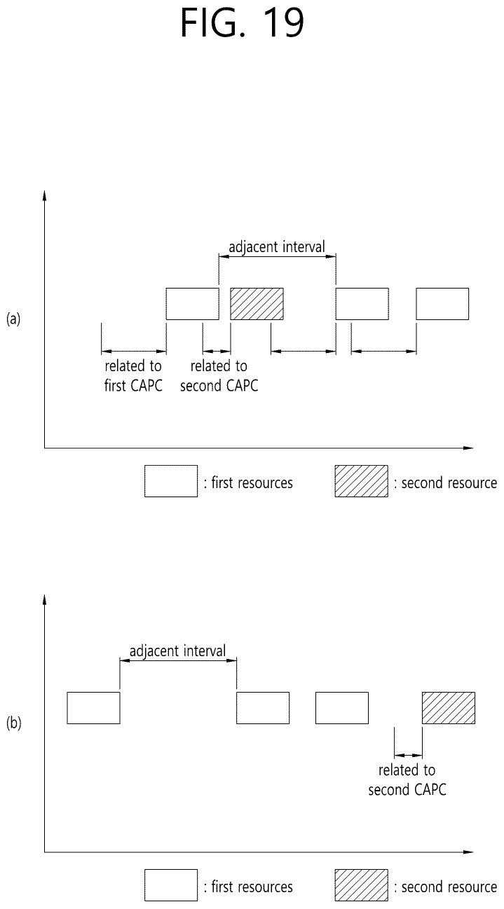

FIG. 19 shows a resource selection method performed for transmission of a MAC PDU related to different SL processes, according to one embodiment of the present disclosure. The embodiment of FIG. 19 may be combined with various embodiments of the present disclosure.

For example, a transmitting UE may be a UE that is about to transmit a first MAC PDU related to the first SL process and a second MAC PDU related to the second SL process. Here, the transmitting UE may determine whether to select a resource for transmitting the first MAC PDU and the second MAC PDU as a neighboring resource, according to various embodiments of the present disclosure.

Referring to FIG. 19(a), first transmission resources already selected for transmitting the first MAC PDU are shown. Here, it is assumed that a transmitting UE has determined to select a second transmission resource for transmitting the second MAC PDU, from among the neighboring resources of the first transmission resources. The transmitting UE may select the second transmission resource within a neighboring interval of the first transmission resources. For example, in order for the second transmission resource to be selected within a neighboring interval of the first transmission resources, the transmitting UE may determine, in the LCP procedure related to the second SL process, the CAPC value related to the second MAC PDU to be: i) less than or equal to the CAPC value related to the first MAC PDU, if the first transmission resources precede the second transmission resource to be selected; or ii) greater than or equal to the CAPC value related to the first MAC PDU, if the first transmission resources lag behind the second transmission resource to be selected.

Alternatively, for example, the LCP procedure may be performed prior to determining whether to select a neighbor resource. In this case, for example, if the CAPC value related to the second MAC PDU is less than or equal to the CAPC value related to the first MAC PDU, it may be determined that neighbor resource selection is performed or not performed. For example, in this case, if neighbor resource selection is performed, the second transmission resource may be lagging behind the first transmission resource.

Alternatively, for example, the LCP procedure may be performed prior to determining whether to select a neighbor resource. In this case, for example, if the CAPC value related to the second MAC PDU is greater than or equal to the CAPC value related to the first MAC PDU, it may be determined that neighbor resource selection may or may not be performed. For example, if neighbor resource selection is performed in this case, the second transmission resource may precede the first transmission resource.

For example, in (a) of FIG. 19, the transmission of the first MAC PDU and the transmission of the second MAC PDU may share the result of LBT, i.e., for example, if the LBT result for the most preceding resource is idle, the transmission based on the lagging resource may be performed without channel sensing for the lagging resource.

Referring to (b) of FIG. 19, the first transmission resources already selected for transmitting the first MAC PDU are shown. Here, it is assumed that the transmitting UE has determined to select a second transmission resource for transmitting the second MAC PDU, avoiding neighboring resources of the first transmission resources (i.e., it has determined not to perform neighbor selection). The transmitting UE may select the second transmission resource by avoiding resources within the neighboring interval of the first transmission resource. For example, during the resource selection procedure, the transmitting UE may exclude resources included in the neighboring interval from the candidate resources/idle resources. For example, the MAC layer of the transmitting UE may not select resources included in the neighboring interval during the resource selection procedure.

Alternatively, for example, the LCP procedure may be performed prior to determining whether to perform neighbor resource selection. In this case, for example, if the CAPC value related to the second MAC PDU is less than or equal to the CAPC value related to the first MAC PDU, the neighbor resource selection may or may not be determined to be performed.

Alternatively, for example, the LCP procedure may be performed prior to determining whether to perform neighbor resource selection. In this case, for example, if the CAPC value related to the second MAC PDU is greater than or equal to the CAPC value related to the first MAC PDU, the neighbor resource selection may or may not be determined to be performed.

For example, in the embodiment, the neighboring interval may refer to the LBT channel sensing duration related to the lagging resource (or the time interval for which the LBT channel sensing duration is considered). For example, the neighboring interval may include neighboring intervals of time and/or frequency resources.

For example, when reselecting resources based on a procedure such as pre-emption/re-evaluation, when configuring the selectable candidates for reselected resources, resources that are not transmittable for the reasons described above may be excluded.

The following describes the existing operation/spec information for NR-U.

Regarding back-to-back operation

In the back-to-back operation of CG/DG, consecutive transmissions may only be possible when CG CAPC >=DG CAPC, otherwise (i.e. CG CAPC <DG CAPC) CG transmission may be omitted.

In the back-to-back operation of DG (CAPC P1)/DG (CAPC P2), if P1 >=P2, continuous transmission may be possible; otherwise (i.e., P1<P2), the P1-based LBT operation is terminated and the P2-based LBT may be performed again.

In the back-to-back operation of CG/CG, different CG-based transmissions may be assumed to be the same CAPC.

Regarding LBT operation

For example, within a shared COT, only transmissions based on a CAPC value less than or equal to the CAPC value used for COT initiation may be allowed.

From a COT responder perspective,

If the Type 2B LBT fails, a Type 2A LBT may be performed, and also if the Type 2A LBT fails, the Type 2A LBT may continue to be performed.

The duration limitation for Type 2C based transmission may only be applied to the operation of the COT responder.

However, if a Type 2B/2A LBT-based transmission is initiated and followed by a Type 2C-based transmission, the DURATION LIMITATION of the Type 2C-based transmission may not be applied.

From a COT initiator perspective,

Type 2 series may not be applied. With a CAPC-based maximum COT length limit, only a transmission in the form of a transmission burst may be possible, i.e., for example if a gap greater than 16 msec occurs, a new COT may need to be generated based on performing a Type 1 LBT.

Below, the Physical structure is described.

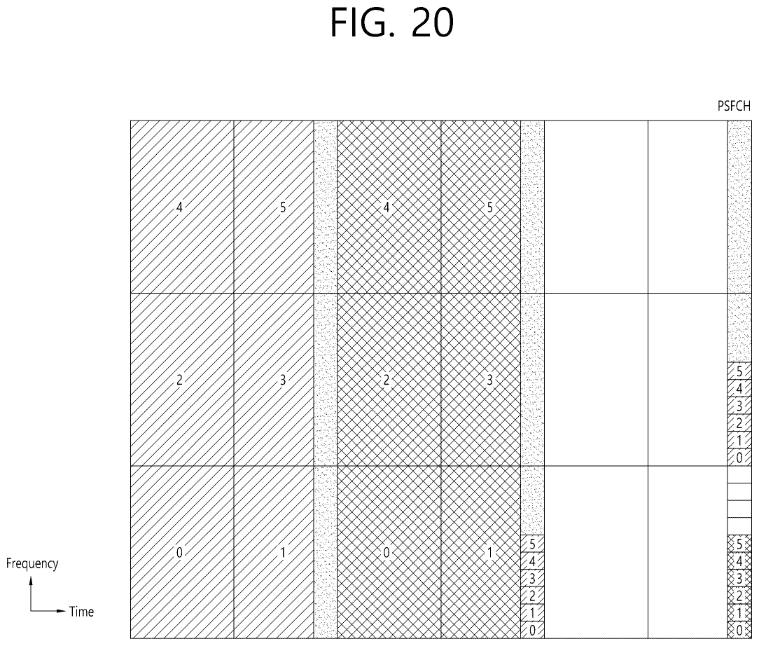

FIG. 20 is a diagram to illustrate a determination rule for PSFCH occasions, according to one embodiment of the present disclosure. The embodiment of FIG. 20 may be combined with various embodiments of the present disclosure.

I. Referring to FIG. 20, different PSFCH PRB groups may be generated according to the minimum-PSSCH-to-PSFCH timing. For each timing, the implicit PSFCH determination rule of Rel-16 may be used.

1. Instead of a PSFCH PRB group, it may be a PSFCH symbol group, RB set.

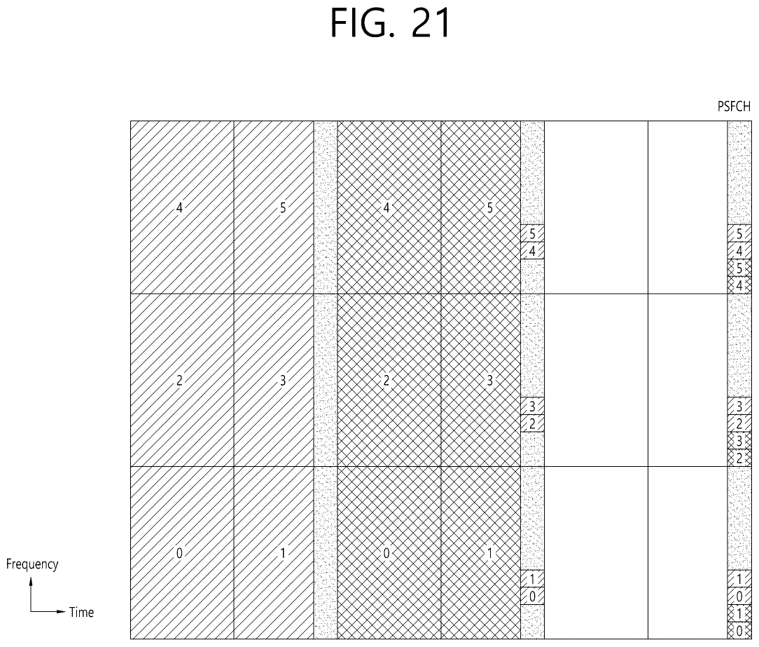

FIG. 21 is a diagram to illustrate a determination rule for PSFCH occasions, according to one embodiment of the present disclosure. The embodiment of FIG. 21 may be combined with various embodiments of the present disclosure.

Referring to FIG. 21, the priority according to the PSFCH transmission occasion order may be changed. For example, the transmission occasion may be considered after the SL priority basis, or the transmission occasion may be considered after the SL priority basis.

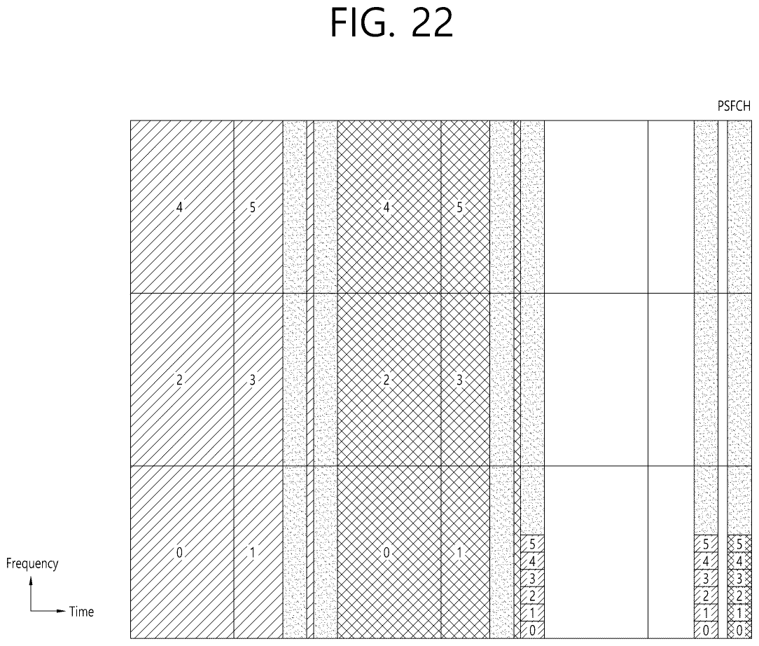

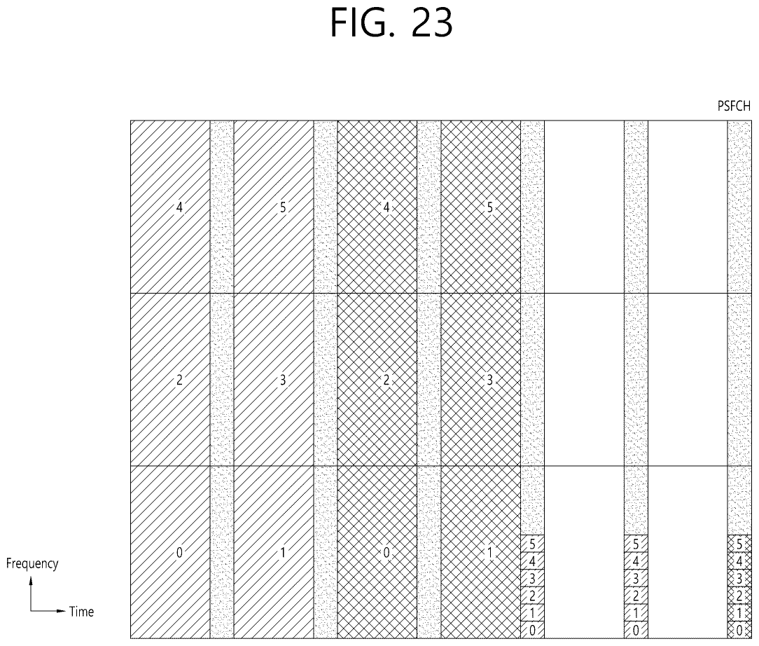

FIG. 22 and FIG. 23 are drawings to describe a determination rule for PSFCH occasions, according to one embodiment of the present disclosure. The embodiments of FIGS. 22 and 23 may be combined with various embodiments of the present disclosure.

Referring to FIG. 22 and FIG. 23, a form with a period of 4, but with a separate period offset, is shown. For example, there may still be one PSFCH occasion in a PSFCH slot.

For example, an SL transmission burst may be composed of a combination of AN-based PSSCH+blind retransmission.

For example, when a SL transmission burst is composed of a combination of AN-based PSSCH+AN-based PSSCH, the AN for the second PSSCH may be included in the next burst.

II. For example, a plurality of PSFCH occasions may be allowed in a PSFCH slot. For each PSFCH occasion, the implicit PSFCH determination rules of Rel-16 may be applied.

1. The UE may use different PSFCH occasions depending on the time point of successful LBT within the PSFCH slot.

a. Assuming at least 2 PSFCH occasions are used, 7 symbols within a slot may be used as PSFCH and gap. For example, a PSSCH symbol gap may be up to 7 symbols.

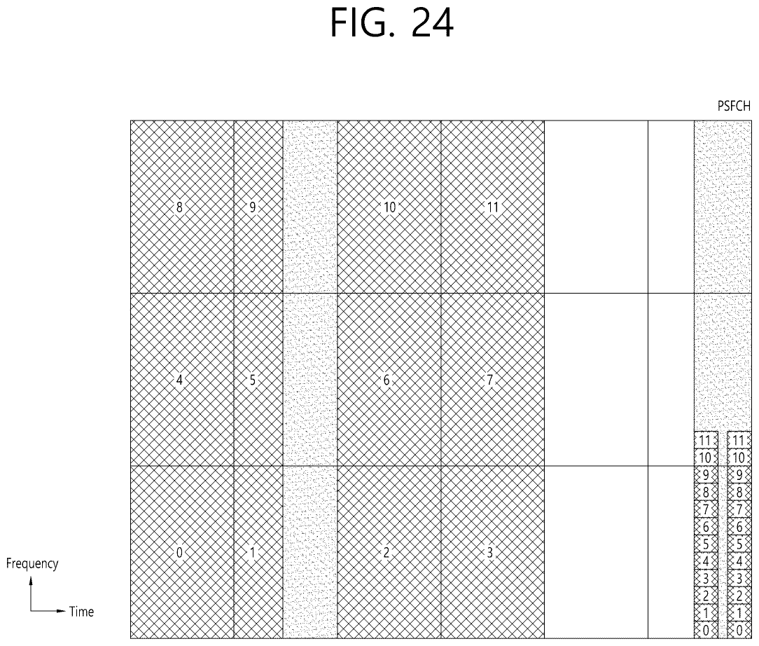

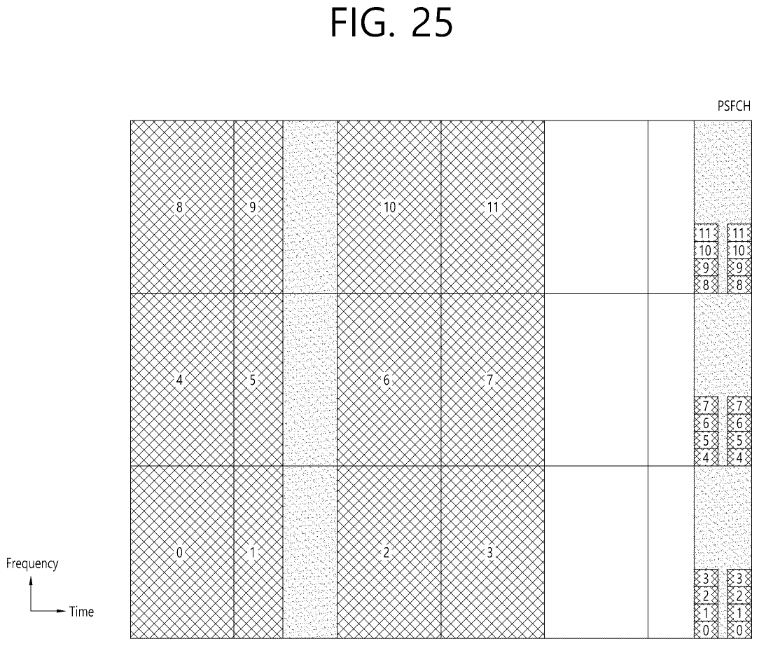

FIG. 24 and FIG. 25 are drawings to describe a determination rule for PSFCH occasions, according to one embodiment of the present disclosure. The embodiments of FIGS. 24 and 25 may be combined with various embodiments of the present disclosure.

Referring to FIG. 24 and FIG. 25, the PRB offset between PSFCH occasions may be configured separately. This allows for more PSFCH occasions to be secured.

For example, the present embodiments may be extended to the case of different PSFCH slots. For example, the RB set may become different depending on the PSFCH occasion. For example, the different RB sets may be in a staggered structure.

i. For example, a PSFCH PRB group may be allowed per RB set in a PSFCH slot. For example, the implicit PSFCH determination rules of Rel-16 may be applied for each PSFCH PRB group.

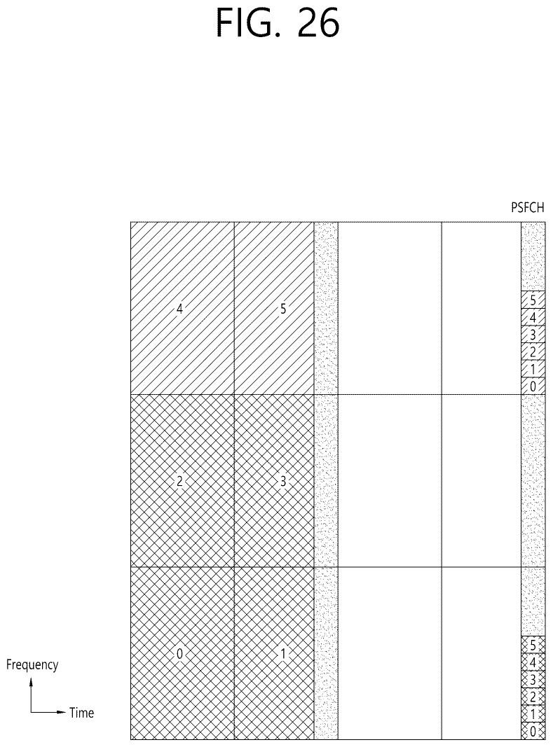

FIG. 26 is a diagram to describe a determination rule for PSFCH occasions, according to one embodiment of the present disclosure. The embodiment of FIG. 26 may be combined with various embodiments of the present disclosure.

Referring to FIG. 26, different colors may mean different RB sets. For example, if the LBT is successful for both PSSCH occasions, the RB set of the PSSCH may be prioritized. For example, the operation may be to maintain the COT. For example, simultaneous transmission may be possible based on the remaining COT interval, the RB set configuration of the simultaneously transmitted PSFCH, and the channel access type (Type 1, Type 2).

For example, PSFCH occasions may be configured for multiple RB sets for PSCCH/PSSCH for the same TB or for different TBs, and whether the final use is determined by successful channel access. For example, in Mode 2 RA, the selection resource may be determined in a similar form. For example, if simultaneous transmission is not possible, if LBT is successful for multiple PSSCH occasions, the PSFCH occasion may be finally selected based on channel access type, SL priority, CAPC, etc.

ii. For example, combination of each may be possible.

A. In this case, the order of LBT attempts could be frequency first, followed by time (symbol, slot).

i. The order may be different for different CAPCs, SL priorities, and QoS. For example, if the PDB is long, it may be performed for the slot first, while if the PDB is short, it may be kept within the slot as much as possible.

iii. Mapping for resource scarcity issues in interlace RB-based PSFCH transmissions

1. For example, one bin may represent one interlace.

b. If not for alleviating LBT failure issues, there may be no time gap between PSFCHs.

i. 2*4 may be used as a PSFCH resource, 2 transmission-reception switching symbols before and after a PSFCH bundle.

(1) There may be four remaining symbols, and a PSSCH DMRS pattern may be defined.

c. In situations where the remaining symbols are not available for PSSCH transmission purposes, a gap between PSFCHs may be configured.

i. There may be a time gap between the four PSFCH occasions. For example, the gap may be 3*4=12 symbols.

ii. The number of PSFCH occasions may also be reduced if a PSSCH does not exist in the PSFCH slot.

(1) Three PSFCH occasions with or without a time gap. For example, it may be 7 symbols if no time gap is included.

(2) Considering multiple PSFCH timings due to LBT failures, groups of PSFCH occasions of 7 symbols in a PSFCH slot may be organized.

1) This may not be applied in ECP.

d. For example, a UE may perform PSFCH transmission and PSFCH reception on different symbols within a PSFCH slot.

2. For PSSCH slots/subchannels linked to a PSFCH slot/occasion, actual SL HARQ-ACK feedback may only be allowed for some of them.

A. Mapping according to PSFCH resource determination rules in a form where specific PSSCH slots/subchannels are excluded

B. It may be allowed for the same PSFCH resource to be mapped for a specific PSSCH slot. Here, it may be assumed that one PSSCH slot/subchannel is used at any one time point.

i. Considering that each UE schedules independently, PSFCH collisions may not be avoided.

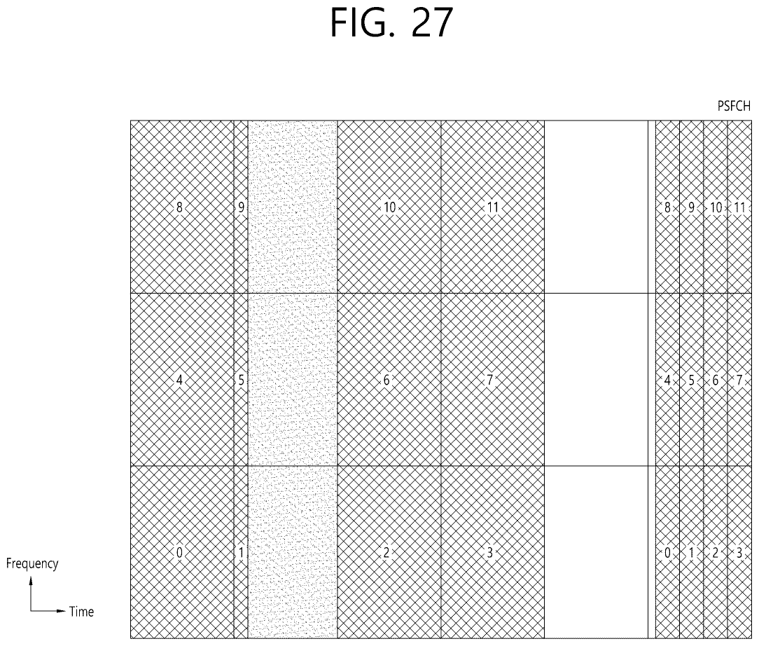

FIG. 27 is a diagram to describe a determination rule for PSFCH occasions, according to one embodiment of the present disclosure. The embodiment of FIG. 27 may be combined with various embodiments of the present disclosure.

Referring to FIG. 27, if there are many NumCsPairs, they may be served by CS. For example, if there is only one NumCsPair, the interlace structure may not be allowed. Alternatively, for example, if the NumCsPair is 1, the number of symbols for the PSFCH may be increased (e.g., 2*2+1+1=6, with a residual of 8).

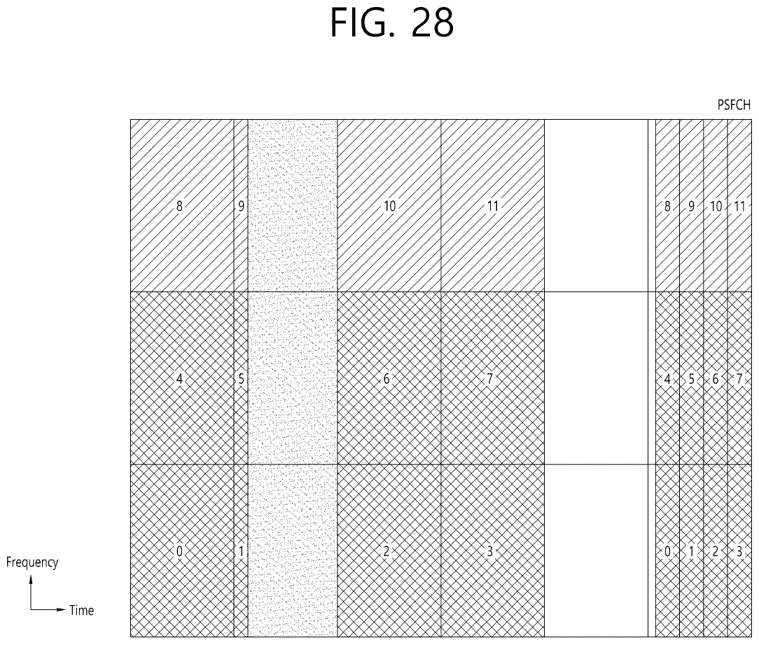

FIG. 28 is a diagram to describe a determination rule for PSFCH occasions, according to one embodiment of the present disclosure. The embodiment of FIG. 28 may be combined with various embodiments of the present disclosure.

Referring to FIG. 28, when selecting a PSFCH based on the allocated subchannels, the RB set may be considered intermediate. For example, this may be to secure more transmission occasions.

For example, one PSFCH may be selected for each RB set, as opposed to one PSFCH being selected from the PSFCH PRB subgroup corresponding to the previously allocated subchannel.

For example, even for allocated subchannels within the same RB set, each may correspond to a different RB set. In this case, PSFCH resource collisions may need to be considered.

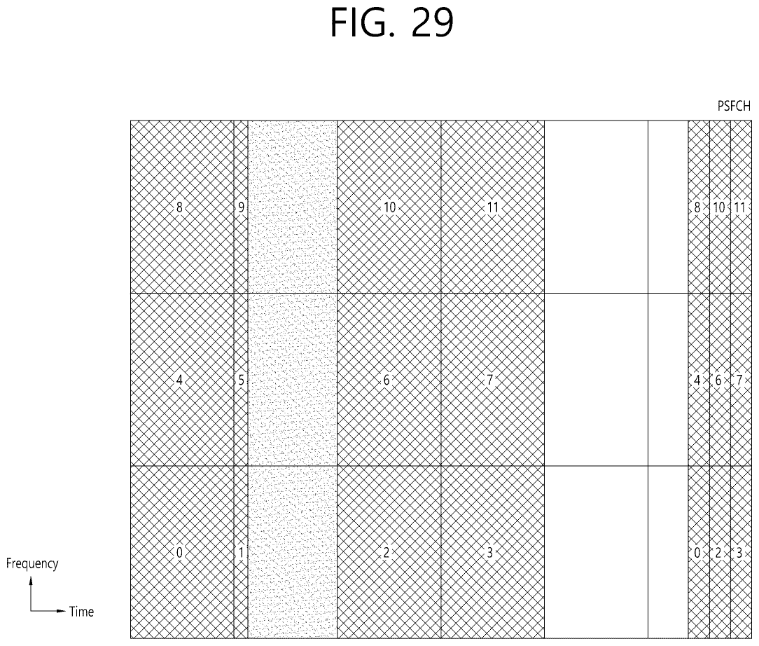

FIG. 29 is a diagram to describe a determination rule for PSFCH occasions, according to one embodiment of the present disclosure. The embodiment of FIG. 29 may be combined with various embodiments of the present disclosure.

vi. Referring to FIG. 29, an embodiment for alleviating PSFCH occasions being interrupted by an SL transmission burst is shown.

1. For example, PSSCH and PSFCH may be FDMed.

A. PRBs may not always be reserved for PSFCH.

2. For the same resource, it may be dynamically converted to either PSSCH or PSFCH use.

A. The uses of LBT may be distinguished through LBT. For example, PSSCH may precede PSFCH, or PSFCH may precede PSSCH, or the back-and-forth relationship may change.

B. By predicting in advance, based on SCI, the PSFCH resources related to the reserved resources, it is possible to ensure that PSSCH resources are avoided in Mode 2 RA. For example, this may be applied in case of additional selection of resources.

i. Based on the 2nd SCI, it may be decided whether to be AN-allowed limited or AN-allowed conservative.

III. A way to protect cases where the PDB is short, while multiple PSFCH occasions/slots are allowed in the resource pool.

1. PSFCH timing limits may be indicated via SCI. For example, the PSFCH timing limits may be indicated via PC5-RRC signaling. For example, the PSFCH timing limits may be configured per CAPC and/or SL priority.

B. Configuring RB set (subchannelization)

I. Contiguous RB-based structures

1. Structures that align to the lowest PRB of the lowest RB set

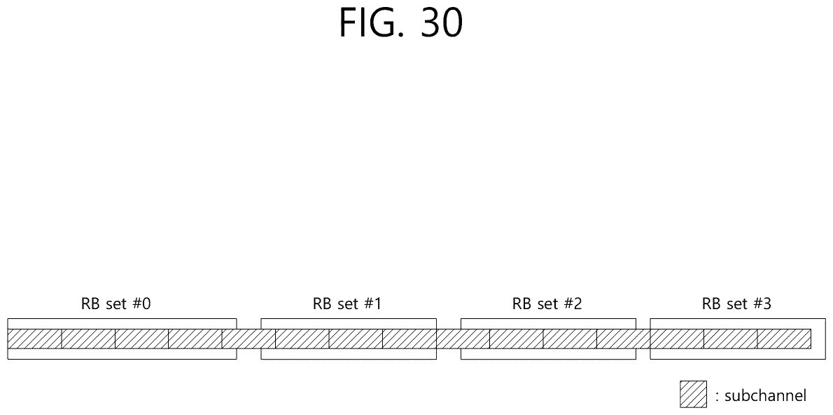

FIG. 30 shows a configuration method for an RB set, according to one embodiment of the present disclosure. The embodiment of FIG. 30 may be combined with various embodiments of the present disclosure.

a. Referring to FIG. 30, a starting RB index for the subchannel may be configured.

b. The number of subchannels may be derived according to the resource pool size.

c. The remaining PRB in the last RB set may not be used.

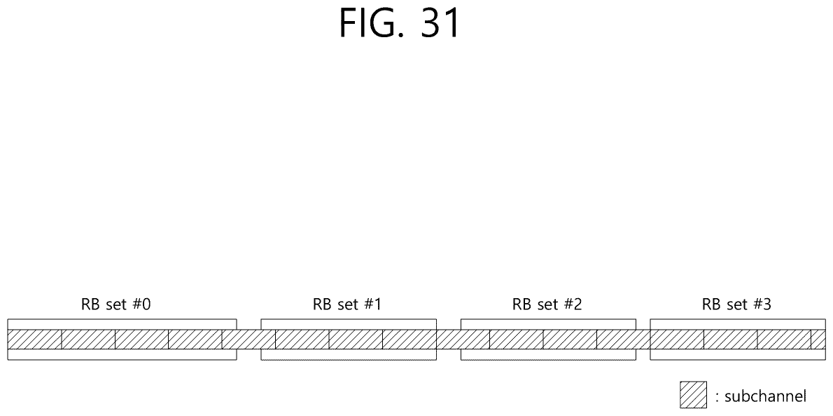

FIG. 31 shows a configuration method for an RB set, according to one embodiment of the present disclosure. The embodiment of FIG. 31 may be combined with various embodiments of the present disclosure.

A. Referring to FIG. 31, the remaining PRB of the last RB set may be allocated as a separate subchannel.

B. To ensure the same TBS indication between the initial transmission and a retransmission, the last subchannel may not be used in the TBS calculation, or may be assumed to be the same size as the other subchannels.

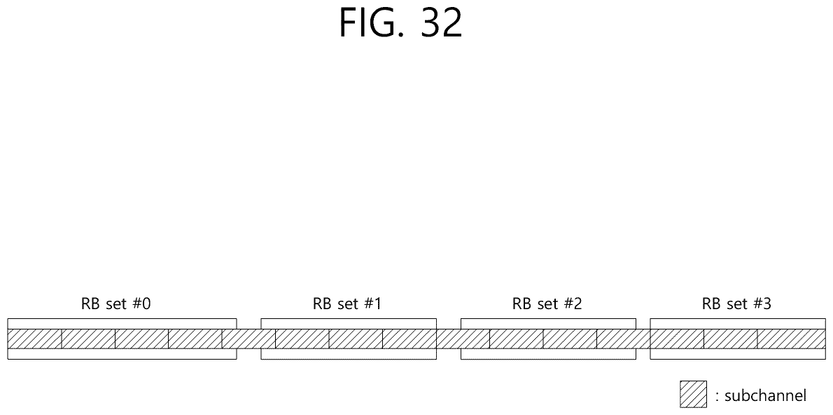

FIG. 32 shows a configuration method for an RB set, according to one embodiment of the present disclosure. The embodiment of FIG. 32 may be combined with various embodiments of the present disclosure.

A. Referring to FIG. 32, the remaining PRB of the last RB set may be merged into the last subchannel.

B. To ensure the same TBS indication between the initial transmission and retransmission, the last subchannel may not be used in the TBS calculation, or may be assumed to be the same size as the other subchannels.

2. Structure where subchannels are configured per RB set

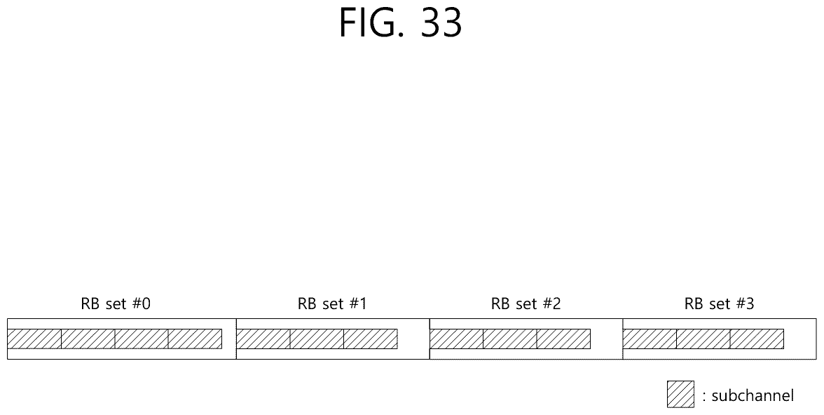

FIG. 33 shows a configuration method for an RB set, according to one embodiment of the present disclosure. The embodiment of FIG. 33 may be combined with various embodiments of the present disclosure.

a. Referring to FIG. 33, the number of subchannels that are partially truncated along the RB set boundary may be minimized.

b. Depending on the TBS calculation, the peak data rate may decrease.

i. To increase the peak data rate, a scaling factor, number of virtual subchannels, etc. may be considered. For example, the number of subchannels/PRBs may be different when calculating the TBS compared to the number of allocated subchannels.

3. CORESET pool configuration reference

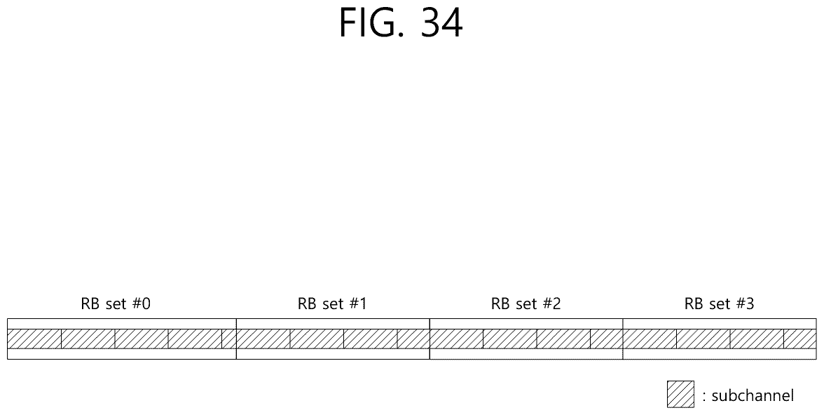

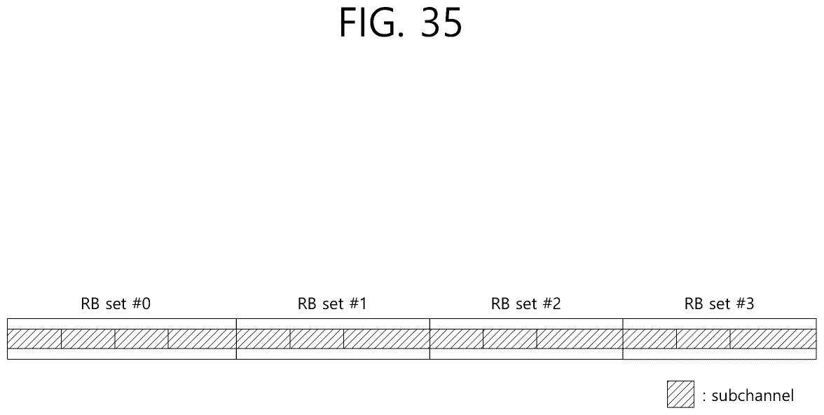

FIG. 34 and FIG. 35 show a configuration method for an RB set, according to one embodiment of the present disclosure. The embodiments of FIGS. 34 and 35 may be combined with various embodiments of the present disclosure.

a. Referring to FIG. 34 and FIG. 35, the 6 PRB unit bitmap may be configured based on RB set0 instead of CRBO.

b. The PRB offset based on the lowest PRB in RB set0 may be applied.

c. For an RB set, a bitmap may be used to configure which RB set the CORESET of RB set0 is placed in the form of a copy to which RB set.

i. CORESET size may be partially truncated in RB sets where size matching is not possible.

II. interlace RB-based structure

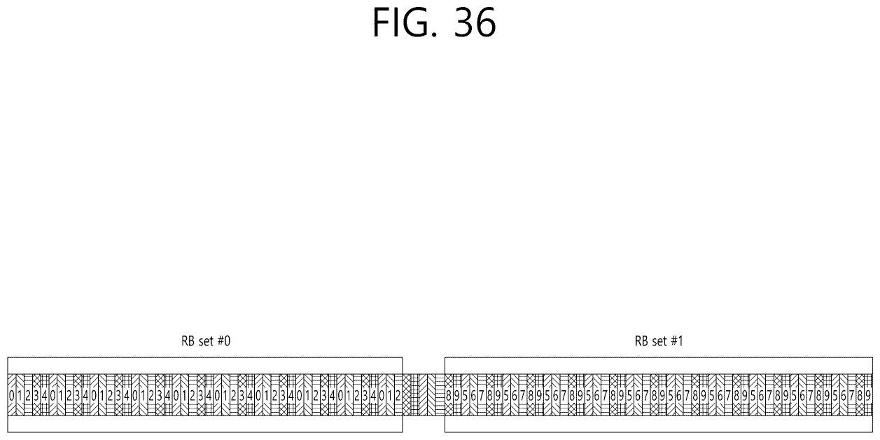

FIG. 36 shows an interlace RB-based RB set structure, according to one embodiment of the present disclosure. The embodiment of FIG. 36 may be combined with various embodiments of the present disclosure.

1. Referring to FIG. 36, when using a small number of interlaces, it may be difficult to keep the interlaces the same for multiple RB sets. For example, when more than one RB set is used, all interlaces may need to be used.

2. A method of filling the guard may be considered in the 0, 1, 2, 3, 4, and 5 usage situations.

a. The guard may be filled on the interlace intersection/union, on all parts, or not filled (null), or on the preceding/following parts of the interlace.

b. In Mode 2 RA, power maximization may be considered for the combination of RB sets depending on the number of interlaces, and the operation may be performed by the UE implementation or the related configuration may be (pre-)configured.

3. For a single RB set transmission, all resources in the RB set may be used for the transmission.

4. At 30 kHz, the number of interlaces is 5, so subchannelization may not guarantee the presence of the same number of interlaces as subchannels. For example, the above problem may be solved by allowing K>1 only at 15 kHz.

a. 2/3, 3/2, 2/2/1, 2/1 (unused or used)/2 structure

i. For example, which subchannel includes two interlaces, which subchannel includes three interlaces, and which subchannel includes one interlace may be set so that the difference in RB count is as small as possible, based on the number of RBs in the interlace configuration.

ii. For example, the TBS may be determined based on a large, small, or average value.

b. Subchannels may be configured across the RB set.

c. The same combination or the same PRB may be maintained between initial transmission and retransmission ((re)transmission of the same TB).

i. The number of subchannels allocated may differ from the number of subchannels actually used for transmission. For example, some subchannels may be discarded based on rules.

5. At 15 kHz, the number of interlaces is 10, and when configuring subchannels, the number of interlaces per subchannel may be 1, 2, or 5.

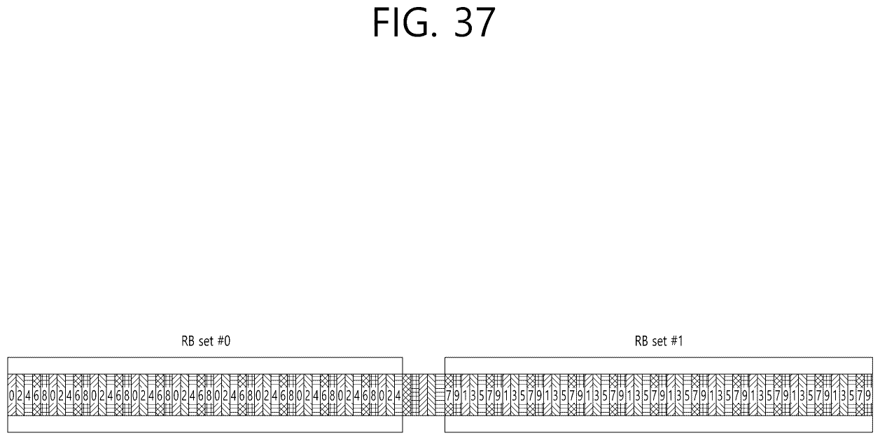

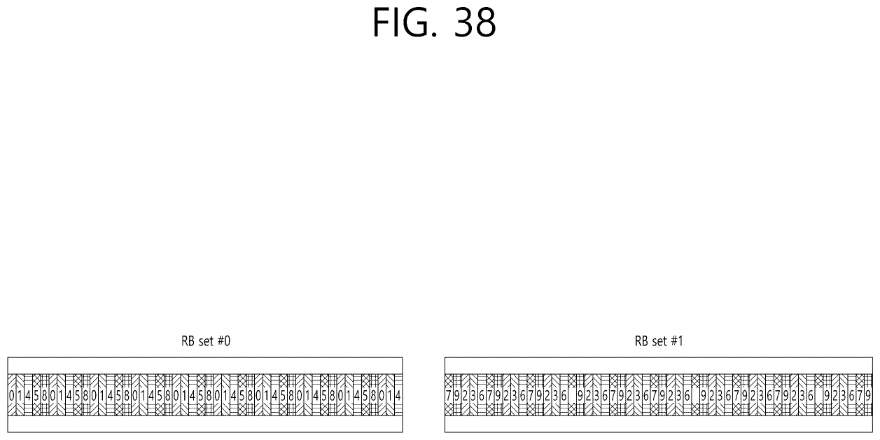

FIG. 37 and FIG. 38 show an interlace RB-based RB set structure, according to one embodiment of the present disclosure. The embodiments of FIG. 37 and FIG. 38 may be combined with various embodiments of the present disclosure.

a. Referring to FIG. 37 and FIG. 38, the non-contiguous interlace/subchannel configuration may be different for the subchannel size K.

b. When changing mappings via dynamic indication, it may also be indicated per reserved resource. Alternatively, the non-contiguous interlace/subchannel configuration may be limited to remain the same to indicate a different RB set.

6. A method for boosting the power of a specific PRB based on a power constraint within 1 MHz.

a. The PRB interval may be set to 12 based on 15 kHz and 6 based on 30 kHz. Alternatively, the PRB interval may be (pre-)configured per resource (pool).

i. It may be configured whether the above embodiment is applied for S-SSB only.

b. For example, in applying the above embodiment, LAA. DFT-S-OFDM constraints, OCB requirements, tearing, NR-U coexistence, etc. may be considered.

In the following, single RB set transmission without GB and transmission based on multiple RB sets including GB are described.

For example, due to LBT instability of a UE, a GB may be excluded in the transmission of a single RB set and included in the transmission of multiple RB sets. In the latter case, it may be assumed that the UE transmits all interlaces within the multiple RB sets. Alternatively, for example, it may be assumed that some (but not all) interlaces within the multiple RB sets are transmitted.

For example, there may be no interference to other UEs due to GB transmissions because one UE is transmitting all resources in multiple RB sets. Alternatively, for example, there may be interference to other UEs due to GB transmissions, even if it is a multiple RB sets transmission (considering some interlace transmissions). In the latter case, for example, the GB transmission may be omitted.

For example, when a UE performs a multiple RB set (e.g., two RB sets) based transmission, GB may be used even if the UE uses all RBs in RB set 1 and some or all RBs in RB set 2. This case may be different from the situation where a UE successfully LBTs over multiple RB sets but ultimately performs a single RB set based transmission, i.e., for example, due to the UE's actual transmission on RB set 2, it may be difficult for other UEs to use RB set 2, and therefore the additional use of GB may not be a significant issue.

For example, a UE may use only some RBs in both RB sets for PSD gain. For example, in this case, other UEs may perform single-RB set or multi-RB set transmissions based on the remaining RBs in RB set 1/2.

For example, if the LBTs for both RB set 0 and RB set 1 are successful, and the transmission is performed based on RB set 0 only (without transmitting RB set 1), a GB transmission may be performed. For example, here, there might be no problem with a GB transmission because the LBTs all succeeded. For example, here, whether or not a GB is transmitted may be signaled.

For example, if a UE is successful in both RB set 1/2, 1) it may be desirable not to transmit GB due to LBT instability (to reduce the impact of interference due to GB transmission) if transmission is performed based on RB set 1 only. 2) If the transmission is performed based on both RB set 1/2, GB transmission may be possible since the effect of LBT instability (due to GB transmission) is only on that UE.

In this case, for example, for case 2), the positive/negative impact of the GB transmission may be different depending on whether (1) the UE performs the transmission through all RBs in RB set 1/2 or (2) only some RBs are transmitted (the rest of the RBs may be transmitted by other UEs).

For example, from the UE's point of view, there may be a situation where both RB sets have successfully LBTed, but there is instability in the substrate, so that the channel may not actually be idle for both RB sets. Therefore, for example, even if both RB sets are successful in LBT, the UE may not perform a GB transmission to eliminate the impact of the above unstable LBT if the UE performs the transmission over only one RB set. Alternatively, for example, if the transmission is performed over all RBs belonging to both RB sets, the impact of the above unstable LBT only affects that UE, so GB transmission may have no impact.

For example, if the transmission is performed through only some RBs in a set of two RBs, other UEs may also perform the transmission through the remaining RBs, and the UE may not perform the GB transmission due to the impact on those other UEs.

Channel access mechanism for SL-U

A. Type 1 channel access procedure

TABLE 34
Agreement
Type 1 and Type 2 (2A/2B/2C) channel access procedures, transmission gap and LBT
sensing idle time requirements specified in TS37.213 for NR-U are taken as baseline for
NR sidelink operation in a shared channel.

| • | FFS conditions for the actual channel access type(s) used for each SL channel | |
|---|---|---|
| | and signal transmitted, and based on COT sharing conditions (if supported) | |
| • | FFS whether UL CAPC or DL CAPC or both should be used as the baseline, | |
| | ∘ | FFS how the channel access priority classes apply to each SL channel and |
| | | signal |
| | ∘ | FFS sidelink priority levels (PQI or L1 priority), channel and signal |
| | | mapping to the 4 channel access priority classes. The discussion may |
| | | involve other WGs. |

I. Proposal: For Type 1 SL channel access procedure

1. If a TX UE has only PSCCH/PSSCH transmission(s) with SL HARQ-ACK feedback disabled during reference duration, contention window size for every CAPC may be kept constant.

a. Reference duration of UL channel access may be reused by replacing PUSCH with PSSCH.

II. Proposal: For Type 1 SL channel access procedure

1. If a TX UE receives at least one ACK from RX UEs in response of groupcast PSSCH transmission(s) with SL HARQ-ACK feedback Option 2 during reference duration, contention window size for every CAPC may be set to the minimum allowable value.

III. Proposal: For Type 1 SL channel access procedure,

1. If a TX UE receives at least one ACK from RX UE(s) in response of unicast PSSCH transmission(s) with SL HARQ-ACK feedback enabled during reference duration, contention window size for every CAPC may be set to the minimum allowable value.

IV. Proposal: For Type 1 SL channel access procedure,

1. For groupcast PSSCH with SL HARQ-ACK feedback Option 1, down-select one of followings:

a. Alt 1: If a TX UE does not receive ACK from RX UE(s) in response of PSSCH transmission(s), and if the TX UE receives NACK in response of groupcast PSSCH transmission(s) with SL HARQ-ACK feedback Option 1, contention window size for every CAPC may be set to the next allowable value.

b. Alt 2: RX UE may transmit ACK in response of groupcast PSSCH with SL HARQ-ACK feedback Option 1. If a TX UE receives at least one ACK from RX UE(s) in response of the PSSCH transmission(s) during reference duration, contention window size for every CAPC may be set to the minimum allowable value.

i. there may be no specification change on HARQ procedure for new ACK signaling.

B. Type 2 channel access procedure

TABLE 35
Agreement

| • | UE-to-UE COT sharing is supported in NR sidelink operation in a shared | |
|---|---|---|
| | channel (SL-U). | |
| | ∘ | FFS applicable SL channels and signals (e.g., PSCCH/PSSCH, PSFCH, |
| | | S-SSB) for shared COT access and any restrictions (e.g. whether the COT |
| | | may be shared with a single UE or multiple UEs) |
| | ∘ | FFS all other details in compliance with the regulatory requirements |
| • | CP extension (CPE) is supported for NR sidelink operation in a shared channel. | |
| | ∘ | FFS all remaining details including applicable scenarios, usage, PHY |
| | | structure, etc. |

I. UE-to-UE COT sharing

1. Observation: For COT sharing, UE initiating the COT may need to occupy the channel until UE(s) sharing the same COT transmits SL channel(s) to avoid another RAT of TX node intercept the channel.

2. Observation: TX UE may know when RX UE will transmit PSFCH in response of TX UE's PSSCH transmission if Rel-16 PSSCH-to-PSFCH timing is reused. Otherwise, TX UE may not know when RX UE will actually transmit PSFCH. In this case, the TX UE may not occupy the channel sufficiently for COT sharing.

3. Observation: TX UE may not know when another UE will transmit PSCCH/PSSCH or S-SSB. In this case, the TX UE may not occupy the channel sufficiently for COT sharing.

4. Proposal: For PSFCH transmission,

a. If a UE receives SCI (e.g., 2nd SCI) indicating Type 2 channel access for PSFCH transmission from another UE transmitting the PSSCH, and

b. If the UE transmits the PSFCH on PSFCH resource determined by Rel-16 PSSCH-to-PSFCH timing in response of the received PSSCH,

i. UE may access channel at least for the PSFCH transmission in response of PSSCH transmission according to Type 2 channel access procedure.

ii. FFS: Whether/how to specify that UE transmitting the PSSCH occupies the channel until the corresponding PSFCH occasion.

5. Proposal: For PSCCH/PSSCH transmission,

a. If a UE receives SCI (e.g., 2nd SCI) indicating the starting time and/or the ending time of the shared COT duration, and

b. If the UE transmits the PSCCH/PSSCH on the starting time of the shared COT duration to the UE indicating the shared COT information,

i. UE may access channel at least for PSCCH/PSSCH transmission according to Type 2 channel access procedure.

ii. FFS: for whether/how to specify that UE indicating the shared COT information occupies the channel until the UE receiving the shared COT information transmits the PSCCH/PSSCH.

iii. FFS: for cast type of PSCCH/PSSCH indicating the shared COT information.

iv. FFS: PSCCH/PSSCH cast type of the responding UE.

6. Observation: Considering FDM with SL transmission burst, it would be necessary to support Type 2 channel access procedure for PSCCH/PSSCH transmission. Otherwise, during the SL transmission burst of a UE, another UE cannot use FDMed resources in the same RB set.

7. Observation 1: For semi-static COT sharing, one or more of following scenarios could be considered:

a. Scenario 1: The absence of any other technology sharing the channel may be guaranteed on a long term basis (e.g. by level of regulation).

b. Scenario 2: The absence of certain link(s) sharing the channel may be guaranteed on a long term basis.

c. Scenario 3: The absence of UE with SL Mode 2 resource (re)selection procedure sharing the channel may be guaranteed on a long term basis.

8. Proposal 6: For semi-static COT sharing, it may be necessary to investigate how to set FFP (fixed frame period) and what is the granularity of configuration for FFP.

### II. Contiguous SL Transmissions

1. Proposal: UE may transmit transmission(s) after a gap within a SL transmission burst without sensing the corresponding channel(s) for availability.

a. SL transmission burst may be defined as a set of transmissions from a UE without any gaps greater than 16 us.

i. CP extension or rate-matching may be used to ensure the time gap requirement between transmissions in a SL transmission burst.

b. Transmissions from a UE separated by a gap of more than 16ps may be considered as separate SL transmission bursts.

c. FFS: for whether the destination of transmissions within a SL transmission burst may be different or not.

d. FFS: for whether TBs of transmissions within a SL transmission burst may be different or not.

e. FFS: for whether CAPC values of transmissions within a SL transmission burst may be different or not.

2. Proposal: For contiguous SL transmission(s),

a. When UE accesses channel according to Type 1 channel access procedure, CAPC value may be selected by one of following options:

i. Option 1: The highest CAPC values of transmissions within the SL transmission burst may vary subject to processing time budget.

ii. Option 2: it may be a CAPC value of the earliest transmission within the SL transmission burst.

b. FFS: Whether/how UE may transmit transmission(s) with higher CAPC value than the CAPC value used for channel access.

3. Proposal: For SL transmission burst,

a. Channel access procedure(s) of UL transmission burst in NR-U may be reused.

C. Short control signaling

I. Check if the duty cycle is satisfied. (S-SSB, PSFCH)

1. Limit 1: within an observation period of 50 ms, the number of Short Control Signalling Transmissions by the equipment shall be equal to or less than 50;

2. Limit 2: the total duration of the equipment's Short Control Signalling Transmissions shall be less than 2 500 ps within the observation period

### 3. S-SSB

a. Observation: In the perspective of a UE, the maximum number of S-SSBs within 160 msec period to meet the requirements for the short control signaling may be given by as follows,

i. 6 for 15 kHz SCS

ii. 16 for 30 kHz SCS

iii. 32 for 60 kHz SCS

iv. it may be assumed that the time locations of S-SSB is equally distributed over the period.

b. Observation: In the perspective of SL system, the maximum number of S-SSBs within 160 msec period for a single S-SSB time allocation (e.g., sl-SSB-TimeAllocatoin1, sl-SSB-TimeAllocatoin2, sl-SSB-TimeAllocatoin3) to meet the requirements for the short control signaling may be given by as follows,

i. 2 for 15 kHz SCS

ii. 5 or 6 for 30 kHz SCS

iii. 10 or 11 for 60 kHz SCS

c. Observation: In the perspective of a UE, the maximum number of S-SSBs within 160 msec period to meet the condition for using Type 2 channel access procedure as in NR-U DL may be given by as follows,

i. 8 for 15 kHz SCS

ii. 16 for 30 kHz SCS

iii. 32 for 60 kHz SCS

d. Observation: In the perspective of SL system, the maximum number of S-SSBs within 160 msec period for a single S-SSB time allocation (e.g., sl-SSB-TimeAllocatoinl, sl-SSB-TimeAllocatoin2, sl-SSB-TimeAllocatoin3) to meet the condition for using Type 2 channel access procedure as in NR-U DL may be given by as follows,

i. 2 or 3 for 15 kHz SCS

ii. 5 or 6 for 30 kHz SCS

iii. 10 or 11 for 60 kHz SCS

### 4. PSFCH

a. Observation: In the perspective of a UE, to meet the requirements for the short control signaling,

i. a UE may transmit PSFCHs on at most 17 PSFCH occasions every 50 msec for 15 kHz SCS

ii. a UE may transmit PSFCHs on at most 35 PSFCH occasions every 50 msec for 30 kHz SCS

iii. a UE may transmit PSFCHs on at most 50 PSFCH occasions every 50 msec for 60 kHz SCS

b. Observation: In the perspective of SL system, the PSFCH resource period to meet the requirements for the short control signaling is 4 for 15 kHz, 30 kHz, and 60 kHz SCS.

D. Aspects of Mode 2 resource selection procedure

I. Observation: UE may know CAPC or the necessity of channel access after the UE triggers SL resource (re)selection procedure.

II. Proposal: UE may attempt to access channel after the resource (re)selection procedure is triggered at the UE side.

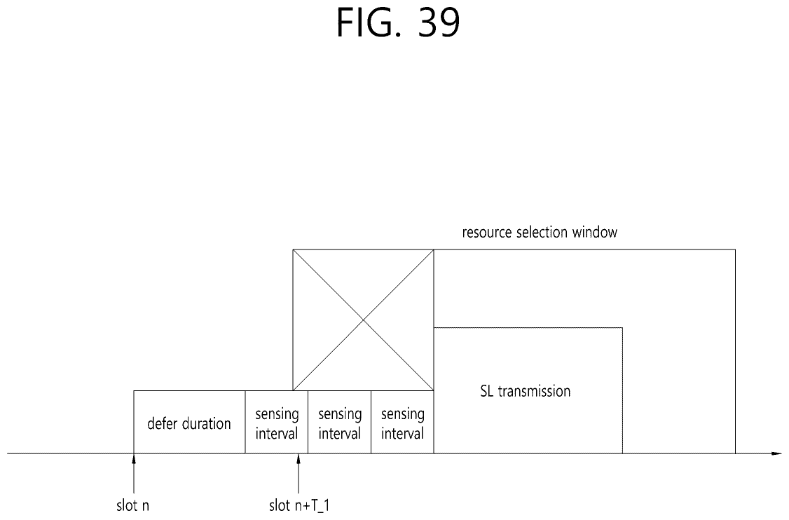

FIG. 39 shows a sense duration and a defer duration related to an SL transmission resource, according to one embodiment of the present disclosure. The embodiment of FIG. 39 may be combined with various embodiments of the present disclosure.

III. Observation: Referring to FIG. 39, considering that the channel sensing duration may be larger than T_proc,1, if the first time location of available SL resources close to the starting time of the resource selection window, the UE may not have enough time to complete the Type 1 channel access procedure.

IV. Proposal: For the case when UE determines that there is no sufficient time to complete channel access procedure before the SL transmission(s), down-select one or more of followings:

1. Option 1: Drop the SL transmission and attempt to next transmission on the reserved resources.

2. Option 2: Reselect the resources for the SL transmission.

3. Option 3: First time location of available SL resources is determined considering the channel sensing duration further.

V. Proposal: For Mode 2 SL resource (re)selection procedure, UE may select transmission resources so that the time gap between any two transmission resources covers channel sensing duration.

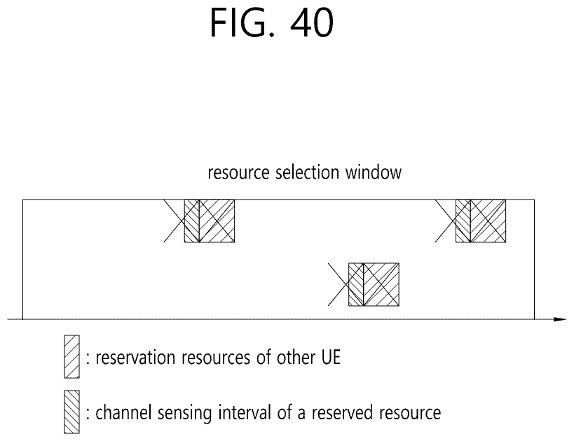

FIG. 40 shows a transmission resource that is excluded from a resource selection procedure, according to one embodiment of the present disclosure. The embodiment of FIG. 40 may be combined with various embodiments of the present disclosure.

VI. Proposal: Referring to FIG. 40, for Mode 2 SL resource (re)selection procedure, UE may further exclude resources associated with channel sensing interval of other UE's reserved resources.

VII. Proposal: For the case when a resource pool consists of more than one RB sets,

1. whether or how to consider RB set(s) for Mode 2 resource (re)selection procedure is described in RANI.

a. e.g., for a given number of sub-channels, smaller number of RB set(s) may be prioritized for PSSCH transmission resources.

b. e.g., before selecting transmission resources, UE may selects RB set(s) for PSSCH transmission.

VIII. Other in-text mentions

1. The amount of candidate resources may increase as the number of LBT failure increases.

2. Whether or how to consider COT duration

a. Whether or how to consider COT duration that is available for SL transmission

b. Whether or how to exclude resources within COT duration that is not available for SL transmission

3. Option B: UE may perform channel access procedure first then performs SL resource reselection procedure

E. Aspects of Mode 1 resource allocation procedure

I. Whether/how to report COT initialized by a UE to gNB

1. Observation: To support that gNB provide COT initiated by a UE to another UE, it may be necessary to check the feasibility on the double COT sharing issue, processing time budget for exchanging COT information, and specification work load on supporting new UCI or reporting type on UL.

2. Proposal: In Rel-17, double COT sharing (i.e., gNB indicates COT initiated by UE to another UE) may be not supported.

II. Whether/how to report LBT failure

1. Observation: gNB may need to know LBT failure ratio for each RB set to decide how to allocate RB set(s) for SL transmission to UE.

2. Proposal 3: For SL Mode 1 operation on unlicensed spectrum, down-select one of followings:

a. Option 1: For LBT failure, a UE may report NACK to gNB.

b. Option 2: A UE may report LBT failure status separately from SL HARQ-ACK status to gNB.

Physical layer structure framework for SL-U

A. SL BWP and resource pool configuration

TABLE 36
Agreement
SL BWP, SL resource pool in R16/R17 NR SL and RB set in R16 NR-U are reused for
SL-U as baseline

| | |
|---|---|
| • | Only one SL BWP is (pre-)configured within a carrier |
| • | The SL BWP is (pre-)configured to include one or multiple SL resource |
| | pools |
| • | At least support that one SL resource pool can be (pre-)configured to |
| | include integer number of RB sets |
| ∘ | FFS: whether/how to support one SL resource pool can include sub-set of |
| | PRBs of one RB set |
| ∘ | FFS: the applicable resource pool |
| ∘ | FFS: the impact on sub-channel size and number of sub-channels in a |
| | resource pool if sub-channel is supported |
| • | PRBs within intra-cell guard band of two adjacent RB sets belong to a |
| | resource pool if the resource pool includes the two adjacent RB sets |
| ∘ | FFS details, e.g., how such PRBs are used, the applicable resource pool, |
| | etc. |
| • | FFS: whether R16/R17 NR SL S-SSB slots and/or new S-SSB slots (if |
| | supported) are excluded from resource pool |
| • | FFS: which slots belong to resource pool, e.g., how to set the value of |
| | bitmap, whether to consider SL-U/NR-U operating in the same carrier and |
| | whether TDD configuration are considered, etc. |
| • | FFS: the impact of PSCCH/PSSCH mapping to frequency resources on |
| | resource pool configuration, on sub-channel definition if sub-channel is |
| | supported, etc. |

L. Proposal: For SL BWP configuration on shared spectrum,

1. Starting PRB of SL BWP may be aligned with the lowest PRB of the lowest RB set within SL BWP

2. Ending PRB of SL BWP may be aligned with the highest PRB of the highest RB set within SL BWP

II. Observation: If coexistence between contiguous RB-based transmission and interlaced RB-based transmission is not allowed in a SL BWP, a UE without interlaced RB-based TX capability would not perform SL transmission on the SL BWP or SL carrier.

III. Proposal: For SL resource pool configuration in frequency domain on shared spectrum,

1. Starting PRB (i.e., sl-StartRB-Subchannel) may be aligned with the lowest PRB of the lowest RB set within the resource pool

2. The number of PRBs (i.e., sl-RB-Number) may be set so that the ending PRB is aligned with the highest PRB of the highest RB set within the resource pool

3. Either contiguous RB-based transmission or interlaced RB-based transmission may be (pre)configured at least for PSCCH, PSSCH, and PSFCH transmission.

a. FFS: for whether or not to apply interlaced RB-based transmission to S-SSB transmission

IV. Proposal 1: For SL communication on shared spectrum, a resource pool excludes following slots:

1. Slots whose symbols from sl-StartSymbol to sl-StartSymbol+sl-LengthSymbols-1 may be not cell-specific UL

2. S-SSB slots

3. Reserved slot as specified in section 8 of TS 38.214

B. Contiguous RB-based transmission

TABLE 37
Agreement

For PSCCH and PSSCH in SL-U:

| ● | Both R16/R17 NR SL contiguous RB-based and R16 NR-U interlace RB-based | |
|---|---|---|
| | transmissions are considered as starting point | |
| | ◯ | RAN1 strives to have unified design for both contiguous RB-based and |
| | | interlace RB-based transmissions |
| | ◯ | FFS: whether/how to address IBE (In Band Emission) impact |

I. Observation: If sub-channels are not aligned with RB sets in boundaries, resources would not be fully utilized especially when small number of RB set(s) are allocated for PSCCH/PSSCH transmission.

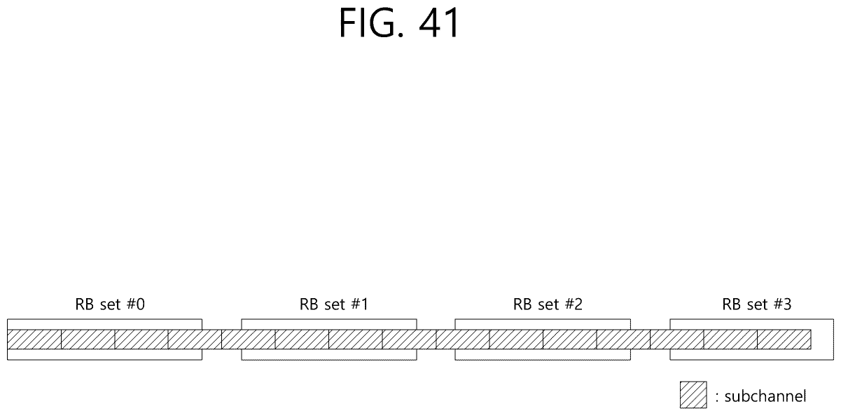

FIG. 41 shows an RB set for transmission based on contiguous RBs, according to one embodiment of the present disclosure. The embodiment of FIG. 41 may be combined with various embodiments of the present disclosure.

II. Proposal: Referring to FIG. 41, for contiguous RB-based transmission,

1. Sub-channels may be defined to be aligned with RB set(s) in boundaries.

2. PRBs between sub-channels belonging to different RB sets may be used automatically for PSCCH/PSSCH transmission when the sub-channels belonging to different RB sets are used for the PSCCH/PSSCH transmission.

a. PRBs not belonging to a sub-channel may be not counted for TBS determination.

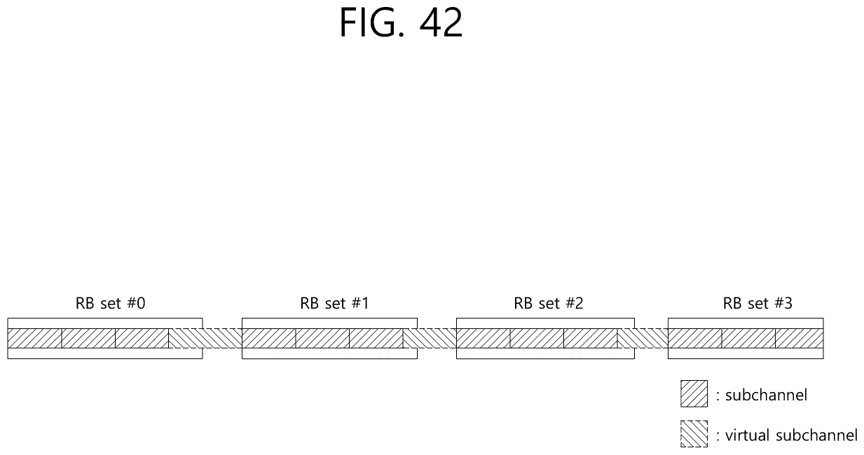

FIG. 42 shows an RB set for transmission based on contiguous RBs, according to one embodiment of the present disclosure. The embodiment of FIG. 42 may be combined with various embodiments of the present disclosure.

Referring to FIG. 42, contiguous RB sets and virtual subchannels are shown. For example, a subchannel that includes a frequency discontinuity between RB sets may be a virtual subchannel. For example, the subchannels may be frequency contiguous, including the virtual subchannels.

C. Interlaced RB-based transmission

TABLE 38
Agreement

For PSCCH and PSSCH in SL-U:

| ● | For interlace RB-based transmission (if supported), at least the following | |
|---|---|---|
| | candidates can be discussed: | |
| | ◯ | Frequency domain resource allocation granularity is one sub-channel for |
| | | PSSCH transmission |
| | | ▪ FFS: Other resource allocation granularity, e.g., RB-level |
| | ◯ | 1 sub-channel equals K interlaces if sub-channel is supported |
| | | ▪ FFS details |
| | ◯ | Other candidates are not precluded |
| | ◯ | FFS: mapping of PSCCH to frequency resources |
| | ◯ | FFS: resource indication in time/frequency domain, e.g., how to handle |
| | | using one RB set or multiple RB sets, etc. |

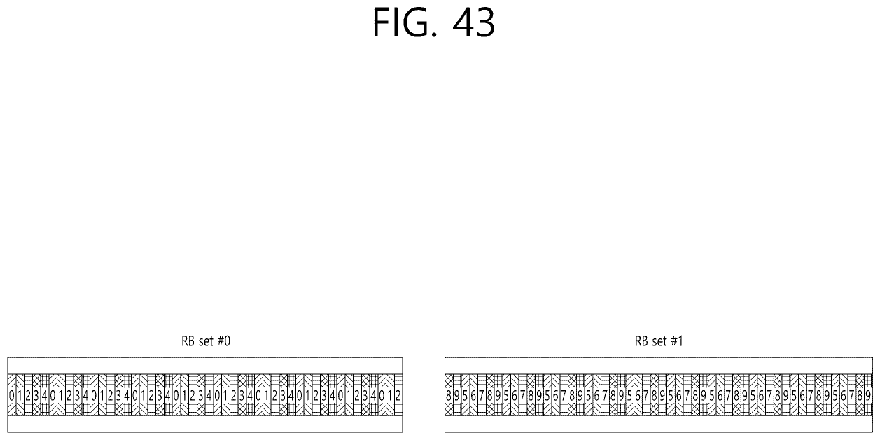

FIG. 43 shows a problem that may occur in an interlace-based RB set, according to one embodiment of the present disclosure. The embodiment of FIG. 43 may be combined with various embodiments of the present disclosure.

I. Observation: Referring to FIG. 43, if a subchannel consists of PRBs corresponding to an interlace index within a RB set, and if the subchannel indexing may be done in increasing order of first the interlace index, and then the RB set index, and if more than one RB sets are scheduled for PSSCH transmission, the same set of interlaces across different RB sets would not be guaranteed. It may cause high PAPR.

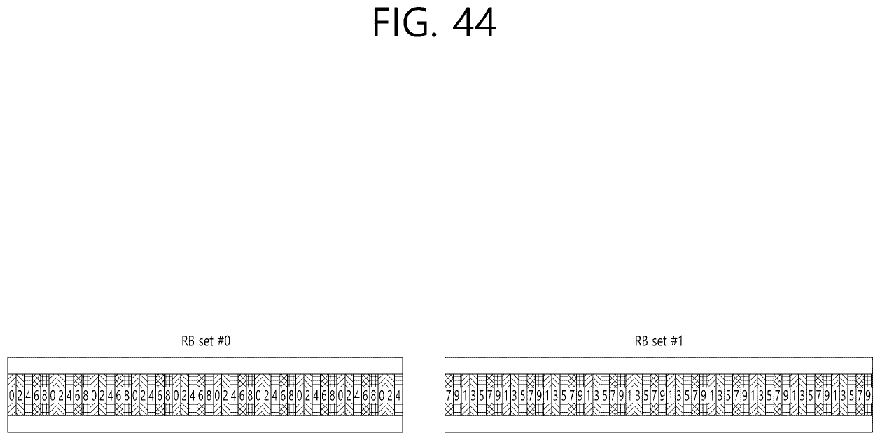

FIG. 44 shows a problem that may occur in an interlace-based RB set, according to one embodiment of the present disclosure. The embodiment of FIG. 44 may be combined with various embodiments of the present disclosure.

II. Observation: Referring to FIG. 44, if a subchannel consists of PRBs corresponding to an interlace index within a RB set, and if the subchannel indexing is done in increasing order of first the RB set index, and then the interlace index, and if more than one interlaces are scheduled for PSSCH transmission, it may need to use multiple RB sets for PSSCH transmission. In this case, the UE needs to access both RB sets for PSSCH transmission.

III. Observation: Due to PSD requirement (i.e., lOdBm/MHz), depending on the number of interlaces, it would be useful using multiple RB sets rather than using single RB set for PSSCH transmission for the same number of PRBs or interlaces.

IV. Observation: For 30 kHz SCS, since the number of interlaces is 5, the number of interlaces belonging to a subchannel may be different.

V. Observation: If contiguous sub-channel allocation mechanism is reused for interlaced RB-based PSSCH transmission, depending on the sub-channelization method, the resource allocation could be inefficient in terms of channel accessibility, PAPR, and/or TX power restriction.

VI. Proposal: For interlaced RB based PSSCH transmission, one of followings may be supported:

### 1. Option 1:

a. A subchannel may consist of PRBs belonging to K interlaces within a RB set.

i. Subchannel indexing may be done in increasing order of first the interlace index, and then the RB set index.

ii. K may be at least 1.

b. SCI may indicate FRIV for subchannel allocation.

c. PSSCH transmission resource(s) may be determined by the indicated sub-channel(s)

d. When more than one RB sets are used, UE may expect that the same set of interlaces are used.

### 2. Option 2:

a. A subchannel may consist of PRBs belonging to K interlaces within a RB set.

i. Subchannel indexing may be done in increasing order of first the RB set index, and then the interlace index.

ii. K may be at least 1.

b. SCI may indicate FRIV for subchannel allocation.

c. PSSCH transmission resource(s) may be determined by the indicated sub-channel(s)

3. Option 3: (into main chapter)

a. A subchannel may consist of PRBs belonging to K interlaces within a RB set.

i. Subchannel indexing may be done

(1) in increasing order of first the interlace index, and then the RB set index, or

(2) 2. in increasing order of first the RB set index, and then the interlace index

ii. K may be at least 1.

b. SCI may indicate sub-channel indexing mechanism and FRIV for subchannel allocation.

c. PSSCH transmission resource(s) may be determined by the indicated sub-channel(s)

4. Option 4:

a. A subchannel may consist of PRBs belonging to K interlaces.

i. K may be at least 1.

b. SCI may indicate FRIV for subchannel allocation and FRIV for RB set allocation.

c. PSSCH transmission resource(s) may be determined by the intersection of indicated sub-channel(s) and indicated RB set(s).

VII. Proposal: PSCCH may be mapped on the lowest subchannel within the lowest RB set allocated for PSSCH transmission.

D. Time domain resource assignment for PSCCH/PSSCH on shared spectrum

TABLE 39
Agreement

For slot structure in SL-U:

| ● | At least R16/R17 NR SL slot-based PSCCH/PSSCH transmission is supported | |
|---|---|---|
| | ◯ | FFS: whether/how to support additional starting symbol(s) within a slot |
| | | for the PSCCH/PSSCH transmission |

I. Additional starting symbol(s) within a slot

1. Observation: For sub-slot-based PSCCH/PSSCH transmission, if two PSSCH transmissions with 7-symbol duration including AGC symbol and TX-RX switching period are allowed in a slot (for normal CP case), PSFCH resource(s) cannot be allocated since there is no PSSCH DMRS pattern for 4-symbol duration.

2. Observation: It may be necessary to carefully investigate the feasibility on that UE prepares and performs the next PSSCH transmission with the next starting symbol after UE decide LBT failure for the 1st starting symbol in terms of processing time budget and UE complexity. Moreover, it is necessary to ensure the same TBS among PSSCH transmission(s) with different starting symbol(s).

3. Observation: If additional starting symbol(s) within a slot for slot-based PSCCH/PSSCH transmission is allowed, the PSSCH RX UE needs to perform AGC procedure for each starting symbol, and it will cause throughput degradation.

### II. SL TX Burst Structure

1. Proposal: For SL transmission burst, time gap between adjacent PSCCH/PSSCH transmissions may be not greater than 16usec.

a. Down-select one of followings:

i. Alt 1: Extended CP of the later SL transmission may occupy part of TX-RX switching symbol of the earlier SL transmission.

ii. Alt 2: Parts of a SL transmission may occupy part of TX-RX switching symbol of the SL transmission.

3. Proposal: For SL transmission burst, down-select one or more of followings:

b. Option 1: Maximum size of SL transmission burst may be determined by PSFCH resource period.

c. Option 2: PSSCH TX UE may transmit any signal in a PSFCH occasion to ensure the time gaps between transmissions within a SL transmission burst is no greater than 16usec.

### E. SL HARQ Procedure

TABLE 40
Agreement

For PSFCH and SL-HARQ in SL-U:

| | |
|---|---|
| ● | At least R16 NR SL PSFCH format 0 is supported |
| | ◯ FFS whether to introduce new PSFCH format |
| ● | FFS: how to meet OCB and PSD requirement for PSFCH transmission, e.g., |
| | using interlaced RB transmission, whether/how to avoid too small PSFCH |
| | capacity, etc. |
| ● | FFS: the locations of PSFCH resources, e.g., (pre-)configured, dynamically |
| | indicated, etc. |
| ● | FFS: whether/how to address PSFCH transmission dropping due to LBT failure, |
| | e.g., whether to have multiple PSFCH occasions for a PSSCH and the related |
| | PSSCH-PSFCH mapping relationship, impact on SL HARQ-ACK reporting to |
| | the gNB for Mode 1, etc. |
| ● | FFS: whether/how to address PSFCH and related PSSCH in different COTs |

I. Observation: Since PSSCH TX UE may receive a number of SL HARQ-ACK feedbacks from different PSSCH RX UEs, R16 NR SL PSFCH format 0 may be sufficient for the container of the SL HARQ-ACK feedback.

II. Observation: If the locations of PSFCH resources are dynamically indicated, UE needs to perform sensing operation for PSFCH further. Otherwise, even though PSSCH resource collision does not occur, PSFCH resources may be collided.

III. Observation: If UE may share COT initiated by UE transmitting PSCCH/PSSCH for PSFCH in response of the PSCCH/PSSCH, the PSFCH TX dropping problem due to LBT failure would be mitigated.

IV. Proposal: If UE fails to access channel for PSFCH transmission, then UE may perform deprioritized PSFCH reception(s) instead.

V. Proposal: If UE tries to access channel for each PSFCH transmission, and if UE fails to access channel for PSFCH transmission with smaller SL priority value, then the UE may transmit PSFCH transmission with larger SL priority value.

VI. Proposal: For handling PSFCH transmission dropping due to LBT failure, followings may be discussed:

1. Option 1: UE may try to transmit SL HARQ-ACK feedback on PSFCH resource in the next RB set.

a. R16 NR SL PSSCH-to-PSFCH resource determination rule may be applied to each RB set.

b. UE may use PSFCH resource in the RB set which UE successes to access.

2. Option 2: UE may try to transmit SL HARQ-ACK feedback on PSFCH resource in the next PSFCH occasion.

a. For each min-PSSCH-to-PSFCH timing, UE may be (pre)configured with different PRB groups for PSFCH resources.

b. R16 NR SL PSSCH-to-PSFCH resource determination rule may be applied to each PSFCH occasion.

c. UE may use PSFCH resource in the earliest PSFCH occasion which UE successes to access the channel.

VII. Proposal: For PSFCH transmission, to meet the OCB and PSD requirements,

1. Interlaced RB-based PSFCH transmission by reusing interlaced PUCCH format 0 may be supported.

a. For PSSCH-to-PSFCH determination rule, a PRB for PSFCH resource may be replaced with PRBs belonging to a interlace within a RB set.

F. Synchronization procedure and channels

TABLE 41
Agreement

For S-SSB and synchronization in SL-U:

| ● | FFS the time domain locations of S-SSB resources, e.g., whether/how to | |
|---|---|---|
| | introduce more candidate occasions compared with R16/R17 NR SL design, etc. | |
| ● | Down-selection at least one of the following solutions to meet OCB and PSD | |
| | requirement for S-SSB transmission | |
| | ◯ | Option 1: Using interlaced RB transmission |
| | ◯ | Option 2: S-SSB multiplexing with other SL transmissions in the same |
| | | slot |
| | ◯ | Option 3: Repetition of S-PSS/S-SSS/PSBCH in frequency domain |
| | ◯ | Option 4: S-PSS/S-SSS/PSBCH with wider bandwidth |
| ● | FFS: whether to support 4 symbols S-SSB | |
| | ◯ | Note: 4 symbols S-SSB can be considered with options 1/2/3/4 above |

| | |
|---|---|
| ● | FFS whether the temporary exemption of OCB requirement is applicable for S- |
| | SSB transmission |
| ● | FFS whether any changes to R16/R17 NR SL synchronization procedure |

I. Observation: If synchronization source for SL communication is limited to GNSS, eNB, or gNB, the applicable scenario for SL operation on unlicensed band would be limited as well.

II. Proposal: For synchronization procedure in SL-U,

1. R16 SL synchronization procedure may be considered as a baseline.

III. Observation: Considering coverage of SL communication the S-SSB structure in time domain (i.e., 2-symbol S-PSS and 2-symbol S-SSS) may need to be kept to achieve energy combining gain.

IV. Proposal: For S-SSB in SL-U,

1. R16 S-SSB structure in time domain may be reused (i.e., 14-symbol duration of S-SSB for normal CP, and 12-symbol duration of S-SSB for extended CP).

V. Observation: Time domain locations of S-SSB resources may need to be determined based on the condition to use Type 2 DL channel access procedure for DL discovery burst transmissions, which is that the transmission(s) duration is at most Ims, and the duty cycle is at most 1/20 to use Type 2A channel access procedure.

VI. Observation: According to EN 301 893, the temporary exemption of OCB requirement may be applicable at least for S-PSS and S-SSS. However, due to PSD requirement, the communication coverage would be too restrictive.

1. During a Channel Occupancy Time (COT), equipment may operate temporarily with an occupied bandwidth of less than 80% of its nominal channel bandwidth. The occupied bandwidth shall not be less than 2 MHz.

2. It might be necessary to check if shared COTs are included.

VII. Observation: For interlaced RB-based transmission for S-SSB, depending on the number of PRBs associated with a single interlace, it would be necessary to use two interlaces for S-SSB transmission to ensure bandwidth of 11 PRBs.

VIII. Observation: For interlaced RB-based transmission for S-SSB, if two interlaces are used, the PSD would be halved compared to the case when single interlace may be used due to PSD requirement.

IX. ix. Observation: For S-SSB with wider bandwidth, bandwidth of PRACH in NR-U could be reused. Moreover, the design principle of R16 S-SSB may be reused further.

X. x. Observation: Repetition of S-SSB in frequency domain would increase PAPR, and it may further reduce coverage.

XI. xi. Proposal: For S-SSB in SL-U, support Option 4 to meet OCB and PSD requirement for S-SSB transmission:

1. Option 1: Using interlaced RB transmission (main chapter)

a. R16 S-PSS/S-SSS/PSBCH may be mapped on 11 PRBs associated with one or two interlaces within a RB set.

b. A (pre)configuration provides the RB set(s) and interlace(s) for S-SSB mapping.

2. Option 4: S-PSS/S-SSS/PSBCH with wider bandwidth

a. For 15 kH SCS,

i. The number of PRBs for S-SSB mapping may be 96.

ii. Sequence length of S-PSS/S-SSS may be 1151.

b. For 30 kH SCS,

i. The number ofPRBs for S-SSB mapping maybe 48.

ii. Sequence length of S-PSS/S-SSS may be 571.

c. For 60 kH SCS,

i. The number ofPRBs for S-SSB mapping may be 24.

ii. Sequence length of S-PSS/S-SSS may be 283.

d. For S-PSS,

i. The coefficient ofN_ID,2 may be replaced with ceiling(Sequence lengthl3).

ii. The constant term may be replaced with ceiling(Sequence lengthL6).

1. Introduction

In the followings, a channel access mechanism for SL-U is proposed.

TABLE 42
Agreement

Type 1 and Type 2 (2A/2B/2C) channel access procedures, transmission gap and LBT
sensing idle time requirements specified in TS37.213 for NR-U are taken as baseline for
NR sidelink operation in a shared channel.

| | |
|---|---|
| ● | FFS conditions for the actual channel access type(s) used for each SL |
| | channel and signal transmitted, and based on COT sharing conditions (if |
| | supported) |
| ● | FFS whether UL CAPC or DL CAPC or both should be used as the baseline, |
| ◯ | FFS how the channel access priority classes apply to each SL channel and |
| | signal |
| ◯ | FFS sidelink priority levels (PQI or L1 priority), channel and signal mapping |
| | to the 4 channel access priority classes. The discussion may involve other |
| | WGs. |

TABLE 43
Agreement

| | |
|---|---|
| ● | UE-to-UE COT sharing is supported in NR sidelink operation in a shared |
| | channel (SL-U). |
| ◯ | FFS applicable SL channels and signals (e.g., PSCCH/PSSCH, PSFCH, S- |
| | SSB) for shared COT access and any restrictions (e.g. whether the COT can |
| | be shared with a single UE or multiple UEs) |
| ◯ | FFS all other details in compliance with the regulatory requirements |
| ● | CP extension (CPE) is supported for NR sidelink operation in a shared |
| | channel. |
| ◯ | FFS all remaining details including applicable scenarios, usage, PHY |
| | structure, etc. |

TABLE 44
Agreement

Channel access procedures for transmission(s) on multiple channels are supported
for NR sidelink operation as defined by TS37.213 for NR-U (wherever applicable)

| | |
|---|---|
| ● | FFS whether the downlink, uplink and/or semi-static multiple channel access |
| | procedure(s) (if supported) from NR-U should be used as a baseline and |
| | whether/how they are applied in SL mode 1 and mode 2 operation |

TABLE 45
Agreement

| ● | The existing sidelink mode 1 RA including dynamic grant, Type 1 and Type 2 | |
|---|---|---|
| | configured grants are supported as a baseline for sidelink operation in a shared | |
| | carrier, subject to applicable regional regulations. At least in dynamic channel | |
| | access, SL UE performs Type 1 or one of the Type 2 LBTs before SL- | |
| | transmission using the allocated resource(s), in compliance with transmission gap | |
| | and LBT sensing idle time requirements specified in TS37.213. | |
| | ◯ | FFS whether/how mode 1 resource allocation [symbol] procedure needs |
| | | to be updated / enhanced due to shared spectrum channel access |
| ● | The existing sidelink mode 2 RA schemes are supported as a baseline for sidelink | |
| | operation in a shared carrier, subject to applicable regional regulations. At least | |
| | in dynamic channel access, SL UE performs Type 1 or one of the Type 2 LBTs | |
| | before SL transmission using the selected and/or reserved resources, in | |
| | compliance with transmission gap and LBT sensing idle time requirements | |
| | specified in TS37.213. | |
| | ◯ | FFS whether/how mode 2 resource selection procedure needs to be |
| | | updated / enhanced due to shared spectrum channel access |
| ● | FFS whether/how multi-consecutive slots transmission can be supported for NR | |
| | sidelink operation in unlicensed spectrum, including the following aspects | |
| | ◯ | channel access, resource allocation and PHY channel design |

| | |
|---|---|
| ● | FFS whether/how enhancement is needed between the end of the LBT procedure |
| | and the start of the SL transmission to retain channel access |
| ● | RAN1 to strive for a common solution for channel access for Mode 1 and Mode |
| | 2 |

In this contribution, issues on the channel access mechanism for NR sidelink transmission on unlicensed spectrum are discussed.

2.1. SL channel access procedure
2.1.1. Type 1 SL channel access procedure

For example, in case of random back-off LBT, the channel access mechanism for DL or UL would need to be modified for SL transmission. To be specific, in Type 1 DL channel access procedure, gNB may adjust contention window size based on HARQ-ACK status of unicast PDSCH transmission within a previous COT duration. When the gNB receives ACK for at least one TB, then the contention window size is reset to the minimum value among the allowable values. Otherwise, the gNB may increase the contention window size to the next allowable value.

For example, in SL transmission, it may be possible that PSCCH/PSSCH conveys a TB with HARQ-ACK feedback disabled even for unicast. In this case, the TX UE cannot know whether RX UE successes to decode a TB and whether the channel access procedure performed by the TX UE is accurate. For example, a method wherein, when UE transmits only PSCCH/PSSCH with HARQ-ACK feedback disabled, the contention window size is kept constant regardless of the existence of its blind retransmission(s) is proposed.

According to an embodiment of the present disclosure, (Proposal 1), for Type 1 SL channel access procedure, if a TX UE transmitted only PSCCH/PSSCH transmission(s) with SL HARQ-ACK feedback disabled during reference duration, contention window size for every CAPC may be kept constant.

For example, a reference duration of UL channel access may be reused by replacing PUSCH with PSSCH.

For example, in case of groupcast SL HARQ-ACK feedback Option 2, PSCCH/PSSCH TX UE may receive HARQ-ACK feedbacks from multiple RX UEs. For HARQ procedure, the TX UE may determine ACK only if the received HARQ-ACK feedbacks are all ACK. However, considering the principle of the contention window size adjustment for Type 1 DL channel access, it may be considered that the TX UE reset the contention window size when the TX UE receives at least one ACK from multiple RX UEs for the same groupcast PSCCH/PSSCH.

According to an embodiment of the present disclosure, (Proposal 2), for Type 1 SL channel access procedure, if a TX UE receives at least one ACK from RX UEs in response of groupcast PSSCH transmission(s) with SL HARQ-ACK feedback Option 2 or in response of unicast PSSCH transmission(s) with SL HARQ-ACK feedback enabled during reference duration, contention window size for every CAPC may be set to the minimum allowable value.

For example, in case of groupcast SL HARQ-ACK feedback Option 1, PSCCH/PSSCH TX UE may not receive explicit ACK from PSCCH/PSSCH RX UE(s). The UE mey determine ACK for the transmitted PSSCH when the UE does not receive any PSFCH from RX UE(s). However, since the UE cannot distinguish the case when the RX UE fails to detect SCI and the case when the RX UE successes to decode PSCCH/PSSCH, the contention window size adjustment based on this implicit ACK could be inaccurate. Alternatively, it may be considered that UE counts the number of NACKs for multiple groupcast PSSCH to decide whether or not to increase contention window size. Another approach may be that the RX UE(s) transmit ACK for the purpose of indicating the reset of the contention window size. In other words, this new ACK signaling may not affect the existing HARQ procedure.

According to an embodiment of the present disclosure, (Proposal 3), for Type 1 SL channel access procedure, for groupcast PSSCH with SL HARQ-ACK feedback Option 1, down-select one of followings:

Alt 1: If a TX UE does not receive ACK from RX UE(s) in response of PSSCH transmission(s), and if the TX UE may receive NACK in response of groupcast PSSCH transmission(s) with SL HARQ-ACK feedback Option 1, contention window size for every CAPC may be set to the next allowable value.

Alt 2: RX UE may transmit ACK in response of groupcast PSSCH with SL HARQ-ACK feedback Option 1 upon decoding success. If a TX UE receives at least one ACK from RX UE(s) in response of the PSSCH transmission(s) during reference duration, contention window size for every CAPC may be set to the minimum allowable value.

For example, there may be no specification change on HARQ procedure for new ACK signaling.

For example, it may be considered that the contention window size is still determined based on HARQ-ACK status of PSCCH/PSSCH. Meanwhile, if uni-direction scenario is considered, further optimization for PSFCH transmission could be also considered.

For example, to minimize NR specification work, the contention window size for SL could be determined based on only unicast PSCCH/PSSCH with HARQ-ACK feedback enabled. In this case, the same mechanism for DL could be directly reused for SL. However, before PC5-RRC connection or without unicast session, the TX UE may use minimum contention window size, so it would be necessary to check the accuracy of channel access mechanism for SL in terms of coexistence with other RATs or links.

For example, for channel sensing operation, UE may perform energy detection to decide the channel is busy or idle. In NR-U, the energy detection threshold could be changed depending on the (maximum) target TX power. Considering that the UL-to-DL COT sharing could be a baseline for SL-to-SL COT sharing, it may be considered that energy detection threshold adaptation procedure for UL is a baseline to design energy detection threshold adaptation procedure for SL. In this case, the energy detection threshold for SL transmission could be (pre)configured or PC5-RRC configured. Otherwise, the energy detection threshold could be adjusted depending on the (maximum) target TX power. If the threshold offset is provided, the offset value could be applied to the energy detection threshold.

According to an embodiment of the present disclosure, (Proposal 4), for SL transmission, energy detection threshold adaptation procedure for UL may be considered as a baseline

For example, for COT sharing ED threshold is (pre)configured or PC5-RRC configured, or for Energy detection threshold for S-SSB transmission, further study may be performed.

2.1.2. Type 2 SL channel access procedure

For example, in case of short LBT or no LBT, the channel access mechanism for DL or UL transmission could be reused in terms of channel sensing interval and its location for channel access mechanism for SL. The remaining issue may be when the UE may use Type 2 SL channel access procedure.

First of all, for example, once a UE successes to access the channel according to Type 1 SL channel access, the UE may continue SL transmission without sensing the channel during the COT duration initiated by the UE itself In other words, during the SL transmission burst, the UE may skip the LBT for SL transmission(s) within the SL transmission burst. In this case, it would be necessary to discuss how to define the SL transmission burst and the relevant channel access mechanism.

Next, for example, when UE shares the COT duration initiated by another UE, the UE may try to access the channel according to Type 2 SL channel access procedure during the COT duration. In this approach, it would be necessary to discuss how to define UE-to-UE COT sharing mechanism.

Lastly, for example, for some regions, short control signaling exemption may be allowed by regulation for a UE to transmit certain transmission on a channel without sensing the channel under the some limitations.

2.1.2.1 SL transmission burst

For example, for a DL transmission burst, the transmission time gap may be up to 16 us, and the gNB may transmit the remaining transmission on the channel after performing Type 2C DL channel access. Similarly, for an UL transmission burst, the transmission gap may be up to 16 us, and the UE may transmit the remaining transmission on the channel after performing Type 2C UL channel access. For the contiguous UL transmission(s), if the transmission time gap may be at least 25 us, or equal to 16 us, or up to 16 us, the gNB may indicate Type 2A, or Type 2B, or Type 2C UL channel access procedures, respectively. Meanwhile, these transmissions may need to be within the relevant COT duration.

For example, considering that gNB may transmit transmission(s) within the DL transmission burst to different UE(s), transmission(s) within SL transmission burst would have different destination(s). However, it would be difficult to link different Mode 2 operation processes for different destination or different TB to make transmission(s) derived by the different Mode 2 operation processes to be a form of SL transmission burst.

For example, a simple way to make SL transmission burst would be replacing candidate single-slot resources with candidate multi-slot resources for a single TB transmission. Another approach may be that the UE may skip channel sensing operation opportunistically only if the set of selected resources derived by one or multiple processes of the existing Mode 2 operation forms a SL transmission burst. At least, as in NR-U DL transmission, when the transmission gap is larger than 16 us, the UE would need to attempt to access the channel again according to Type 1 channel access procedure for later transmission resources. Moreover, for skipping channel sensing for transmission, it would be necessary to ensure that the CAPC value of the performed channel access procedure is larger than equal to the CAPC value corresponding to the remaining transmission(s).

According to an embodiment of the present disclosure, (Proposal 5), UE may transmit transmission(s) after a gap within a SL transmission burst without sensing the corresponding channel(s) for availability.

For example, an SL transmission burst is defined as a set of transmissions from a UE without any gaps greater than 16 us. For example, a CP extension or rate-matching may be used to ensure the time gap requirement between transmissions in a SL transmission burst. For example, transmissions from a UE separated by a gap of more than 16ps may be considered as separate SL transmission bursts.

For example, for whether the destination of transmissions within a SL transmission burst may be different or not, or, for whether TBs of transmissions within a SL transmission burst may be different or not, or, for whether CAPC values of transmissions within a SL transmission burst may be different or not, there may be a further study.

2.1.2.2. UE-to-UE COT sharing for SL transmission(s)

For example, for the case when gNB shares the COT initiated by a UE using the Type 1 UL channel access, the gNB may transmit a transmission that follows a UL transmission on scheduled resources or a PUSCH transmission on configured resources by the UE after a gap if the destination of the transmission is the UE.

In this case, for example, if the time gap between UL transmission and DL transmission is up to 16 us, the gNB may transmit the transmission on the channel after performing Type 2C DL channel access procedure. If the time gap is 25 us or 16 us, the gNB may transmit the transmission on the channel after Type 2A or Type 2B DL channel access procedures.

For example, for the case when gNB shares the COT initiated by a UE with CG PUSCH transmission, the gNB may transmit a transmission that follows the configured grant transmission by the UE based on the beginning and ending time of the COT duration indicated by CG-UCI from the UE. Even in this case, it may be understood that the gNB may transmit the transmission on the channel after Type 2 channel access procedure if the time gap is small enough.

On the other hand, in case when UE shares the COT initiated by the gNB using Type 1 DL channel access, there may be no explicit description about the time gap between DL transmission and UL transmission to use Type 2 channel access procedure. In this case, it may be understood that gNB may ensure the sufficiently small time gap via proper scheduling, if necessary.

For example, in those points of views, if UE-to-UE COT sharing for SL transmission is considered, the UE initiating the COT may need to occupy the channel until the UE sharing the same COT duration transmits SL transmission(s) to avoid that another device intercepts the channel or to guarantee the accuracy of Type 2 SL channel access procedure.

Observation 1: For UE-to-UE COT sharing, UE initiating the COT may need to occupy the channel until UE(s) sharing the same COT transmits SL channel(s) to avoid another RAT of TX node intercept the channel.

For example, a UE initiating the COT duration would need to know when UE sharing the COT duration transmits SL transmission(s) so that the UE initiating the COT duration tries to occupy the channel. In case of PSFCH transmission with Rel-16 PSSCH-to-PSFCH timing, the TX UE may exactly know when the RX UE will transmit the PSFCH in response of PSCCH/PSSCH transmission from the TX UE. In this case, it may be possible that the TX UE occupies the channel until the RX UE transmit the PSFCH transmission. So, the time gap would be small enough to perform Type 2 channel access procedure. However, if the PSFCH timing may be varying due to LBT failure at the RX UE side, the TX UE may not know exactly when the RX UE will transmit the PSFCH in response of PSCCH/PSSCH transmission from the TX UE. In this case, the time gap could be large, and then the RX UE may overestimate the channel availability due to Type 2 channel access procedure. It will cause other devices' channel access interruption or LBT failure at the RX UE side.

Observation 2: TX UE may know when RX UE will transmit PSFCH in response of TX UE's PSSCH transmission if Rel-16 PSSCH-to-PSFCH timing is reused. Otherwise, TX UE may not know when RX UE will actually transmit PSFCH. In this case, the TX UE may not occupy the channel sufficiently for COT sharing.

For example, since PSFCH will be transmitted in response of the received PSCCH/PSSCH, it may be considered that SCI (e.g., 2nd SCI) indicates channel access type to be used for PSFCH transmission as if DCI indicates channel access type of PUCCH transmission in NR-U. Continuous channel occupancy of the TX UE may or may not be specified in the specification explicitly.

According to an embodiment of the present disclosure, (Proposal 6), for PSFCH transmission, if a UE receives SCI (e.g., 2nd SCI) indicating Type 2 channel access for PSFCH transmission from another UE transmitting the PSSCH, and if the UE transmits the PSFCH on PSFCH resource determined by Rel-16 PSSCH-to-PSFCH timing in response of the received PSSCH, a UE may access channel for the PSFCH transmission in response of PSSCH transmission according to Type 2 channel access procedure.

For example, Type 2A channel access procedures may be applicable to PSFCH transmission performed by the UE following transmission(s) by UE indicating Type 2 channel access type after a gap of 25 us.

For example, Type 2B channel access procedures may be applicable to PSFCH transmission performed by the UE following transmission(s) by UE indicating Type 2 channel access type after a gap of 16 us.

For example, Type 2C channel access procedures may be applicable to PSFCH transmission performed by the UE following transmission(s) by UE indicating Type 2 channel access type after a gap of up to 16 us.

For example, there may be further study for whether/how to specify that UE transmitting the PSSCH occupies the channel until the corresponding PSFCH occasion.

For example, in case of PSCCH/PSSCH transmission, since the Mode 2 operation is done in distributed manner, a UE initiating COT duration would not know when another UE's PSCCH/PSSCH transmission is present. In case of S-SSB transmission, depending the synchronization source and the relaying hop, the exact S-SSB transmission location would be different among sl-SSB-TimeAllocationl, sl-SSB-TimeAllocation2, and sl-SSB-TimeAllocation3. For the above cases, the UE initiating the COT duration may not occupy the channel sufficiently before the transmission(s) of the UE sharing the COT duration.

Observation 3: TX UE may not know when another UE will transmit PSCCH/PSSCH or S-SSB. In this case, the TX UE may not occupy the channel sufficiently for COT sharing.

Meanwhile, if the COT sharing is not applied to PSCCH/PSSCH transmission, it may be not possible that a UE transmits PSCCH/PSSCH on a channel in the middle of SL transmission bursts of another UE on the same channel. In other words, resources would not be fully utilized. To support FDM between SL transmission burst and another PSCCH/PSSCH on the same channel, it may be necessary to support the case where UE-to-UE COT sharing is applied to PSCCH/PSSCH transmission to use Type 2 channel access procedures.

Observation 4: Considering FDM with SL transmission burst, it would be necessary to support Type 2 channel access procedure for PSCCH/PSSCH transmission. Otherwise, during the SL transmission burst of a UE, another UE cannot use FDMed resources in the same RB set.

For example, for PSCCH/PSSCH transmission in shared COT duration, UL-to-DL COT sharing may be considered as a baseline. To be specific, like CG-UCI, an SCI may indicate the starting time and ending time of the shared COT duration, and the UE receiving the COT sharing information may use Type 2 channel access procedure for the transmission that follows UE initiating the COT after the sufficiently small gap.

In this case, for example, it is understood that the UE initiating the COT may occupy the channel until the indicated starting time of the shared COT duration. If the UE will reselect PSSCH resources based on the shared COT duration, the cast of PSCCH/PSSCH indicating the COT information would be unicast to avoid resource collision among multiple UEs sharing the same COT duration.

On the other hand, for example, if the UE will opportunistically share the COT duration only when the PSSCH resource determined by Mode 2 operation is on the indicated starting time of the shared COT duration instead of resource reselection, it would be better that the COT sharing information is transmitted in groupcast or broadcast manner to increase the possibility of using Type 2 channel access procedures.

According to an embodiment of the present disclosure, (Proposal 7), for PSCCH/PSSCH transmission, if a UE receives SCI (e.g., 2nd SCI) indicating the starting time and/or the ending time of the shared COT duration, and if the UE transmits the PSCCH/PSSCH on the starting time of the shared COT duration to the UE indicating the shared COT information, UE may access channel at least for PSCCH/PSSCH transmission according to Type 2 channel access procedure.

Type 2A channel access procedures may be applicable to transmission(s) performed by the UE following transmission(s) by UE initiating the COT duration after a gap of 25 us in a shared channel occupancy.

Type 2B channel access procedures may be applicable to transmission(s) performed by the UE following transmission(s) by UE initiating the COT duration after a gap of 16 us in a shared channel occupancy.

Type 2C channel access procedures may be applicable to transmission(s) performed by the UE following transmission(s) by UE initiating the COT duration after a gap of up to 16 us in a shared channel occupancy.

For example, there may be a study for whether/how to specify that UE indicating the shared COT information occupies the channel until the UE sharing the COT transmits the PSCCH/PSSCH, or, cast type of PSCCH/PSSCH indicating the shared COT information, or, cast type of PSCCH/PSSCH by the UE sharing the indicated COT duration.

2.1.2.3. Short control signaling

For example, UE may send management and control signals without sensing the channel when following limits of short control signaling are fulfilled: within an observation period of 50 ms, the number of SCS transmissions by the equipment shall be equal to or less than 50; and the total duration of the equipment's SCS transmissions shall be less than 2 500 ps within the observation period.

For example, Type 2A DL channel access procedure may be applicable to transmission(s) initiated by a gNB with only discovery burst or with discovery burst multiplexed with non-unicast information, where the transmission(s) duration is at most 1 ms, and the discovery burst duty cycle is at most 120.

Observation 5: Short control signaling exemption would be applicable in some region while Type 2A DL channel access procedure condition would be applicable without any restriction on the regions.

For example, the possibility of applying the short control signaling to S-SSB and/or PSFCH transmission(s) may be described. It is necessary to clarify whether the transmission(s) per UE basis or per system basis are used to check the limitations for short control signaling. In this disclosure, an analysis on the number of transmission(s) in per-UE basis or per-system basis to meet the requirements for the short control signaling may be proposed. For per-system basis analysis, transmission(s) by a number of UEs may fulfill the requirements by adjusting total number of resource candidate(s).

Observation 6: In the perspective of a UE, the maximum number of S-SSBs within 160 msec period to meet the requirements for the short control signaling may be given by as follows. For example, it may be 6 for 15 kHz SCS, 16 for 30 kHz SCS, and 32 for 60 kHz SCS

For example, it may be assumed that the time locations of S-SSB is equally distributed over the period.

Observation 7: In the perspective of SL system, the maximum number of S-SSBs within 160 msec period for a single S-SSB time allocation (e.g., sl-SSB-TimeAllocatoinl, sl-SSB-TimeAllocatoin2, sl-SSB-TimeAllocatoin3) to meet the requirements for the short control signaling may be given by as follows. For example, it may be 2 for 15 kHz SCS, 5 or 6 for 30 kHz SCS, and 10 or 11 for 60 kHz SCS.

For example, for S-SSB transmission(s), if the contiguous time locations of S-SSB are considered, the number of S-SSB transmission(s) would be further reduced to meet the requirements. For example, if the sl-SSB-TimeAllocation3 is not provided, then the number of S-SSB resources could be increased.

Observation 8: In the perspective of a UE, to meet the requirements for the short control signaling, the UE may transmit PSFCHs on at most 17 PSFCH occasions every 50 msec for 15 kHz SCS, transmit PSFCHs on at most 35 PSFCH occasions every 50 msec for 30 kHz SCS, transmit PSFCHs on at most 50 PSFCH occasions every 50 msec for 60 kHz SCS

Observation 9: In the perspective of SL system, the PSFCH resource period of 1 and 2 may not meet the requirements for the short control signaling exemption for 15 kHz, 30 kHz, and 60 kHz SCS.

For example, for PSFCH transmission(s) in per-UE basis, UE may need to drop parts of PSFCH transmission(s) to meet the requirements.

In this disclosure, an analysis on the number of S-SSB transmission(s) in per-UE basis or per-system basis to meet the requirements for Type 2A channel access procedure in NR-U DL may be provided.

Observation 10: In the perspective of a UE, the maximum number of S-SSBs within 160 msec period to meet the condition for using Type 2A channel access procedure as in NR-U DL may be given by as follows. For example, it may be 8 for 15 kHz SCS, 16 for 30 kHz SCS, and 32 for 60 kHz SCS

Observation 11: In the perspective of SL system, the maximum number of S-SSBs within 160 msec period for a single S-SSB time allocation (e.g., sl-SSB-TimeAllocatoinl, sl-SSB-TimeAllocatoin2, sl-SSB-TimeAllocatoin3) to meet the condition for using Type 2A channel access procedure as in NR-U DL may be given by as follows. For example, it may be 2 or 3 for 15 kHz SCS, 5 or 6 for 30 kHz SCS, and 10 or 11 for 60 kHz SCS.

For example, the number of S-SSB transmission(s) for Type 2A channel access procedure may be almost similar compared to the short control signaling exemption.

In this disclosure, for simplicity, what is checked are the requirements for the case when only S-SSB transmission is applied or the case when only PSFCH transmission is applied. However, if it is considered that short control signaling exemption or Type 2A channel access procedure condition is applied to both S-SSB and PSFCH transmissions, it would be necessary to check the total durations of both S-SSB transmission(s) and PSFCH transmission(s) to check whether the requirements are fulfilled or not. In this case, the number of transmissions of each SL channel/signal would need to be further reduced. It may limit the SL communication coverage and/or the gain achievable from SL HARQ process.

Observation 12: If short control signaling exemption is applied to both S-SSB and PSFCH transmission(s), the requirements may need to be fulfilled considering the total duration of both S-SSB transmission(s) and PSFCH transmission(s).

According to an embodiment of the present disclosure, (Proposal 8), short control signaling exemption or conditions for applying Type 2A channel access procedure at least for S-SSB transmission(s) may be prioritized.

2.1.3. Semi-static channel occupancy

For example, when the absence of any other RAT sharing the channel is guaranteed on long term basis, the form of the COT duration could be fixed-frame period (FFP). In this case, once gNB or UE accesses the channel, the TX node may occupy the channel during the associated FFP. Meanwhile, in NR-U, both DL and UL transmission resources may be controlled by gNB. On the other hand, in case of SL Mode 2 resource (re)selection procedure, some SL transmission resource could be out of gNB's control. For instance, it would be possible that DL or UL transmission scheduled by gNB may collide with SL transmission due to simplified channel sensing operation. In this case, it would be necessary to discuss when the semi-static COT duration could be used.

Observation 13: For semi-static COT sharing, one or more of following scenarios could be considered:

Scenario 1: The absence of any other technology sharing the channel may be guaranteed on a long term basis (e.g. by level of regulation)

Scenario 2: The absence of certain link(s) sharing the channel may be guaranteed on a long term basis

Scenario 3: The absence of UE with SL Mode 2 resource (re)selection procedure sharing the channel may be guaranteed on a long term basis

For example, in NR-U, UE may be provided with the FFP (fixed-frame period) configuration via SIB1 or dedicated RRC signaling. In SL, UE-specific parameters may be realized by PC5-RRC signaling, and this PC5-RRC signaling and connection needs unicast session. For example, considering groupcast and broadcast transmission and the case when unicast session is not set, it would be necessary to support at least that FFP for SL transmission is provided by a (pre)configuration.

According to an embodiment of the present disclosure, (Proposal 9), for semi-static COT sharing, how to set FFP (fixed frame period) and what is the granularity of configuration for FFP is proposed.

2.2. Aspects of Mode 2 resource selection procedure

For example, when the channel sensing procedure is further considered, it would be necessary to check whether or how to modify the SL resource (re)selection procedure. To be specific, it would be necessary to determine whether the channel sensing procedure will be performed before or after performing SL resource (re)selection procedure.

For example, for Type 1 channel access procedure, UE may need to know CAPC value to decide contention window size, and the CAPC value would be related to data packet or TB which the UE will transmit. In this case, at least when data packet is available at the UE side, the UE may decide whether or not to start Type 1 channel access procedure based on the proper CAPC value. Moreover, according to the agreement, since SL UE performs Type 1 or one of the Type 2 LBTs before SL transmission using the selected and/or reserved resources, the UE may decide whether or not to start the LBT procedure after the UE decide its PSSCH transmission resources.

Observation 14: UE may know CAPC or the necessity of channel access after the UE triggers SL resource (re)selection procedure.

According to an embodiment of the present disclosure, (Proposal 10), UE may attempt to access channel according to Type 1 SL channel access procedure after the resource (re)selection procedure is triggered at the UE side.

According to an embodiment of the present disclosure, (Proposal 11), for the case when UE determines that there is no sufficient time to complete channel access procedure before the SL transmission(s), down-select one or more of followings: Option 1: Drop the SL transmission and attempt to access the channel for the next transmission on the reserved resources, Option 2: Reselect the resources for the SL transmission, Option 3: First time location of available SL resources is determined to ensure the channel sensing duration.

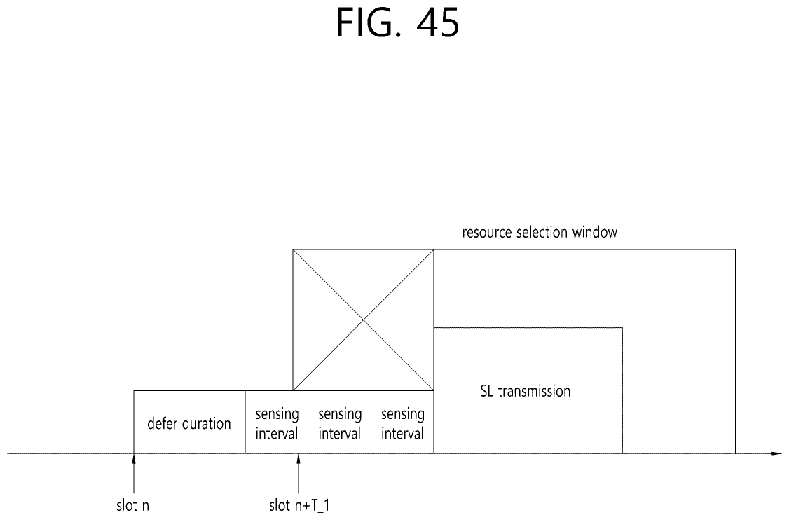

FIG. 45 shows a channel sensing duration of a type 1 SL channel access for an SL transmission near the start of a resource selection window, according to one embodiment of the present disclosure. The embodiment of FIG. 45 may be combined with any embodiment of the present disclosure.

Meanwhile, depending on the contention window size, the total channel sensing duration could be much larger than T_proc,1. In this case, the UE may fail to complete Type 1 channel access procedure before the time location of the selected resources for PSSCH transmission especially when the time location of the selected resource(s) is closed to the beginning of the resource selection window as shown in FIG. 45. To alleviate this problem, it may be considered to delay the earliest time location of the available SL resources to cover the channel sensing duration.

Observation 15: Considering that the channel sensing duration may be larger than T_proc,1, if the first time location of available SL resources closes to the starting time of the resource selection window, the UE may not have enough time to complete the Type 1 channel access procedure.

For example, for Type 1 SL channel access procedure, after a UE selects a random number for channel sensing duration, the UE may determine whether the channel sensing duration is sufficient or not. If the channel sensing duration is not sufficient, the UE may drop the corresponding SL transmission. After dropping the SL transmission due to limited channel sensing duration, the UE may attempt to access the channel for the next transmission on the reserved resources. Alternatively, to recover the dropped SL transmission, the UE may perform a resource reselection procedure for the dropped SL transmission.

According to an embodiment of the present disclosure, (Proposal 12), for Mode 2 SL resource (re)selection procedure, UE may select transmission resources so that the time gap between any two transmission resources covers channel sensing duration.

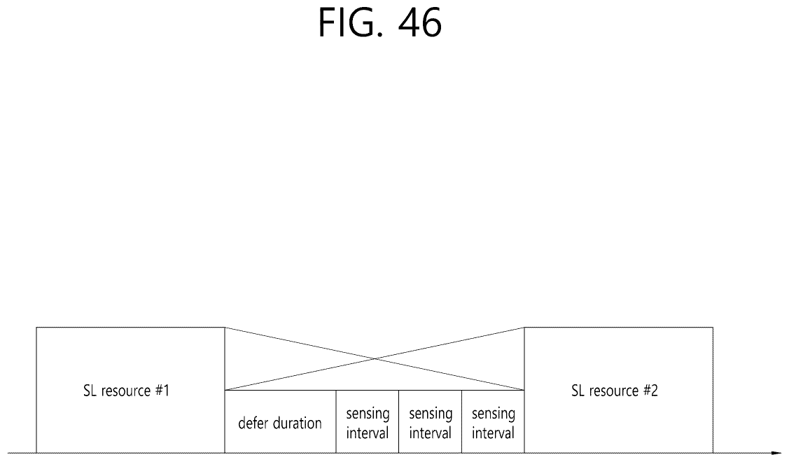

FIG. 46 shows a transmission resource that is selected in a mode 2 SL resource selection procedure such that the time gap between all two transmission resources covers the channel sense interval, according to one embodiment of the present disclosure. The embodiment of FIG. 46 may be combined with various embodiments of the present disclosure.

For example, in case of SL resource (re)selection procedure, if PSFCH resource is (pre)configured in a resource pool, the time gap between any two selected resources should be larger than or equal to HARQ RTT. Similarly, when UE selects TX resources, it is necessary to guarantee the channel sensing interval right before each TX resource as shown in FIG. 46. If this kind of restriction is not introduced, at least, it would be necessary to determine how to handle the case when a UE has not enough time to perform channel sensing operation before SL transmission.

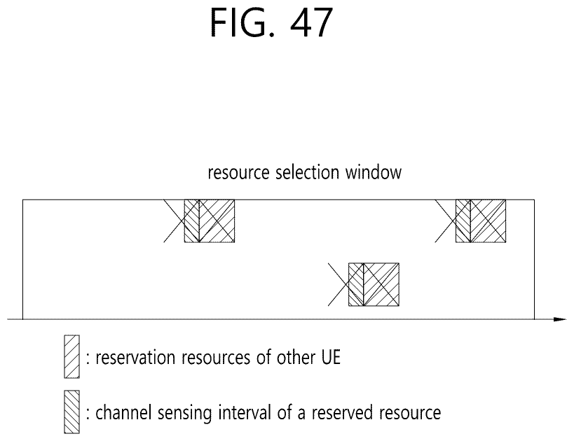

FIG. 47 shows an SL mode 2 resource selection procedure based on channel sensing durations of different UEs, according to one embodiment of the present disclosure. The embodiment of FIG. 47 may be combined with various embodiments of the present disclosure.

Referring to FIG. 47, for channel access, a UE will perform channel sensing operation during the channel sensing interval. In this case, if another transmission occupies this channel sensing interval, the UE would not perform actual transmission since the UE will determine that the channel is busy. In this case, once a UE detects reserved resources of other UE and determines to exclude these resources from the candidate single-slot resource set, then the UE also needs to exclude the channel sensing interval of the reserved resources.

For example, in case of Type 2 channel access procedure, the channel sensing interval would have the fixed size. Since the channel sensing interval of Type 1 channel access procedure could by varying, it would be needed to have representative value for the sensing interval to be excluded from the candidate single-slot resource set.

Observation 16: For Mode 2 SL resource (re)selection procedure, it would be useful for a UE to further exclude resources associated with channel sensing interval of other UE's reserved resources.

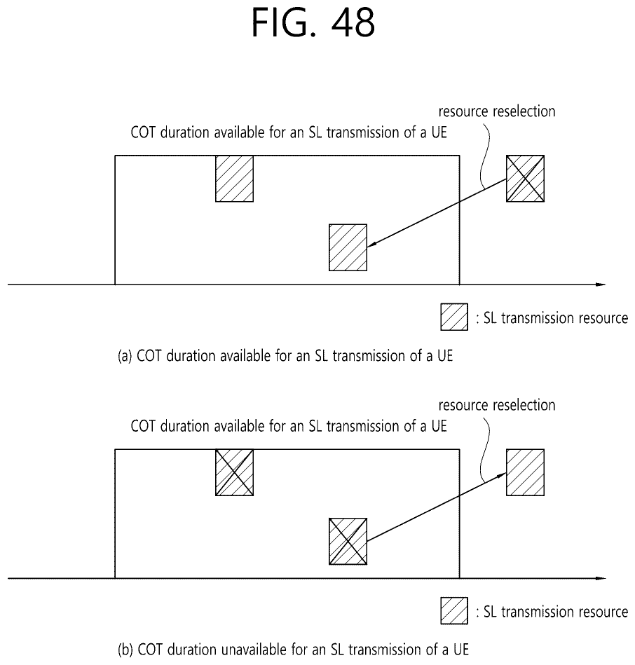

FIG. 48 shows an SL mode 2 resource selection procedure based on shared or unshared COT durations, according to one embodiment of the present disclosure. The embodiment of FIG. 48 may be combined with various embodiments of the present disclosure.

For example, when the concept of COT sharing is adopted, it would be necessary to prioritize resources inside the COT duration to reduce overhead for channel sensing operation. For example, referring to (a) of FIG. 48, when UE performs SL resource selection or re-selection, if there is COT duration available for SL transmission of the UE, the UE may first use resources inside the COT duration as much as possible. If the UE still need to have TX resources, then the remaining TX resources may be selected outside the COT duration. On the other hand, referring to (b) of FIG. 48, it would be possible that the COT duration known to the UE cannot be used for SL transmission of the UE. In this case, to avoid another transmission inside the COT duration, it may be considered that the UE uses resources outside the COT duration for its SL transmission.

For example, in unlicensed carrier, RB set may be a granularity of channel sensing operation in frequency domain. In this case, for the same number of PRBs for SL transmission, if the PRBs are distributed over multiple RB sets, the UE may need to success to access the RB sets to actually perform the SL transmission. Considering the availability of SL transmission, it would be beneficial to select SL resources within smaller number of RB set(s). On the other hand, due to the PSD requirement, it would be useful to select SL resources to be distributed over a number of RB sets. In those points of views, it would be necessary to modify Mode 2 resource (re)selection procedure to take the concept of RB set into account.

Proposal 13: For the case when a resource pool consists of more than one RB sets, it may be needed to discuss whether or how to consider RB set(s) for Mode 2 resource (re)selection procedure.

For example, for a given number of sub-channels, smaller number of RB set(s) may be prioritized for PSSCH transmission resources.

For example, before selecting transmission resources, UE may selects RB set(s) for PSSCH transmission.

For example, it would be necessary to handle the (consistent) LBT failure at the UE side for Mode 2 operation. For example, when a UE determines the consistent LBT failure, for a certain RB set(s), the UE may need to avoid using the RB set(s) for SL transmission. Alternatively, for example, to avoid the consistent LBT failure, it may be considered to increase the amount of candidate resources for SL transmission.

2.3. Aspects of Mode 1 resource allocation procedure

For example, in sidelink unlicensed operation, the gNB may not perform Type 1 channel access to initiate and share a channel occupancy, neither Type 2 channel access to share an initiated channel occupancy, nor semi-static channel access procedures to access an unlicensed channel.

For example, the possibility that the gNB provides the COT initiated by a UE to another UE may need to be discussed. In this case, the gNB may just relay the COT information and does not perform channel access procedure for SL-U operation. This relaying mechanism could be seen as double COT sharing which is not supported in NR-U. It would be need to discuss n the necessity of this double COT sharing.

For example, even if this mechanism is introduced for SL-U, RANT still need to check the feasibility of the double COT sharing in terms of processing time budget. For example, a UE may need to report the COT information to gNB on UL after the UE accesses the channel including SL transmission. After the gNB receives the COT reporting from the UE, the gNB may need to transmit the COT information to another UE on DL. The above processing may need to be finished within the maximum COT duration, and the remaining COT duration after these processing could be used for SL transmission

However, considering that the maximum COT duration could be 2 or 3 msec, this approach may be infeasible or inefficient. Moreover, for COT information reporting, it would be necessary to design new UCI or new reporting type on UL. For example, to design UL mechanism including UCI multiplexing issue or scheduling/configuring UL channels for new type of reporting may be needed.

Observation 17: To support that gNB provide COT initiated by a UE to another UE, it may be necessary to check the feasibility on the double COT sharing issue, processing time budget for exchanging COT information, and specification work load on supporting new UCI or reporting type on UL.

According to an embodiment of the present disclosure, (Proposal 14), a feature that double COT sharing (i.e., gNB indicates COT initiated by UE to another UE) is not supported may be proposed.

For example, since gNB does not perform channel sensing operation for SL-U, the gNB may not know which RB set(s) would be good for SL transmission in terms of channel availability. In this case, it would be possible that the gNB continuously allocates a certain RB set which may make consistent LBT failure to a UE for SL transmission. To alleviate this inefficiency, it would be beneficial to have new Mode 1 reporting related to LBT failure.

For example, if a UE observes consistent LBT failures during a certain period of time, the UE may report this situation to the gNB. In this case, the gNB may change RB set(s) or energy detection threshold to give more chance to access the channel to a UE for SL transmissions. However, this new reporting type would need more specification work for UL mechanism. Alternatively, it may be considered that the gNB anticipates which RB set(s) would be problematic based on the existing SL HARQ-ACK reporting on UL.

Observation 18: gNB may need to know LBT failure ratio for each RB set to decide how to allocate RB set(s) for SL transmission to UE.

According to an embodiment of the present disclosure, (Proposal 15), for SL Mode 1 operation on unlicensed spectrum, down-select one of followings: For example, option 1: For LBT failure, a UE may report NACK to gNB, option 2: A UE may report LBT failure status separately from SL HARQ-ACK status to gNB.

### 1. Introduction

For example, for channel access mechanism for SL-U, followings may be supported.

TABLE 46
Agreement

SL BWP, SL resource pool in R16/R17 NR SL and RB set in R16 NR-U are reused for
SL-U as baseline

| | |
|---|---|
| ● | Only one SL BWP is (pre-)configured within a carrier |
| ● | The SL BWP is (pre-)configured to include one or multiple SL resource |
| | pools |
| ● | At least support that one SL resource pool can be (pre-)configured to |
| | include integer number of RB sets |
| ◯ | FFS: whether/how to support one SL resource pool can include sub-set of |
| | PRBs of one RB set |
| ◯ | FFS: the applicable resource pool |
| ◯ | FFS: the impact on sub-channel size and number of sub-channels in a |
| | resource pool if sub-channel is supported |
| ● | PRBs within intra-cell guard band of two adjacent RB sets belong to a |
| | resource pool if the resource pool includes the two adjacent RB sets |
| ◯ | FFS details, e.g., how such PRBs are used, the applicable resource pool, |
| | etc. |
| ● | FFS: whether R16/R17 NR SL S-SSB slots and/or new S-SSB slots (if |
| | supported) are excluded from resource pool |
| ● | FFS: which slots belong to resource pool, e.g., how to set the value of |
| | bitmap, whether to consider SL-U/NR-U operating in the same carrier and |
| | whether TDD configuration are considered, etc. |
| ● | FFS: the impact of PSCCH/PSSCH mapping to frequency resources on |
| | resource pool configuration, on sub-channel definition if sub-channel is |
| | supported, etc. |

TABLE 47
Agreement

For PSCCH and PSSCH in SL-U:

| | |
|---|---|
| ● | Both R16/R17 NR SL contiguous RB-based and R16 NR-U interlace RB- |
| | based transmissions are considered as starting point |
| ◯ | RAN1 strives to have unified design for both contiguous RB-based and |
| | interlace RB-based transmissions |
| ◯ | FFS: whether/how to address IBE (In Band Emission) impact |

TABLE 48
Agreement

For PSCCH and PSSCH in SL-U:

| | |
|---|---|
| ● | For interlace RB-based transmission (if supported), at least the following |
| | candidates can be discussed: |
| ◯ | Frequency domain resource allocation granularity is one sub-channel for |
| | PSSCH transmission |
| ▪ | FFS: Other resource allocation granularity, e.g., RB-level |
| ◯ | 1 sub-channel equals K interlaces if sub-channel is supported |
| ▪ | FFS details |
| ◯ | Other candidates are not precluded |
| ◯ | FFS: mapping of PSCCH to frequency resources |
| ◯ | FFS: resource indication in time/frequency domain, e.g., how to handle |
| | using one RB set or multiple RB sets, etc. |

TABLE 49
Agreement

For slot structure in SL-U:

| | |
|---|---|
| ● | At least R16/R17 NR SL slot-based PSCCH/PSSCH transmission is |
| | supported |
| ◯ | FFS: whether/how to support additional starting symbol(s) within a slot for |
| | the PSCCH/PSSCH transmission |

TABLE 50
Agreement

For PSFCH and SL-HARQ in SL-U:

| | |
|---|---|
| ● | At least R16 NR SL PSFCH format 0 is supported |
| ◯ | FFS whether to introduce new PSFCH format |
| ● | FFS: how to meet OCB and PSD requirement for PSFCH transmission, |
| | e.g., using interlaced RB transmission, whether/how to avoid too small |
| | PSFCH capacity, etc. |
| ● | FFS: the locations of PSFCH resources, e.g., (pre-)configured, |
| | dynamically indicated, etc. |
| ● | FFS: whether/how to address PSFCH transmission dropping due to LBT |
| | failure, e.g., whether to have multiple PSFCH occasions for a PSSCH and |
| | the related PSSCH-PSFCH mapping relationship, impact on SL HARQ- |
| | ACK reporting to the gNB for Mode 1, etc. |
| ● | FFS: whether/how to address PSFCH and related PSSCH in different |
| | COTs |

TABLE 51
Agreement

For S-SSB and synchronization in SL-U:

| ● | FFS the time domain locations of S-SSB resources, e.g., whether/how to | |
|---|---|---|
| | introduce more candidate occasions compared with R16/R17 NR SL design, etc. | |
| ● | Down-selection at least one of the following solutions to meet OCB and PSD | |
| | requirement for S-SSB transmission | |
| | ◯ | Option 1: Using interlaced RB transmission |
| | ◯ | Option 2: S-SSB multiplexing with other SL transmissions in the same |
| | | slot |
| | ◯ | Option 3: Repetition of S-PSS/S-SSS/PSBCH in frequency domain |
| | ◯ | Option 4: S-PSS/S-SSS/PSBCH with wider bandwidth |
| ● | FFS: whether to support 4 symbols S-SSB | |
| | ◯ | Note: 4 symbols S-SSB can be considered with options 1/2/3/4 above |

| | |
|---|---|
| ● | FFS whether the temporary exemption of OCB requirement is applicable for S- |
| | SSB transmission |
| ● | FFS whether any changes to R16/R17 NR SL synchronization procedure |

In the present disclosure, the physical channel design for NR sidelink transmission on unlicensed band is described.

### 2. Discussion

### 2.1. SL BWP and SL Resource Pool Configuration

For example, in NR-U, BWP is configured to be aligned with RB set(s) in boundaries. Moreover, a SL resource pool may be (pre)configured to include integer number of RB sets. In those of points of view, it would be necessary that the SL BWP is also (pre)configured to be aligned with RB set(s) in boundaries.

Considering that the BWP in NR-U is always aligned with RB set(s) in boundaries, it may be unclear benefit of supporting that a SL resource pool includes sub-set of PRBs of one RB set. Moreover, considering that the granularity of the channel sensing operation is a RB set, it would be better in terms of resource utilization not to restrict available resource into a certain subset of resources in the RB set. Since the granularity of the number of frequency resources belonging to a SL resource pool is a PRB, there is no problem to align the boundary of the SL resource pool with the boundary of RB set(s).

Depending on the regulation, the occupied bandwidth would need to be larger than 80% over the total bandwidth. Moreover, power spectral density for any 1 MHz could be limited. In NR-U, to meet these regulations, interlaced RB-based transmission is supported. At least for PSCCH and PSSCH, both NR SL contiguous RB-based and interlaced RB-based transmissions may be considered. In this case, it may be necessary to decide the granularity of (pre)configuration to enable or disable the interlaced RB-based transmission.

In NR-U, the interlaced RB-based transmission may be a part of UE capability, and enabling/disabling interlaced RB-based transmission is cell-specific. Meanwhile, if the interlaced RB-based transmission is (pre)configured per SL BWP or SL carrier, then UE(s) without the interlaced RB-based TX capability would not be supported on the SL carrier.

For example, since S-SSB transmission still be a form of interlaced structure, it would be unclear the benefit of allowing the coexistence between contiguous RB-based transmission and interlaced RB-based transmission in a SL carrier. To be specific, even if the contiguous RB-based transmission is allowed in a SL carrier with OCB requirement, the UEs without interlaced RB-based transmission capability may not transmit S-SSB transmission.

Observation 1: If S-SSB transmission is a form of interlace structure, the benefit of the coexistence between contiguous RB-based transmission and interlaced RB-based transmission in a SL carrier may be unclear.

According to an embodiment of the present disclosure, (Proposal 1), for SL BWP configuration on shared spectrum, starting PRB of SL BWP may be aligned with the lowest PRB of the lowest RB set within SL BWP, ending PRB of SL BWP may be aligned with the highest PRB of the highest RB set within SL BWP, and either contiguous RB-based transmission or interlaced RB-based transmission may be (pre)configured.

According to an embodiment of the present disclosure, (Proposal 2), for SL resource pool configuration in frequency domain on shared spectrum, starting PRB (i.e., sl-StartRB-Subchannel) may be aligned with the lowest PRB of the lowest RB set within the resource pool, and the number of PRBs (i.e., sl-RB-Number) may be set so that the ending PRB is aligned with the highest PRB of the highest RB set within the resource pool.

For example, in case of SL communication on licensed spectrum, for TDD, cell-specific UL slots may be belonging to a resource pool. For flexible slots, if the SL symbol group in a slot is set to cell-specific UL, then the flexible slots may be belonging to a resource pool as well.

For example, for simplicity, even for unlicensed spectrum operation, the same principle could be adopted for candidate slots that may be belonging to a resource pool. If it is allowed that other flexible slots or DL slots to belong to a resource pool, it would be further discuss how to define prioritization rule between DL reception (e.g., DL discovery burst, PDCCH monitoring, CSI measurement) and SL transmission/reception. If the UE is configured with tdd-UL-DL-ConfigurationCommon for the unlicensed carrier, the UE may be configured to use it.

According to an embodiment of the present disclosure, (Proposal 3), for SL communication on shared spectrum, a resource pool excludes following slots: i) slots whose symbols from sl-StartSymbol to sl-StartSymbol+sl-LengthSymbols-1 arenot semi-statically configured as UL as per the higher layer parameter tdd-UL-DL-ConfigurationCommon of the serving cell if provided or sl-TDD-Configuration if provided or sl-TDD-Config of the received PSBCH if provided, ii)S-SSB slots, iii) reserved slots.

2.1.1. Contiguous RB-based transmission

For example, according to NR-U, the granularity of channel sensing operation is RB set, and the size of the RB set is between 100 ˜110 for 15 kHz SCS or between 50 ˜55 except for at most one RB set which may contain 56 RBs for 30 kHz SCS. Moreover, depending on the carrier, there could exist guard-band between two adjacent RB sets. If UE accesses two RB sets, then the UE may transmit UL channel/signal on resources belonging to guard bands as well to ensure contiguous UL transmission in frequency domain.

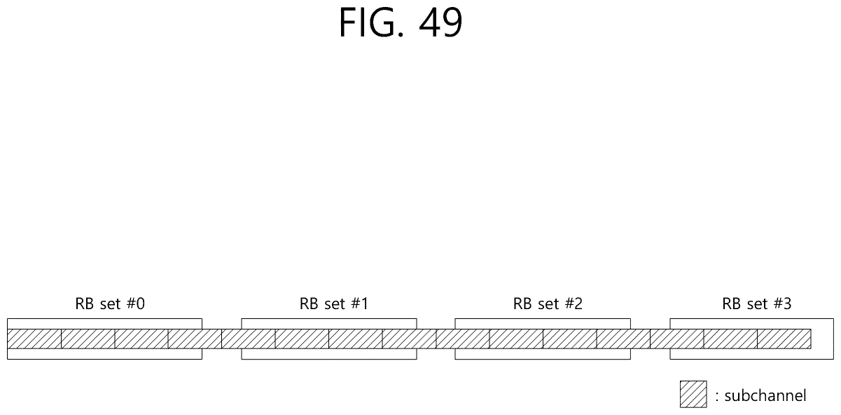

FIG. 49 shows subchannelization for PSCCH/PSSCH transmissions based on contiguous RBs, according to one embodiment of the present disclosure. The embodiment of FIG. 49 may be combined with various embodiments of the present disclosure.

For example, for contiguous RB-based PSCCH/PSSCH transmission, since the granularity of PSCCH/PSSCH transmission is sub-channel, it would be necessary to investigate the relationship between RB sets and sub-channels. If Rel-16 NR SL sub-channelization is applied to the multiple RB sets, sub-channels would not be aligned with RB sets in boundaries. In this case, it would be possible that a subset of PRBs belonging to a sub-channel is outside the RB set, and these PRBs would not be used for PSCCH/PSSCH transmissions.

For example, referring to FIG. 49, only two sub-channels are fully confined within a RB set #1, and the parts of the other sub-channels are outside the RB set. In this case, when UE transmits PSCCH/PSSCH on RB set #1, then the only two sub-channels may be used. In this case, a number of resources within the RB set cannot be utilized.

Observation 2: If sub-channels are not aligned with RB sets in boundaries, a number of resources would not be utilized especially when small number of RB set(s) are allocated for PSCCH/PSSCH transmission.

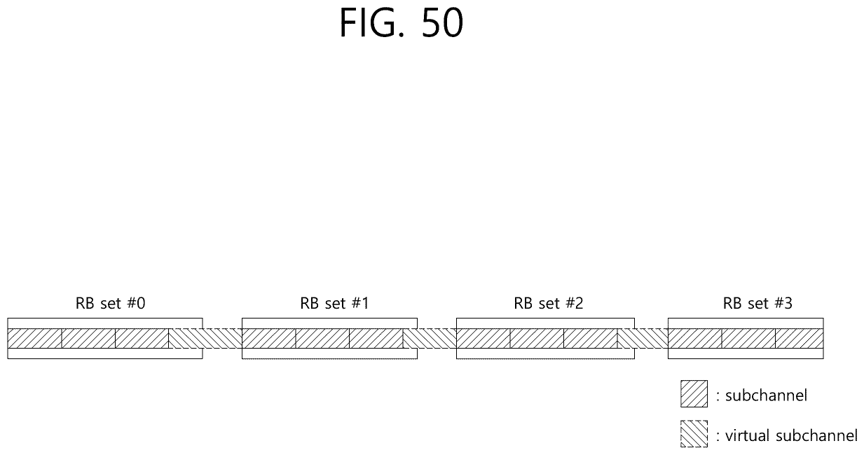

FIG. 50 shows subchannelization for PSCCH/PSSCH transmissions based on contiguous RBs, according to one embodiment of the present disclosure. The embodiment of FIG. 50 may be combined with various embodiments of the present disclosure.

For example, sub-channels could be defined to be aligned with RB set(s) in boundaries. To be specific, for each RB set belonging to a SL resource pool, sub-channels may be allocated to be fully confined within the RB sets as shown in FIG. 50. Meanwhile, the remaining PRBs after allocating the sub-channel of each RB set and PRBs belonging to a guard band may be automatically used for PSCCH/PSSCH transmission only if the adjacent RB sets may be allocated for PSCCH/PSSCH transmission. Moreover, to ensure enabling the same TB size regardless of whether or not to use these remaining PRBs, it may be considered that the remaining PRBs are not counted for TBS determination.

According to an embodiment of the present disclosure, (Proposal 4), for contiguous RB-based transmission, sub-channels may be defined to be aligned with RB set(s) in boundaries, PRBs between sub-channels belonging to different RB sets may be used automatically for PSCCH/PSSCH transmission when the sub-channels belonging to different RB sets are used for the PSCCH/PSSCH transmission, and PRBs not belonging to a sub-channel may be not counted for TBS determination.

### 2.1.2. Interlaced RB-Based Transmission

For example, at least for PSCCH and PSSCH, interlaced RB-based transmissions may be considered. Since the granularity of PSCCH/PSSCH scheduling is a sub-channel, it would be necessary to discuss how to define sub-channel for the interlaced structure. Or, it would be necessary how to modify FRIV indication to indicate RB set and/or interlaced index for the current resource and the reserved resources.

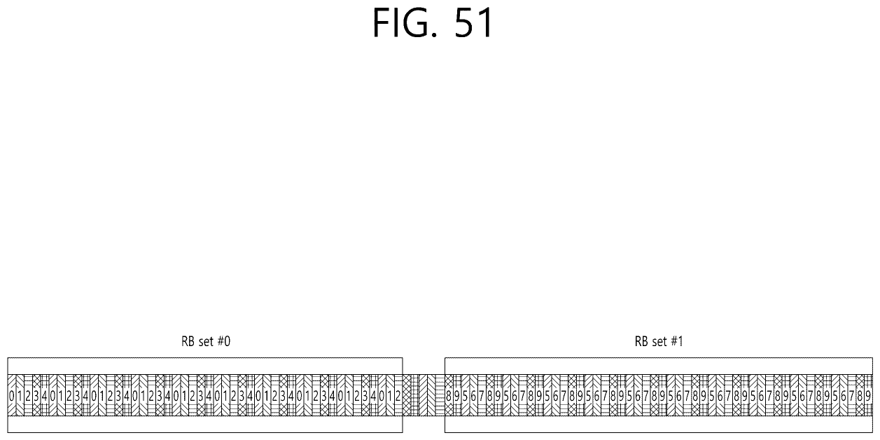

FIG. 51 shows subchannelization for PSCCH/PSSCH transmission based on interlaced RBs, according to one embodiment of the present disclosure. The embodiment of FIG. 51 may be combined with various embodiments of the present disclosure.

First of all, sub-channel may consist of PRBs belonging to one or multiple interlaces within a RB set. In this case, it may be considered that sub-channel indexing is done in increasing order of first the interlace index, and then the RB set index as shown in FIG. 51.

In this case, for example, the UE may use multiple interlaces within a RB set by using the existing contiguous sub-channel allocation indicator, and it would be beneficial in terms of channel availability. However, if the UE uses more than one RB sets for PSCCH/PSSCH transmission, it would not guarantee that the same set of interlaces are used. In this case, PAPR for PSCCH/PSSCH transmission over multiple RB sets would be increased further.

Observation 3: If a subchannel consists of PRBs corresponding to an interlace index within a RB set, and if the subchannel indexing is done in increasing order of first the interlace index, and then the RB set index, and if more than one RB sets are scheduled for PSSCH transmission, the same set of interlaces across different RB sets would not be guaranteed. It may cause high PAPR.

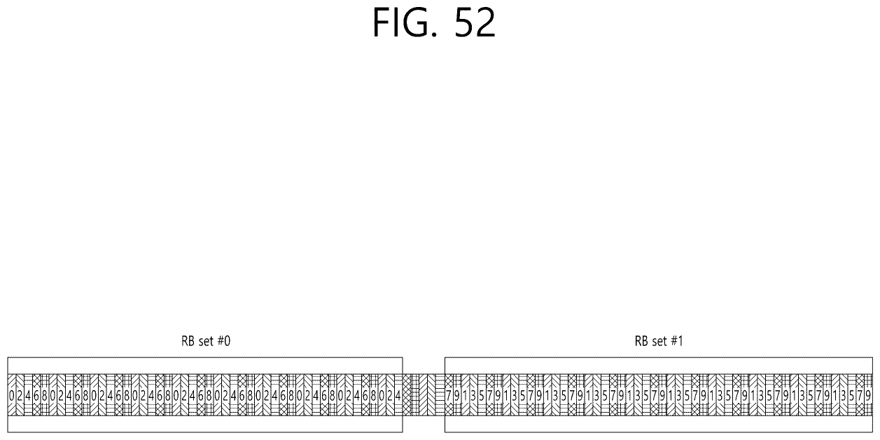

FIG. 52 shows a sub-channelization for interlaced RB-based PSCCH/PSSCH transmission, according to one embodiment of the present disclosure. The embodiment of FIG. 52 may be combined with various embodiments of the present disclosure.

Referring to FIG. 52, sub-channel indexing may be done in increasing order of first the RB set index, and then the interlace index. In this case, when the UE uses more than one RB sets for PSCCH/PSSCH transmission, the same set of interlaces could be guaranteed. However, in this approach, even though the number of sub-channels is small, multiple RB sets may be used, and it may not be good in terms of channel availability.

Observation 4: If a subchannel consists of PRBs corresponding to an interlace index within a RB set, and if the subchannel indexing is done in increasing order of first the RB set index, and then the interlace index, and if more than one interlaces are scheduled for PSSCH transmission, it may need to use multiple RB sets for PSSCH transmission. In this case, the UE may need to access both RB sets for a PSSCH transmission.

Meanwhile, considering PSD requirement, it would be necessary to support the distributed mapping of PSSCH transmission as shown in FIG. 52. For example, when a UE uses sub-channel #0 and sub-channel #1 for a PSSCH transmission, according to PSD requirement, 10 dBm may be distributed into a PRB of subchannel #0 and a PRB of subchannel #1 in FIG. 51 while 10 dBm will be allocated to both a PRB of subchannel #0 and a PRB of sub-channel #1. In the above example, the mapping of FIG. 52 may use TX power twice more than the mapping of FIG. 51.

Observation 5: Due to PSD requirement (i.e., 8 or 10 dBm/MHz), depending on the number of interlaces, it would be useful using multiple RB sets rather than using single RB set for PSSCH transmission for the same number of PRBs or interlaces.

For example, one of them may be that 1 sub-channel equals K interlaces. However, in case of 30 kHz SCS, the total number of interlaces may be 5, so if the value of K is 2 or 3, it would not be possible that the all the sub-channels consist of K interlaces. Instead, it might be needed to allow the case where different sub-channels have different number of interlaces. It would not be beneficial to ensure enabling the same TBS between initial transmission and retransmission with different set of allocated subchannels.

Observation 6: For 30 kHz SCS, since the number of interlaces is 5, the number of interlaces belonging to a subchannel may be different.

Observation 7: If contiguous sub-channel allocation indicator is reused for interlaced RB-based PSSCH transmission, depending on the sub-channelization method, the resource allocation could be inefficient in terms of channel accessibility, PAPR, and/or TX power restriction.

For example, since the sub-channelization without a separate indication of allocated RB set may lose scheduling flexibility, it would be better to consider indicating RB set separately from indicating interlaces or sub-channels. In this case, a single sub-channel may consist of PRBs belonging to a single or multiple interlaces across RB set(s).

For example, the final PRBs allocated for PSSCH transmission may be determined by intersection between the indicated sub-channel(s) and the indicated RB set(s) like NR-U resource allocation type 2. Since it would be necessary to consider how to indicate reserved resources in NR SL, FRIV may be used to indicate RB set(s) instead of RIV. In this approach, the scheduling flexibility may be maximized and the same set of interlaces across different RB sets may be guaranteed when more than one RB sets are used for PSSCH transmission.

Proposal 5: For interlaced RB based PSSCH transmission, one of followings is supported:

Option 1: For example, a subchannel may consist of PRBs belonging to K interlaces within a RB set. Subchannel indexing may be done in increasing order of first the interlace index, and then the RB set index. K may be at least 1. SCI may indicate FRIV for subchannel allocation. PSSCH transmission resource(s) may be determined by the indicated sub-channel(s). when more than one RB sets are used, UE may expect that the same set of interlaces are used.

Option 2: For example, a subchannel may consist of PRBs belonging to K interlaces within a RB set. Subchannel indexing may be done in increasing order of first the RB set index, and then the interlace index. K may be at least 1. SCI may indicate FRIV for subchannel allocation. PSSCH transmission resource(s) may be determined by the indicated sub-channel(s).

Option 3: For example, a subchannel may consist of PRBs belonging to K interlaces. Subchannel indexing may be done in increasing order of the interlace index. K may be at least 1. SCI may indicate FRIV for subchannel allocation and FRIV for RB set allocation. PSSCH transmission resource(s) may be determined by the intersection of indicated sub-channel(s) and indicated RB set(s).

For example, to save bit field size for FRIV indicating RB set(s), it may be further considered to combine Option 1 and Option 2. For example, additional one bit indicator may be used to indicate the sub-channel mapping rule between option 1 and option 2.

Next, for example, for PSCCH mapping, it may be considered that all or a subset of PRBs belonging to the lowest subchannel within the lowest RB set allocated for PSSCH transmission is used.

According to an embodiment of the present disclosure, (Proposal 6), PSCCH may be mapped on the lowest subchannel within the lowest RB set allocated for PSSCH transmission.

2.2. Time domain resource assignment for PSCCH/PSSCH on shared spectrum
2.2.1. Additional starting symbol(s) within a slot

For example, additional starting symbol(s) within a slot for PSCCH/PSSCH transmission to handle LBT failure may be introduced. For example, one possible approach may be to support sub-slot-based PSCCH/PSSCH transmission. In other words, two PSSCH transmissions with 7 or 6 symbol duration including AGC symbol and TX-RX switching symbol may be allowed in a slot for normal CP or extended CP, respectively. However, in this case, PSFCH resource(s) cannot be (pre)configured in the SL resource pool since PSSCH DMRS pattern is not defined for the PSSCH symbol duration including AGC symbol less than 5.

Observation 8: For sub-slot-based PSCCH/PSSCH transmission, if two PSSCH transmissions with 7-symbol duration including AGC symbol and TX-RX switching period are allowed in a slot (for normal CP case), PSFCH resource(s) cannot be allocated since the proper PSSCH DMRS pattern is not defined.

For another approach, for example, there may be support multiple starting positions of slot-based PSCCH/PSSCH transmission. In this case, when UE fails to access channel before the earlier starting position, then the UE may attempt to access the channel for the next starting position for a PSCCH/PSSCH transmission. When UE prepares the PSCCH/PSSCH transmission with later starting position after determining LBT failure for the earlier starting position, the processing time budget would not be sufficient.

Alternatively, for example, it may be considered that the UE prepares multiple OFDM waveforms for multiple starting positions in advance. However, in this case, the UE may need to have sufficient storage to store multiple waveforms with multiple starting positions. Even for this case, it may be necessary to have sufficient processing time budget for switching proper waveforms. Moreover, it may be necessary to check whether or how to ensure enabling the same TB size among PSSCH transmission candidates with different starting positions. To alleviate this problems, it may be considered that the UE punctures some earlier OFDM symbols after determining LBT failure, but this approach also needs to consider whether or how to avoid puncturing 1st SCI and/or 2nd SCI.

Observation 9: It may be necessary to carefully investigate the feasibility on that UE prepares and performs the next PSSCH transmission with the next starting symbol after UE decide LBT failure for the 1st starting symbol in terms of processing time budget and UE complexity. Moreover, it may be necessary to ensure the same TB size among PSSCH transmission(s) with different starting symbol(s).

For example, since PSCCH transmission may be confined within the PSSCH transmission, if more than one starting positions are allowed, the PSCCH transmission candidates would be also increased. In this case, the PSSCH RX UE may need to perform blind decoding for multiple starting positions. Moreover, the PSSCH RX UE may perform AGC procedure for each starting position. Since these additional AGC symbol would be not be used for decoding, the throughput performance would be also degraded.

Observation 10: If additional starting symbol(s) within a slot for slot-based PSCCH/PSSCH transmission is allowed, the PSSCH RX UE may need to perform AGC procedure for each starting symbol, and it may cause throughput degradation.

In those points of views, supporting additional starting symbol(s) within a slot for the PSCCH/PSSCH transmission may be deprioritized. To finalize the essential parts for SL-U operation first may be necessary.

### 2.2.2. SL Transmission Burst Structure

For example, to minimize overhead for channel sensing operation, it may be considered to introduce SL burst transmission for the same TB and/or different TBs. For burst transmission, gNB or UE may skip LBT operation for consecutive DL or UL transmissions without gaps after the gNB or UE accesses the channel according to channel access procedure, respectively.

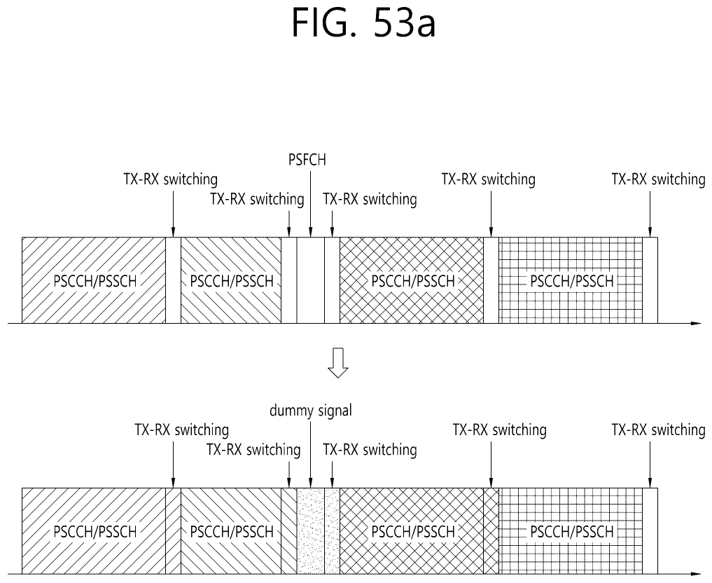

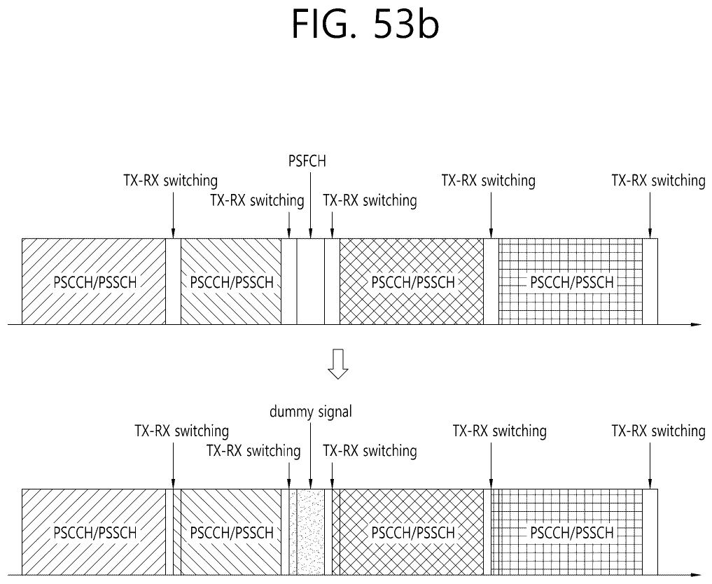

FIG. 53a and FIG. 53b show resources related to SL burst transmission, according to one embodiment of the present disclosure. The embodiments of FIG. 53a and FIG. 53b may be combined with various embodiments of the present disclosure.

Meanwhile, according to SL slot structure, the last SL symbol may be used for TX-RX switching period, and any SL channel/signals may be not mapped on the last SL symbol. In this case, at least for SL burst transmission, it would be necessary how to reduce or remove TX-RX switching period in SL slot.

For one simply way, for example, a method for implicitly or explicitly indicating whether or not to use the last SL symbol for SL transmission to PSCCH/PSSCH TX UE is proposed. In this case, the TX UE may perform rate-matching for the last SL symbol as shown in FIG. 53(a).

As another approach, for example, a method for performing CP extension to use all or a subset of TX-RX switching symbol of the earlier SL transmission of the TX UE as shown in FIG. 53(b) is proposed.

Proposal 7: For SL transmission burst, time gap between adjacent PSCCH/PSSCH transmissions may be not greater than 16usec.

To fill out all or a subset of TX-RX switching symbol, down-select one of followings: Alt 1: Extended CP of the later SL transmission may occupy part of TX-RX switching symbol of the earlier SL transmission. Alt 2: Parts of a SL transmission may occupy part of TX-RX switching symbol of the SL transmission.

Moreover, depending on the SL BWP (pre)configuration, it may be possible that SL transmission resource presents in the middle of a slot, and this slot structure may be applied to all the SL slots. In this case, even though multiple SL channels/signals are mapped on consecutive slots, there time gap may exist between two consecutive SL transmissions. To support SL burst transmission, it would be necessary to fix the value of sl-StartSymbol to 0 and to fix the value of sl-LenthSymbols to 14 for normal CP or 12 for extended CP. Similarly, consecutive physical slots may also need to be belonging to a resource pool for SL burst transmission.

For example, in SL slot structure, PSFCH resource may be TDMed with PSCCH/PSSCH resource within a slot, and the maximum PSFCH resource period is 4 logical slots. For example, in this case, the maximum duration of SL burst transmission would be also limited to 4 slots. To extend the time duration of the SL burst transmission, one way is to increase the maximum PSFCH resource period. Alternatively, for example, it may be considered that the TX UE transmit any signal in a PSFCH occasion to ensure the time gap between transmission(s) is no greater than 16usec.

Proposal 8: For SL transmission burst, down-select one or more of followings: Option 1: Maximum size of SL transmission burst may be determined by PSFCH resource period. Option 2: PSSCH TX UE may transmit any signal in a PSFCH occasion to ensure the time gaps between transmissions within a SL transmission burst is no greater than 16usec.

2.3. SL HARQ procedure

For example, new PSFCH format and/or multiple chances of PSFCH transmission in response of a PSSCH transmission may be configured to be introduced.

Unlike Uu link, a TX UE may transmit PSSCH transmissions to different RX UEs, and then the TX UE may receive a number of SL HARQ-ACK feedbacks from different RX UEs. In this case, each RX UE may transmit one SL HARQ-ACK information to the same TX UE. In this case, for example, rather than new PSFCH format with large payload size, the existing PSFCH format 0 may be sufficient for the container of the SL HARQ-ACK feedback. Moreover, since new PSFCH format with large payload size would have no or small multiplexing capacity, the overall PSFCH resource overhead would be too large.

Observation 11: Since PSSCH TX UE may receive a number of SL HARQ-ACK feedbacks from different PSSCH RX UEs, R16 NR SL PSFCH format 0 may be sufficient for the container of the SL HARQ-ACK feedback.

For example, in PSSCH-to-PSFCH mapping, the implicit mapping rule is adopted rather than dynamic indication of PSFCH resources. It may be because of the fact that if the dynamic indication is adopted, the PSSCH TX UE may need to perform sensing operation for PSFCH further. Since, for example, the SL HARQ-ACK enabling/disabling and SL-HARQ-ACK feedback option indicators are present in 2nd SCI, the TX UE would need to success to decode 2nd SCI of other UEs as well for sensing operation. For example, if the TX UE does not perform such sensing operation for PSFCH, even though PSSCH resource collision does not occur, PSFCH resource may be collided.

Observation 12: If the locations of PSFCH resources are dynamically indicated, UE may need to perform sensing operation for PSFCH further. Otherwise, even though PSSCH resources are not overlapping each other, PSFCH resource collision may occur.

Regarding LBT failure handling for PSFCH transmission, it would be necessary to check the progress in channel access mechanism for PSFCH transmission. To be specific, for example, if UE-to-UE COT sharing may be applied to PSFCH transmission in response of the received PSSCH transmission, the PSFCH transmission dropping due to LBT failure would be alleviated.

Observation 13: If UE may share COT initiated by UE transmitting PSCCH/PSSCH for PSFCH in response of the PSCCH/PSSCH, the PSFCH TX dropping problem due to LBT failure would be mitigated.

For example, if multiple PSFCH transmission chances to handle PSFCH transmission dropping due to LBT failure is considered, there could be two domains to be considered.

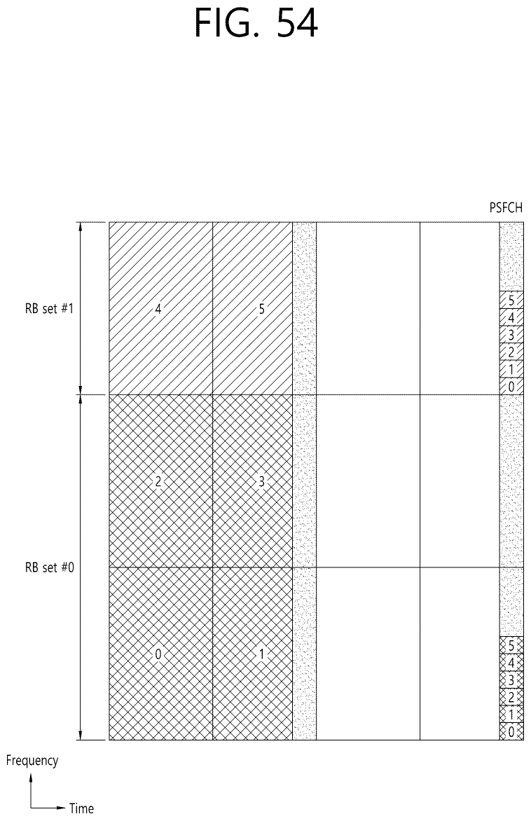

FIG. 54 shows a PSSCH-to-PSFCH mapping that takes into account the dropping of a PSFCH transmission due to LBT failure, according to one embodiment of the present disclosure. The embodiment of FIG. 54 may be combined with various embodiments of the present disclosure.

To be specific, since the sensing results could be different across different RB sets, it may be considered that the UE attempts to access multiple RB sets to transmit a single PSFCH transmission. In this case, once the UE successes to access at least one RB set, then the UE may use the PSFCH resource within the RB set for PSFCH transmission.

For example, to avoid sensing operation for PSFCH, the implicit mapping rule may be used. For instance, PRB groups for PSFCH transmission is (pre)configured in each RB set, and the prior (licensed band) PSSCH-to-PSFCH resource determination rule may be applied to each RB set. FIG. 54 shows an example of PSSCH-to-PSFCH mapping for each RB set. In this example, the PSSCH transmission with index n may be associated with PSFCH resource with index n.

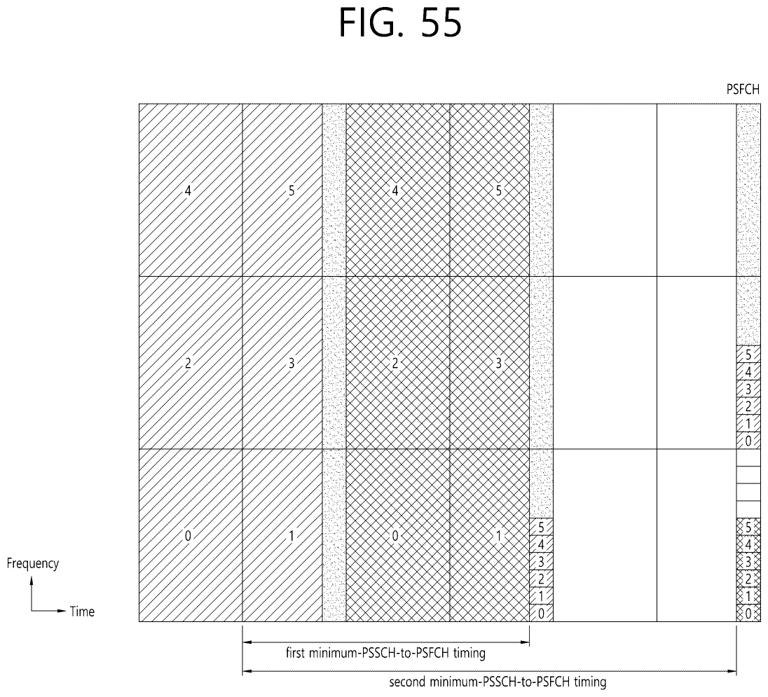

FIG. 55 shows a PSSCH-to-PSFCH mapping for handling PSFCH TX dropping due to LBT failure, according to one embodiment of the present disclosure. The embodiment of FIG. 55 may be combined with various embodiments of the present disclosure.

For example, another domain may be to increase the PSFCH occasions associated with the same PSSCH slot. To do this, it may be considered that UE is (pre)configured with more than one sl-MinTimeGapPSFCH and the difference between minimum timing values will be larger than or equal to the value of PSFCH resource period. In this case, for a given PSSCH slot, there could be more than one PSFCH occasions to be associated with the PSSCH slot. To avoid PSFCH resource collisions between different PSSCH-to-PSFCH timeline, PRB groups for PSFCH transmission may be (pre)configured in each timeline, and the existing PSSCH-to-PSFCH resource determination rule (of licensed band) may be applied to each timeline.

FIG. 55 shows an example of PSSCH-to-PSFCH mapping for each timeline. Here, the PSSCH transmission with index n may be associated with PSFCH resource with index n. For example, this approach may not be suitable for the case when the PDB is limited. Alternatively, for example, instead of multiple PSFCH slots, it may be considered to allow multiple PSFCH occasions in a slot. However, it would require the huge specification work for multiplexing PSCCH/PSSCH/PSFCH in a slot.

In the above approaches, it may require additional frequency resources for PSFCH transmissions. Therefore, this approach would be applicable when a single PRB is used for PSFCH transmission. On the other hand, if a number of PRBs are used for PSFCH transmission as in interlaced RB-based PSFCH transmission, it would not be possible to reserve frequency domain resources for PSFCH transmission further for this purposes. In other words, mechanisms for handling PSFCH TX dropping due to LBT failure would not be applicable to all the type of PSFCH transmissions.

According to an embodiment of the present disclosure, (Proposal 9), For handling PSFCH format 0 transmission dropping due to LBT failure, followings may be discussed: Option 1: UE may try to transmit SL HARQ-ACK feedback on PSFCH resource in the next RB set. For example, the existing (licensed band, Rel-16) NR SL PSSCH-to-PSFCH resource determination rule may be applied to each RB set. Also, UE may use PSFCH resource in the RB set which UE successes to access. Option 2: UE may try to transmit SL HARQ-ACK feedback on PSFCH resource in the next PSFCH occasion. For example, for each min-PSSCH-to-PSFCH timing, UE may be (pre)configured with different PRB groups for PSFCH resources. The existing (licensed band, Rel-16) NR SL PSSCH-to-PSFCH resource determination rule may be applied to each PSFCH occasion.

For example, PSFCH occasions may be present in the same slot or different slots. For example, a UE may use PSFCH resource in the earliest PSFCH occasion which UE successes to access the channel.

Meanwhile, in the existing technology (Rel-16/17) NR SL, PSFCH TX or RX could be dropped according to PSFCH TX/RX prioritization rule based on SL priority value. In this case, it would be necessary to support that UE may perform PSFCH reception(s) if the UE fails to access the channel for prioritized PSFCH TX(s). For example, even for PSFCH TX/TX collisions, it would be beneficial to transmit deprioritized PSFCH transmission instead of prioritized PSFCH transmission when the UE drops the prioritized PSFCH transmission due to LBT failure.

According to an embodiment of the present disclosure, (Proposal 10), if a UE fails to access channel for PSFCH transmission, then the UE may perform deprioritized PSFCH reception(s) instead.

According to an embodiment of the present disclosure, (Proposal 11), if a UE tries to access channel for each PSFCH transmission, and if the UE fails to access channel for PSFCH transmission with smaller SL priority value, then the UE may transmit PSFCH transmission with larger SL priority value.

Alternatively, for example, it may be considered that a UE handles PSFCH TX/RX collisions for the PSFCH transmission(s) after passing the LBT procedure.

For example, in case of PSFCH transmission, considering multiplexing capacity, the interlaced transmission could be considered rather than wideband transmission. Since the PSFCH format 0 is designed based on PUCCH format 0, and the PUCCH format 0 have interlaced transmission form, it may be considered that interlaced transmission form of PUCCH format 0 is considered as a baseline for interlaced PSFCH transmission.

For example, since the number of PRBs for a single PSFCH transmission would be highly increased, it would be necessary to check whether the number of PSFCH resources are sufficient. To increase the number of PSFCH resources, it may be considered to apply time-domain and/or frequency-domain OCC to PSFCH transmission. For example, in case of time-domain OCC, it would be necessary to carefully investigate the impact of power imbalance across different symbols due to OCC. The power imbalance in time domain would have negative impact on the AGC performance. Moreover, since first symbol may be used for AGC, time-domain OCC would not be always feasible for all the UEs. For example, in case of frequency-domain OCC, PAPR needs to be checked. Alternatively, for example, it may be considered to introduce comb structure for the interlaced PSFCH transmission. However, in this case, the number of cyclic shift pairs could be reduced, so total number of PSFCH resources would not be large enough.

For example, when the PSFCH resource is associated with RB set index and interlaced index, it would be necessary to modify the implicit PSSCH-to-PSFCH resource determination rule as well. According to Rel-16 NR SL, subchannel index and slot index of PSSCH are used to determine RB sub-group of PSFCH, and source ID of PSSCH is used to determine RB index within the RB sub-group and cyclic shift pair index.

For example, for interlaced PSFCH transmission, it would be necessary to define how RB set index and interlace index of PSFCH are derived from PSSCH resource and source ID. For example, due to limited number of frequency resources of the interlaced RB-based PSFCH transmission, subgrouping would need to be extended to code-domain resources. For example, the UE may determine, the subset of interlaces and RB sets and cyclic shifts pairs based on subchannel, RB set, and slot associated with PSSCH transmission. Then, the UE may finally select PSFCH resource within the subset of PSFCH resource candidates based on source ID and/or M_ID.

According to an embodiment of the present disclosure, (Proposal 12), for PSFCH transmission, to meet the OCB and PSD requirements, interlaced RB-based PSFCH transmission may be supported, interlaced PUCCH format 0 may be considered as a baseline, and a PSFCH structure for 60 kHz SCS may be considered.

For example, for PSSCH-to-PSFCH determination rule, among (pre)configured set of interlaces, RB sets, and cyclic shift pairs for PSFCH transmission, PSFCH resource indexing may be done in increasing order of first interlace index, and then RB set index, and then cyclic shift pair index. For example, set of PSFCH resources may be partitioned by the RB set of PSSCH, and then may be partitioned by the interlace of PSSCH, and then is partitioned by PSSCH slot. For example, within the subset of PSFCH resources, the UE may select final PSFCH resource index based on source ID and/or M_ID. For example, in this approach, unlike Rel-16 NR SL, it may be allowed CDM among PSFCH resources associated with PSSCH transmission of which resources are TDMed and/or FDMed.

2.4. Synchronization procedure and channels

For example, depending on the regulation, S-SSB transmission may also need to meet the OCB requirement and PSD requirement. For this purpose, a number of options may be listed up.

For example, on the time domain resources for S-SSB, unlike NR-U, S-SSB transmission may be performed by a UE of which TX power would be limited. In Rel-16 NR SL, 2-symbol duration of S-PSS and S-SSS could achieve energy combining gain. In that point of view, at least for S-PSS and S-SSS may need to have 2 symbol duration as in Rel-16 NR SL. Moreover, considering that the first symbol of S-SSB is used for AGC, even if 1 symbol duration is used for both S-PSS and S-SSS, only one symbol may be effectively used to decode PSBCH for the 4 symbol duration of S-SSB transmission. It may restrict SL communication coverage and make SL transmissions asynchronous.

Observation 14: Considering coverage of SL communication the S-SSB structure in time domain (i.e., 2-symbol S-PSS and 2-symbol S-SSS) may need to be kept to achieve energy combining gain.

According to an embodiment of the present disclosure, (Proposal 13), for S-SSB in SL-U, R16 S-SSB structure in time domain may be reused (i.e., 14-symbol duration of S-SSB for normal CP, and 12-symbol duration of S-SSB for extended CP).

For example, Type 2A channel access procedure would be applicable for the S-SSB transmission when the total duration of the S-SSB transmission in UE perspective or in system perspective meets the duty-cycle requirements as in NR-U DL. For example, to increase channel availability, it would be better to (pre)configure the time domain locations of S-SSB resources so that the transmission(s) duration is at most 1 ms, and the duty cycle is at most 1/20 to use Type 2A channel access procedure.

Observation 15: Time domain locations of S-SSB resources may need to be determined based on the condition to use Type 2A DL channel access procedure for DL discovery burst transmissions, which is that the transmission(s) duration is at most Ims, and the duty cycle is at most 1/20 to use Type 2A channel access procedure.

For example, within a COT duration, the UE may not need to fulfil the OCB requirement temporarily as follows: 1) during a Channel Occupancy Time (COT), equipment may operate temporarily with an occupied bandwidth of less than 80% of its nominal channel bandwidth. The occupied bandwidth shall not be less than 2 MHz. 2) Since S-PSS and S-SSS start from the second symbol of S-SSB, it may be understood that both S-PSS and S-SSS would be within the COT duration. In this case, it would be possible to reuse the existing S-PSS and S-SSS sequences without a consideration of the OCB requirement. However, in this case, due to the PSD requirement, the total power of the S-PSS and S-SSS would be too small, and it may cause SL communication coverage reduction.

Observation 16: According to EN 301 893, the temporary exemption of OCB requirement may be applicable at least for S-PSS and S-SSS. However, due to PSD requirement, the communication coverage would be too restrictive.

For example, in case of interlaced RB-based S-SSB transmission, it would be possible to reuse the existing sequences if the number of PRBs belonging to one interlace within a RB set is 11. Otherwise, it would be necessary to use two interlaces for S-SSB transmission. For example, if two interlaces within a RB set is used for S-SSB transmission, due to PSD requirement, the TX power would be limited compared to the case when one interlace is used.

Observation 17: For interlaced RB-based transmission for S-SSB, depending on the number of PRBs associated with a single interlace, it would be necessary to use two interlaces for S-SSB transmission to ensure bandwidth of 11 PRBs.

Observation 18: For interlaced RB-based transmission for S-SSB, if two interlaces are used, the PSD would be halved compared to the case when single interlace is used due to PSD requirement.

In NR-U, the interlaced structure is defined for 15 kHz SCS and 30 kHz SCS, but not for 60 kHz SCS. Meanwhile, in NR SL of the existing technology (Rel-16), for FR1, S-SSB transmission is supported for 60 kHz. For 60 kHz SCS, it would be necessary to define interlaced structure or to adopt another approach for the OCB requirement. For example, the PRB gap between interlaces may be 10 or 5 for 15 kHz or 30 kHz, respectively. Since 5/2 is not an integer, there may be various methods for designing interlace structure for 60 kHz.

Observation 19: For 60 kHz SCS, since interlace structure is not defined in NR-U, interlaced RB-based S-SSB transmission would not be straightforward.

Moreover, in NR-U, since the interlaced RB-based transmission is a part of the UE capability, it would be possible that UEs without the capability cannot relay the received S-SSB transmission. In this case, the system performance of the synchronization procedure and the subsequent Mode 2 operation would be degraded further due to the synchronization error.

Observation 20: For interlaced RB-based S-SSB transmission, UEs without interlaced RB-based transmission cannot relay the received S-SSB transmission, and it may cause system performance degradation due to synchronization error.

For example, for the OCB and PSD requirement, repetition of S-SSB in frequency domain is proposed. However, in this case, PARP could be highly increased. To alleviate this high PAPR problem, at least S-PSS and S-SSS could be repeated with phase adjustment while a PSBCH is transmitted in wideband transmission manner.

Observation 21: Repetition of S-SSB in frequency domain would increase PAPR, and it may further reduce coverage.

In NR-U, wideband PRACH transmission is introduced for OCB and PSD requirements. To design wideband S-SSB transmission, it may be considered to reuse target bandwidth of wideband PRACH transmission in NR-U. However, for different length of the M-sequence or Gold sequence, it would be necessary to find new polynomials and input polynomials.

Observation 22: For S-SSB with wider bandwidth, it would be necessary to find new polynomials and input polynomials for each SCS. It would highly increase specification work load.

Proposal 14: For S-SSB in SL-U, by supporting Option 1, OCB and PSD requirement for S-SSB transmission may be met.

Option 1: Using interlaced RB transmission. For details, down-select one of followings:

R16 S-PSS/S-SSS/PSBCH may be mapped on 11 PRBs associated with one or two interlaces within a RB set. A (pre)configuration may provide the RB set(s) and interlace(s) for S-SSB mapping.

### Option 1-2:

R16 S-PSS/S-SSS/PSBCH may be mapped on PRBs associated with one interlace within a RB set. If the number of PRBs associated with the interlace within the RB set is smaller than 11 PRBs, parts of sequences may be truncated. A (pre)configuration may provide the RB set(s) and interlace(s) for S-SSB mapping.

### Option 1-3:

R16 S-PSS/S-SSS/PSBCH may be mapped on 11 PRBs equally distributed over a RB set. PRB gap may be implicitly or explicitly determined. A (pre)configuration may provide the RB set(s) and/or PRB gap for S-SSB mapping.

For example, whether or not the above rules are applied (and/or the values of the parameters related to the proposed schemes/rules of this disclosure) may be configured/enabled (and/or the application of the above rules may be configured/enabled limitedly) specifically (or, differently, or, independently), for at least one among elements/parameters of (or per), a service type (and/or a (LCH or service) priority and/or a QOS requirement (e.g., latency, reliability, minimum communication range) and/or a PQI parameter) (and/or a HARQ enabled (and/or disabled) LCH/MAC PDU (transmission) and/or a CBR measurement value of a resource pool and/or SL cast type (e.g., unicast, groupcast, broadcast) and/or an SL groupcast HARQ feedback option (e.g., a NACK only feedback, an ACK/NACK feedback, a TX-RX distance based NACK only feedback) and/or an SL MODE 1 CG type (e.g., SL CG type 1/2) and/or an SL mode type (e.g., mode 1/2) and/or a resource pool and/or whether it is a resource pool in which a PSFCH resource is configured and/or a case in which a periodic resource reservation operation (and/or an aperiodic resource reservation operation) is enabled/configured (or not enabled/configured) on a resource pool and/or a case in which a partial sensing operation (and/or a random resource selection operation (and/or a full sensing operation)) is enabled/configured (or not enabled/configured) on a resource pool and/or a source (L2) ID (and/or destination (L2) ID) and/or a PC5 RRC connection link and/or an SL link and/or a connection state (with a base station) (e.g., RRC CONNECTED state, IDLE state, INACTIVE state) and/or an SL HARQ process (ID) and/or whether it is an SL DRX operation is performed (of a transmitting UE or a receiving UE) and/or whether it is a power saving (transmitting or receiving) UE and/or a case where a PSFCH TX and a PSFCH RX (and/or a plurality of PSFCH transmissions (whose UE capability is exceeded)) overlaps (and/or a case where a PSFCH transmission (and/or a PSFCH reception) is omitted) (in the perspective of a specific UE) and/or a case where a receiving UE (successively) actually received from a transmitting UE a PSCCH (and/or PSSCH) (re)transmission and/or a case where a (transmitting) UE performing a packet transmission (and/or transmission resource (re)selection) performs a power saving operation (and/or an SL DRX operation) and/or a case where a target (receiving) UE of a transmission packet performs a power saving operation (and/or an SL DRX operation) and/or a case where a remaining PDB value related to a transmission packet is greater than equal to a pre-configured threshold value (or less than or equal to) and/or a case of an initial transmission (and/or a retransmission) (related to a TB) and/or a case where an interlace based structure (RB) is applied and/or a case where (pre-configured) channel access type (e.g., type 1, type 2A, type 2B, type 2C, semi-static channel occupancy) is performed and/or a case where a transmission/reception of an (pre-configured) SL channel/signal (e.g., SL SSB, PSCCH, PSSCH, PSFCH) is performed and/or an RB set (and/or a channel and/or a carrier) (for which a channel access operation is performed in an unlicensed band) and/or COT(channel occupancy time) and/or a TX burst and/or a discovery burst), etc. In addition, a combination of the proposed schemes (and/or proposed rules and/or embodiments) described in this disclosure may be applied.

Furthermore, the word “configuration” (or “designation”) in this disclosure may be broadly interpreted to a form of informing a UE through a predefined (physical layer or higher layer) channel/signal (e.g., SIB, RRC, MAC CE) (and/or, a form being supporting through a pre-configuration, and/or, a form of informing another UE through a predefined (physical layer or higher layer) channel/signal (e.g., SL MAC CE, PC5 RRC)), etc.

In addition, the “PSFCH” wording in this disclosure may be (inter) expanded interpreted as “(NR or LTE) PSSCH (and/or (NR or LTE) PSCCH) (and/or (NR or LTE) SL SSB (and/or UL channel/signal))”.

Further, the proposed schemes in this disclosure may be combined with each other and extended (into new forms of schemes) to be used. Furthermore, in this disclosure, the wording “active time” (and/or “on-duration”) wording in this disclosure may be (inter) expanded interpreted as “on-duration” (and/or “active time”).

According to one embodiment of the present disclosure, the scheme for determining a contention window size may be a scheme where a plurality of schemes are mixed and matched. For example, the scheme may be a scheme that, when there are multiple SL HARQ-ACK feedback groups referenced, the result determined based on a representative HARQ-ACK value of each group maintains the CWₚ value for all or each CAPC and/or a scheme that increases the CWₚ value for all or each CAPC to the next allowable value if the result is not to initialize to the initial value.

For example, if there are multiple factors referenced in configuring the contention window size, and if a result that increases the CWₚ value to the next allowable value and maintaining or initializing the CWₚ value occur simultaneously as a result of the determination of each factor, the CWₚ value may be maintained and/or the CWₚ value may be initialized to a minimum value.

For example, if there are multiple factors that are referenced in configuring the contention window size, and if a result that increases the CWₚ value to the next allowable value and maintaining or initializing the CWₚ value occur simultaneously as a result of the determination of each factor, the CWₚ value may be increased to the next allowable value.

According to one embodiment of the present disclosure, the PSCCH/PSSCH referenced to determine the contention window size may be received within a specific time interval. For example, the specific time interval may exist within the earliest SL channel occupancy interval after the UE last updated its CWₚ.

According to one embodiment of the present disclosure, an operation in which CWₚ is initialized to a minimum value may be replaced by another specific value (e.g., a (pre-)configured value), and/or the specific value may be configured differently according to factors that control the size of the contention window.

In various embodiments of the present disclosure, for example, The reference duration may be an interval i) from the start of channel occupancy for a COT occupied by a UE (for sidelink communication) and/or a COT occupied by a base station (for sidelink communication) to the end of the first slot in which an actual specific sidelink transmission is performed for all allocated resources for sidelink transmission, or ii) to the end of the first transmission burst including an actual specific sidelink transmission for all allocated resources for sidelink transmission, or iii) to an earlier time point between the above end points. For example, the specific sidelink transmission may be a PSCCH/PSSCH transmission for unicast and/or groupcast and/or PSCCH/PSSCH with SL HARQ-ACK feedback enabled. For example, the length of the reference interval may be (pre-)configured per resource pool and/or per SL priority value of the SL transmission of a UE when the COT is initialized.

In various embodiments of the present disclosure, different combinations of the above may be used, for example, according to whether the COT duration is initialized by a UE or a base station.

In various embodiments of the present disclosure, for example, adjusting the size of the contention window for sidelink may be performed per unicast session (group) and/or per cast type and/or per transmission priority value and/or per SL transmission with SL HARQ-ACK feedback enabled/disabled and/or per SL HARQ-ACK feedback option, respectively. For example, the processes of adjusting the size of the contention window may be performed for each case of a first UE transmitting an SL to a second UE and transmitting an SL to a third UE, respectively. For example, when adjusting the size of the contention window based on HARQ-ACK, the HARQ-ACK may be limited to a specific cast type and/or a specific unicast session.

In various embodiments of the present disclosure, for example, adjusting the size of the contention window for sidelink may be performed only based on a specific cast type (e.g., unicast or group cast) and/or PSSCH with SL HARQ-ACK feedback enabled.

In various embodiments of the present disclosure, for example, initializing the value of CW_p to the respective minimum value may be applied by replacing it with decreasing the value of CW_p to the previous allowable value.

For example, when accessing a TYPE 1 SL channel, the size of the contention window may be (pre-)configured per priority class and/or per SL priority and/or per resource pool. For example, in any of the above cases, an operation to separately adjust the size of the contention window may not be performed by the UE.

In various embodiments of the present disclosure, for example, in a channel sensing operation according to a channel access type, a threshold value for determining whether a channel is busy or idle may be (pre-)configured, and/or predefined per resource pool, and/or per SL BWP, and/or per an RB set, and/or per a carrier, and/or per an SL transmit priority, and/or per a representative transmit power value (range), and/or per a congestion control level.

Various embodiments of the present disclosure may be applied in different combinations of the above, for example, depending on whether the transmissions are within or outside the COT (channel occupancy time). Various embodiments of the present disclosure may be applied in the different combinations differently according to the form of the COT (e.g., semi-static or time-varying). For example, in a semi-static COT, the absence of other technologies sharing the same channel or RB set may be guaranteed for a period of time, such as by regulation. For example, in the semi-static COT for SL transmission, the absence of DL and/or UL transmissions sharing the same channel or RB set for a certain period of time may be guaranteed, such as by regulation. For example, in the semi-static COT, the absence of SL transmission sharing the same channel or RB set may be guaranteed for a certain period of time, such as for DL and/or UL transmission. For example, in the semi-static COT, the absence of SL transmissions based on SL mode 2 resource (re)selection sharing the same channel or RB set for a certain period of time may be guaranteed, such as by regulation.

For example, the length of the fixed-frame period (FFP) and/or the time axis offset value for the semi-static COT duration may be (pre-)configured per resource pool and/or per SL BWP and/or per carrier and/or per an RB set and/or per congestion control level and/or per SL transmit priority value. For example, the length of the fixed-frame period (FFP) and/or the time axis offset value for the semi-static COT duration may be configured via PC5-RRC signaling between UEs. For example, the (pre-)configured FFP may be overwritten via the PC5-RRC signaling. For example, the FFP configured to the PC5-RRC may be used limitedly for unicast transmission corresponding to the PC5-RRC connection. Various embodiments of the present disclosure may be applied in the form of different combinations of the above, according to different carriers, with or without guards between RB sets, or according to regulations.

While various embodiments of the present disclosure describe changing the contention window size for all CAPCs, the ideas of the present disclosure may be extended to include changing the contention window size per specific CAPC or SL priority value.

In various embodiments of the present disclosure, for example, the scheme may be applied differently per SL channel, depending on the type of channel access and whether/how it is indicated. In various embodiments of the present disclosure, for example, with respect to the type of channel access and whether/how to indicate, the above scheme may be applied differently depending on the type of information included in the SL channel.

For example, the proposed method may be applied to devices described below. First, a processor 202 of a receiving UE may configure at least one BWP. Then, the processor 202 of the receiving UE may control a transceiver 206 of the receiving UE to receive a sidelink-related physical channel and/or a sidelink-related reference signal from the transmitting UE over the at least one BWP.

When selecting the transmission resource for a plurality of MAC PDU transmissions respectively, it may be determined whether the resource selection performed temporally later is to be performed as a contiguous resource selection. Since PSFCH is supported in NR and HARQ feedback for multiple PSSCHs may be transmitted on a PSFCH resource, which may generate large power, AGC saturation issues may occur when LTE resources occupied prior to the PSFCH resource overlap with NR PSFCH resources. For example, when a UE selects multiple SL grant related resources, it may be desired that the different SL grant related resources are located as close as possible (in time domain) to each other (to avoid blocking other SL grant related LBT operations). Here, whether or not such an operation is applied may be determined based on the (maximum) CAPC value of the different SL grant-related data. Further, when the above operation is applied, when performing the LCP procedure for generating MAC PDUs transmitted over different SL grants, for example, the CAPC value of the MAC PDU transmitted over the preceding SL grant may be greater than or equal to the CAPC value of the MAC PDU transmitted over the lagging SL grant.

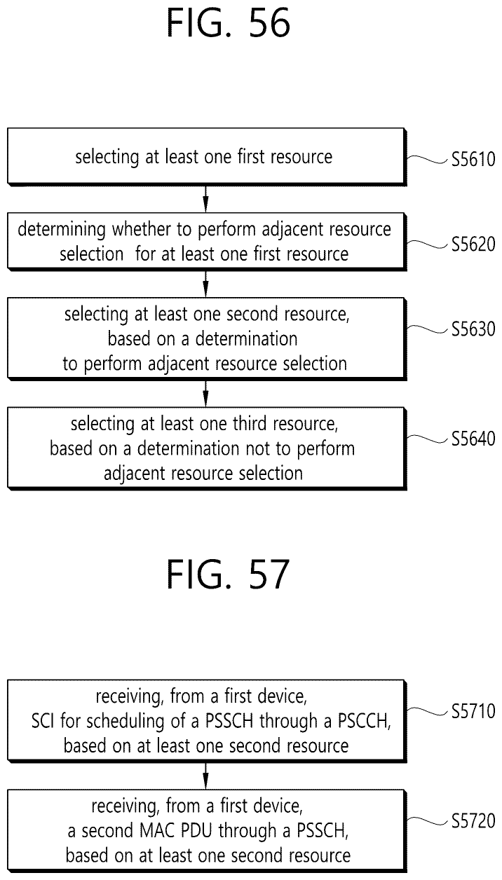

FIG. 56 shows a procedure for a first device to perform wireless communication, according to one embodiment of the present disclosure. The embodiment of FIG. 56 may be combined with various embodiments of the present disclosure.

Referring to FIG. 56, in step S5610, a first device may select at least one first resource. In step S5620, the first device may determine whether to perform contiguous resource selection for the at least one first resource. In step S5630, the first device may select at least one second resource, based on the determination to perform the contiguous resource selection. For example, based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and based on the earliest resource among the at least one second resource not preceding the at least one first resource, the first CAPC value may be greater than or equal to the second CAPC value. In step S5640, the first device may select at least one third resource, based on the determination not to perform the contiguous resource selection. For example, a first sensing duration and a first frequency of channel sensing for a channel access procedure (CAP) related to the at least one first resource may be not overlapped with the at least one third resource, and a third sensing duration and a third frequency of channel sensing for a CAP related to the at least one third resource may be not overlapped with the at least one first resource.

For example, a second channel sensing duration or a second frequency of channel sensing for a CAP related to the at least one second resource may be overlapped with the at least one first resource, or the first channel sensing duration and the first frequency may be overlapped with the at least one second resource.

For example, the contiguous resource selection may be determined to be performed, based on the second CAPC value being greater than or equal to the first CAPC value, and the contiguous resource selection may be determined not to be performed, based on a third CAPC value related to a third MAC PDU to be transmitted based on the at least one third resource being less than the first CAPC value.

For example, the contiguous resource selection may be determined not to be performed, based on the third CAPC value being greater than or equal to the first CAPC value, and the contiguous resource selection may be determined to be performed, based on the second CAPC value being less than the first CAPC value.

For example, additionally, the first device may generate the second MAC PDU including a serving data unit (SDU) related to the second CAPC value based on a logical channel prioritization (LCP) procedure, based on the determination to perform the contiguous resource selection.

For example, selection for the at least one second resource may be performed based on the generation of the second MAC PDU.

For example, the at least one second resource may be a resource after an earliest resource among the at least one first resource.

For example, channel sensing for a CAP related to the at least one second resource may be omitted.

For example, channel sensing for a CAP related to the at least one second resource may be omitted based on a result of channel sensing for a CAP related to at least one first resource being idle.

For example, a third CAPC value related to a third MAC PDU to be transmitted based on the at least one third resource may be greater than or equal to the first CAPC value.

For example, the at least one third resource may be a resource after an earliest resource among the at least one first resource.

For example, selecting the at least one third resource, based on the determination not to perform the contiguous resource selection may include: excluding a resource overlapped with the first sensing duration and the first frequency, from at least one candidate resource.

For example, at least one of the at least one first resource, the at least one second resource, or the at least one third resource may be in an interlace structure.

For example, additionally, the first device may perform, to a second device, a sidelink (SL) transmission, based on the at least one second resource or the at least one third resource.

The embodiments described above may be applied to various devices described below. First, a processor 102 of a first device 100 may select at least one first resource. And, the processor 102 of the first device 100 may determine whether to perform contiguous resource selection for the at least one first resource. And, the processor 102 of the first device 100 may select at least one second resource, based on the determination to perform the contiguous resource selection. For example, based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and based on the earliest resource among the at least one second resource not preceding the at least one first resource, the first CAPC value may be greater than or equal to the second CAPC value. And, the processor 102 of the first device 100 may select at least one third resource, based on the determination not to perform the contiguous resource selection. For example, a first sensing duration and a first frequency of channel sensing for a channel access procedure (CAP) related to the at least one first resource may be not overlapped with the at least one third resource, and a third sensing duration and a third frequency of channel sensing for a CAP related to the at least one third resource may be not overlapped with the at least one first resource.

According to an embodiment of the present disclosure, a first device for performing wireless communication may be proposed. For example, the first device may comprise: at least one transceiver; at least one processor; and at least one memory operably connected to the at least one processor and storing instructions that, based on being executed by the at least one processor, cause the first device to perform operations. For example, the operations may comprise: selecting at least one first resource; determining whether to perform contiguous resource selection for the at least one first resource; selecting at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and selecting at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

For example, a second channel sensing duration or a second frequency of channel sensing for a CAP related to the at least one second resource may be overlapped with the at least one first resource, or the first channel sensing duration and the first frequency may be overlapped with the at least one second resource.

For example, the contiguous resource selection may be determined to be performed, based on the second CAPC value being greater than or equal to the first CAPC value, and the contiguous resource selection may be determined not to be performed, based on a third CAPC value related to a third MAC PDU to be transmitted based on the at least one third resource being less than the first CAPC value.

For example, the contiguous resource selection may be determined not to be performed, based on the third CAPC value being greater than or equal to the first CAPC value, and the contiguous resource selection may be determined to be performed, based on the second CAPC value being less than the first CAPC value.

For example, additionally, the operations may further comprise: generating the second MAC PDU including a serving data unit (SDU) related to the second CAPC value based on a logical channel prioritization (LCP) procedure, based on the determination to perform the contiguous resource selection.

For example, selection for the at least one second resource may be performed based on the generation of the second MAC PDU.

For example, the at least one second resource may be a resource after an earliest resource among the at least one first resource.

For example, channel sensing for a CAP related to the at least one second resource may be omitted.

For example, channel sensing for a CAP related to the at least one second resource may be omitted based on a result of channel sensing for a CAP related to at least one first resource being idle.

For example, a third CAPC value related to a third MAC PDU to be transmitted based on the at least one third resource may be greater than or equal to the first CAPC value.

For example, the at least one third resource may be a resource after an earliest resource among the at least one first resource.

For example, selecting the at least one third resource, based on the determination not to perform the contiguous resource selection may include: excluding a resource overlapped with the first sensing duration and the first frequency, from at least one candidate resource.

For example, at least one of the at least one first resource, the at least one second resource, or the at least one third resource may be in an interlace structure.

For example, additionally, the operations may further comprise: performing, to a second device, a sidelink (SL) transmission, based on the at least one second resource or the at least one third resource.

According to an embodiment of the present disclosure, a device adapted to control a first user equipment (UE) may be proposed. For example, the device may comprise: at least one processor; and at least one memory operably connected to the at least one processor and storing instructions that, based on being executed by the at least one processor, cause the first UE to perform operations. For example, the operations may comprise: selecting at least one first resource; determining whether to perform contiguous resource selection for the at least one first resource; selecting at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and selecting at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

According to an embodiment of the present disclosure, a non-transitory computer-readable storage medium storing instructions may be proposed. For example, the instructions, based on being executed, may cause a first device to: select at least one first resource; determine whether to perform contiguous resource selection for the at least one first resource; select at least one second resource, based on the determination to perform the contiguous resource selection, wherein based on an earliest resource among the at least one second resource preceding the at least one first resource, a first channel access priority class (CAPC) value related to a first medium access control (MAC) protocol data unit (PDU) to be transmitted through the at least one first resource may be less than or equal to a second CAPC value related to a second MAC PDU to be transmitted through the at least one second resource, and wherein based on the earliest resource among the at least one second resource not preceding the at least one first resource, the first CAPC value may be greater than or equal to the second CAPC value; and select at least one third resource, based on the determination not to perform the contiguous resource selection, wherein a first sensing duration and a first frequency of channel sensing for a channel access procedure (CAP) related to the at least one first resource may be not overlapped with the at least one third resource, and wherein a third sensing duration and a third frequency of channel sensing for a CAP related to the at least one third resource may be not overlapped with the at least one first resource.

FIG. 57 shows a procedure for a second device to perform wireless communication, according to one embodiment of the present disclosure. The embodiment of FIG. 57 may be combined with various embodiments of the present disclosure.

Referring to FIG. 57, in step S5710, a second device may receive, from a first device, sidelink control information (SCI) for scheduling of a physical sidelink shared channel (PSSCH) through a physical sidelink control channel (PSCCH), based on at least one second resource. In step S5720, the second device may receive, from the first device, a second medium access control (MAC) protocol data unit (PDU) through the PSSCH, based on the at least one second resource. For example, a second channel access priority class (CAPC) value related to the second MAC PDU may be less than or equal to a first CAPC value related to a first MAC PDU to be transmitted through at least one first resource, and the at least one second resource may be selected within a contiguous interval of the at least one first resource based on a determination to perform contiguous resource selection.

For example, the second MAC PDU may be generated to include a serving data unit (SDU) related to the second CAPC value based on a logical channel prioritization (LCP) procedure, based on the determination to perform the contiguous resource selection.

The embodiments described above may be applied to various devices described below. First, a processor 202 of a second device 200 may control a transceiver 206 to receive, from a first device 100, sidelink control information (SCI) for scheduling of a physical sidelink shared channel (PSSCH) through a physical sidelink control channel (PSCCH), based on at least one second resource. And, the processor 202 of the second device 200 may control the transceiver 206 to receive, from the first device 100, a second medium access control (MAC) protocol data unit (PDU) through the PSSCH, based on the at least one second resource. For example, a second channel access priority class (CAPC) value related to the second MAC PDU may be less than or equal to a first CAPC value related to a first MAC PDU to be transmitted through at least one first resource, and the at least one second resource may be selected within a contiguous interval of the at least one first resource based on a determination to perform contiguous resource selection.

According to an embodiment of the present disclosure, a second device for performing wireless communication may be proposed. For example, the second device may comprise: at least one transceiver; at least one processor; and at least one memory operably connected to the at least one processor and storing instructions that, based on being executed by the at least one processor, cause the second device to perform operations. For example, the operations may comprise: receiving, from a first device, sidelink control information (SCI) for scheduling of a physical sidelink shared channel (PSSCH) through a physical sidelink control channel (PSCCH), based on at least one second resource; and receiving, from the first device, a second medium access control (MAC) protocol data unit (PDU) through the PSSCH, based on the at least one second resource, wherein a second channel access priority class (CAPC) value related to the second MAC PDU may be less than or equal to a first CAPC value related to a first MAC PDU to be transmitted through at least one first resource, and wherein the at least one second resource may be selected within a contiguous interval of the at least one first resource based on a determination to perform contiguous resource selection.

For example, the second MAC PDU may be generated to include a serving data unit (SDU) related to the second CAPC value based on a logical channel prioritization (LCP) procedure, based on the determination to perform the contiguous resource selection.

Various embodiments of the present disclosure may be combined with each other.

Hereinafter, device(s) to which various embodiments of the present disclosure may be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

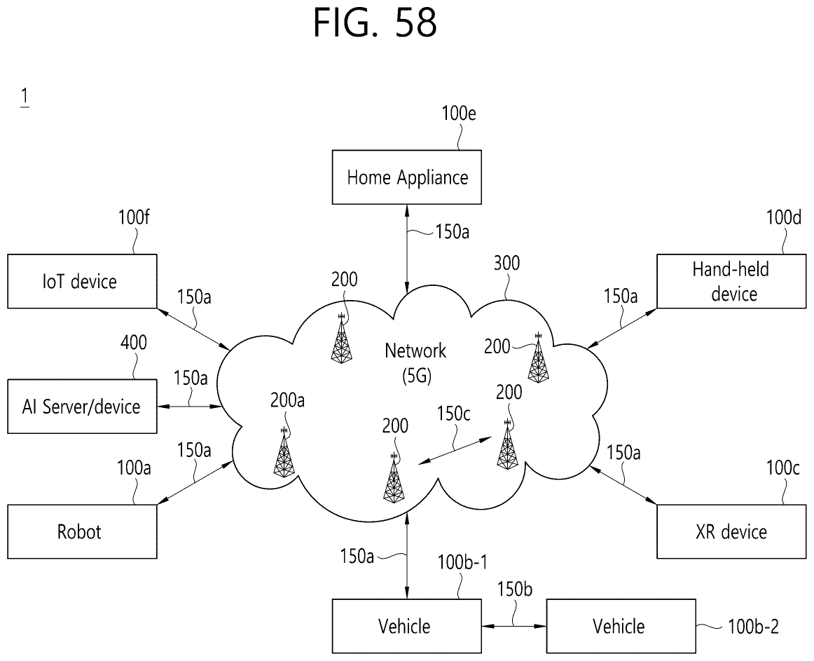

FIG. 58 shows a communication system 1, based on an embodiment of the present disclosure. The embodiment of FIG. 58 may be combined with various embodiments of the present disclosure.

Referring to FIG. 58, a communication system ito which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An Al technology may be applied to the wireless devices 100a to 100f and the wireless devices 100a to 100f may be connected to the Al server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

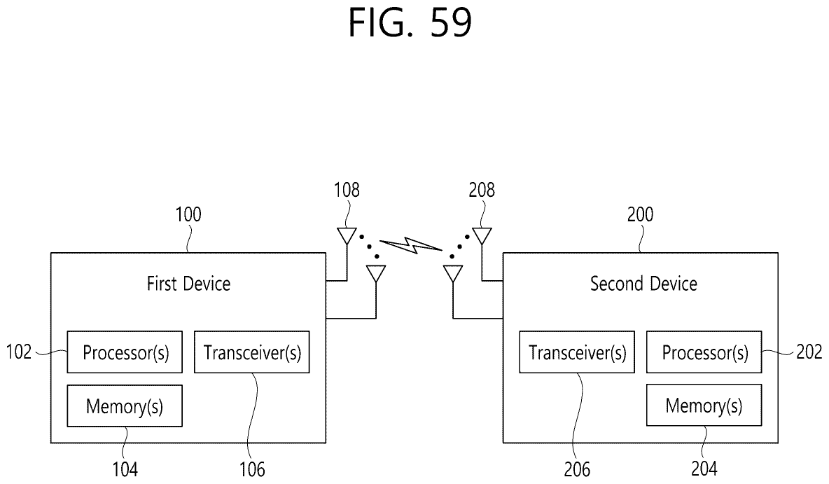

FIG. 59 shows wireless devices, based on an embodiment of the present disclosure. The embodiment of FIG. 59 may be combined with various embodiments of the present disclosure.

Referring to FIG. 59, a first wireless device 100 and a second wireless device 200 may transmit radio signals through a variety of RATs (e.g., LTE and NR). Herein, {the first wireless device 100 and the second wireless device 200}may correspond to {the wireless device 100x and the BS 200}and/or {the wireless device 100x and the wireless device 100x}of FIG. 58.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

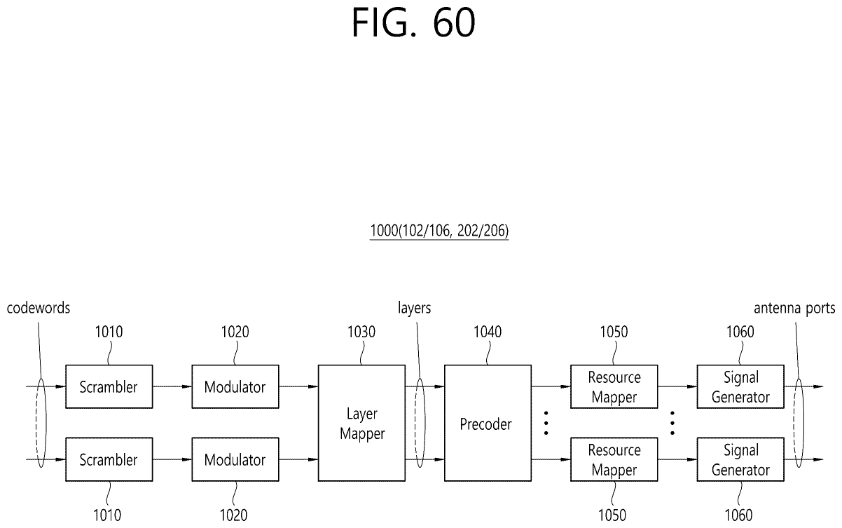

FIG. 60 shows a signal process circuit for a transmission signal, based on an embodiment of the present disclosure. The embodiment of FIG. 60 may be combined with various embodiments of the present disclosure.

Referring to FIG. 60, a signal processing circuit 1000 may include scramblers 1010, modulators 1020, a layer mapper 1030, a precoder 1040, resource mappers 1050, and signal generators 1060. An operation/function of FIG. 60 may be performed, without being limited to, the processors 102 and 202 and/or the transceivers 106 and 206 of FIG. 59. Hardware elements of FIG. 60 may be implemented by the processors 102 and 202 and/or the transceivers 106 and 206 of FIG. 59. For example, blocks 1010 to 1060 may be implemented by the processors 102 and 202 of FIG. 59. Alternatively, the blocks 1010 to 1050 may be implemented by the processors 102 and 202 of FIG. 59 and the block 1060 may be implemented by the transceivers 106 and 206 of FIG. 59.

Codewords may be converted into radio signals via the signal processing circuit 1000 of FIG. 60. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 60. For example, the wireless devices (e.g., 100 and 200 of FIG. 59) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

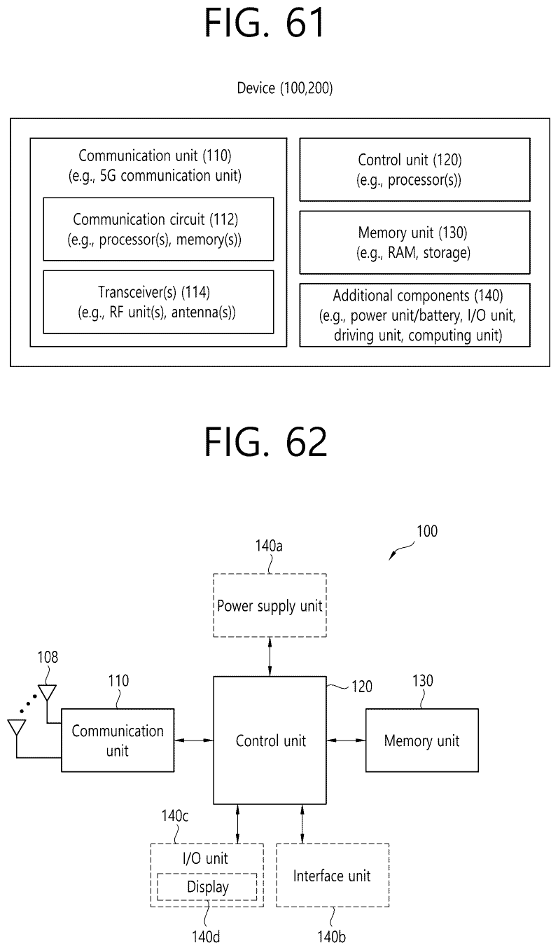

FIG. 61 shows another example of a wireless device, based on an embodiment of the present disclosure. The wireless device may be implemented in various forms according to a use-case/service (refer to FIG. 58). The embodiment of FIG. 61 may be combined with various embodiments of the present disclosure.

Referring to FIG. 61, wireless devices 100 and 200 may correspond to the wireless devices 100 and 200 of FIG. 59 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 59. For example, the transceiver(s) 114 may include the one or more transceivers 106 and 206 and/or the one or more antennas 108 and 208 of FIG. 59. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 58), the vehicles (100b-1 and 100b-2 of FIG. 58), the XR device (100c of FIG. 58), the hand-held device (100d of FIG. 58), the home appliance (100e of FIG. 58), the IoT device (100f of FIG. 58), a digital broadcast terminal, a hologram device, a public safety device, an MTC device, a medicine device, a fintech device (or a finance device), a security device, a climate/environment device, the Al server/device (400 of FIG. 58), the BSs (200 of FIG. 58), a network node, etc. The wireless device may be used in a mobile or fixed place according to a use-example/service.

In FIG. 61, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 61 will be described in detail with reference to the drawings.

FIG. 62 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 62 may be combined with various embodiments of the present disclosure.

Referring to FIG. 62, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 61, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

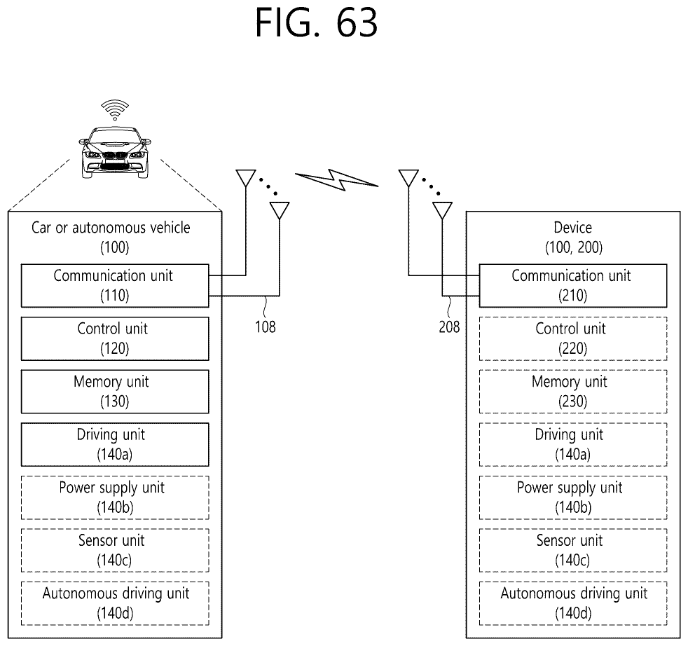

FIG. 63 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 63 may be combined with various embodiments of the present disclosure.

Referring to FIG. 63, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 61, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using Al technology, etc., based on the information collected from vehicles or autonomous vehicles and provide the predicted traffic information data to the vehicles or the autonomous vehicles.

Claims in the present description may be combined in a various way. For instance, technical features in method claims of the present description may be combined to be implemented or performed in an apparatus, and technical features in apparatus claims may be combined to be implemented or performed in a method. Further, technical features in method claim(s) and apparatus claim(s) may be combined to be implemented or performed in an apparatus. Further, technical features in method claim(s) and apparatus claim(s) may be combined to be implemented or performed in a method.

1. A method comprising:
selecting at least one first resource;
determining whether to perform contiguous resource selection for the at least one first resource;
selecting at least one second resource, based on the determination to perform the contiguous resource selection,
wherein based on an earliest resource among the at least one second resource preceding the at least one first resource, a first channel access priority class (CAPC) value related to a first medium access control (MAC) protocol data unit (PDU) to be transmitted through the at least one first resource is less than or equal to a second CAPC value related to a second MAC PDU to be transmitted through the at least one second resource, and
wherein based on the earliest resource among the at least one second resource not preceding the at least one first resource, the first CAPC value is greater than or equal to the second CAPC value; and
selecting at least one third resource, based on the determination not to perform the contiguous resource selection,
wherein a first sensing duration and a first frequency of channel sensing for a channel access procedure (CAP) related to the at least one first resource are not overlapped with the at least one third resource, and
wherein a third sensing duration and a third frequency of channel sensing for a CAP related to the at least one third resource are not overlapped with the at least one first resource.

2. The method of claim 1, wherein a second channel sensing duration or a second frequency of channel sensing for a CAP related to the at least one second resource are overlapped with the at least one first resource, or the first channel sensing duration and the first frequency are overlapped with the at least one second resource.

3. The method of claim 1, wherein the contiguous resource selection is determined to be performed, based on the second CAPC value being greater than or equal to the first CAPC value, and
wherein the contiguous resource selection is determined not to be performed, based on a third CAPC value related to a third MAC PDU to be transmitted based on the at least one third resource being less than the first CAPC value.

4. The method of claim 1, further comprising:
generating the second MAC PDU including a serving data unit (SDU) related to the second CAPC value based on a logical channel prioritization (LCP) procedure, based on the determination to perform the contiguous resource selection.

5. The method of claim 4, wherein selection for the at least one second resource is performed based on the generation of the second MAC PDU.

6. The method of claim 1, wherein the at least one second resource is a resource after an earliest resource among the at least one first resource.

7. The method of claim 1, wherein channel sensing for a CAP related to the at least one second resource is omitted.

8. The method of claim 7, wherein channel sensing for a CAP related to the at least one second resource is omitted based on a result of channel sensing for a CAP related to at least one first resource being idle.

9. The method of claim 1, wherein a third CAPC value related to a third MAC PDU to be transmitted based on the at least one third resource is greater than or equal to the first CAPC value.

10. The method of claim 9, wherein the at least one third resource is a resource after an earliest resource among the at least one first resource.

11. The method of claim 1, wherein selecting the at least one third resource, based on the determination not to perform the contiguous resource selection includes:
excluding a resource overlapped with the first sensing duration and the first frequency, from at least one candidate resource.

12. The method of claim 1, wherein at least one of the at least one first resource, the at least one second resource, or the at least one third resource is in an interlace structure.

13. The method of claim 1, further comprising:
performing, to a second device, a sidelink (SL) transmission, based on the at least one second resource or the at least one third resource.

14. A first device comprising:
at least one transceiver;
at least one processor; and
at least one memory connected to the at least one processor and storing instructions that, based on being executed by the at least one processor, cause the first device to
select at least one first resource;
determine whether to perform contiguous resource selection for the at least one first resource;
select at least one second resource, based on the determination to perform the contiguous resource selection,
wherein based on an earliest resource among the at least one second resource preceding the at least one first resource, a first channel access priority class (CAPC) value related to a first medium access control (MAC) protocol data unit (PDU) to be transmitted through the at least one first resource is less than or equal to a second CAPC value related to a second MAC PDU to be transmitted through the at least one second resource, and
wherein based on the earliest resource among the at least one second resource not preceding the at least one first resource, the first CAPC value is greater than or equal to the second CAPC value; and
select at least one third resource, based on the determination not to perform the contiguous resource selection,
wherein a first sensing duration and a first frequency of channel sensing for a channel access procedure (CAP) related to the at least one first resource are not overlapped with the at least one third resource, and
wherein a third sensing duration and a third frequency of channel sensing for a CAP related to the at least one third resource are not overlapped with the at least one first resource.

15. A processing device adapted to control a first user equipment (UE), the device comprising:
at least one processor; and
at least one memory connected to the at least one processor and storing instructions that, based on being executed by the at least one processor, cause the first UE to
select at least one first resource;
determine whether to perform contiguous resource selection for the at least one first resource;
select at least one second resource, based on the determination to perform the contiguous resource selection,
wherein based on an earliest resource among the at least one second resource preceding the at least one first resource, a first channel access priority class (CAPC) value related to a first medium access control (MAC) protocol data unit (PDU) to be transmitted through the at least one first resource is less than or equal to a second CAPC value related to a second MAC PDU to be transmitted through the at least one second resource, and
wherein based on the earliest resource among the at least one second resource not preceding the at least one first resource, the first CAPC value is greater than or equal to the second CAPC value; and
select at least one third resource, based on the determination not to perform the contiguous resource selection,
wherein a first sensing duration and a first frequency of channel sensing for a channel access procedure (CAP) related to the at least one first resource are not overlapped with the at least one third resource, and
wherein a third sensing duration and a third frequency of channel sensing for a CAP related to the at least one third resource are not overlapped with the at least one first resource.

16-20. (canceled)
